(19) United States
(12) Patent Application Publication
(10) Pub. No.: US 2025/0280117 A1
(43) Pub. Date: Sep. 4, 2025

(54) VIDEO ENCODING METHOD AND APPARATUS, VIDEO DECODING METHOD AND APPARATUS, AND DEVICES, SYSTEM AND STORAGE MEDIUM

(71) Applicant: GUANGDONG OPPO MOBILE TELECOMMUNICATIONS CORP., LTD., Dongguan (CN)

(72) Inventor: Fan WANG, Dongguan (CN)

(21) Appl. No.: 19/211,871

(22) Filed: May 19, 2025

Related U.S. Application Data
(63) Continuation of application No. PCT/CN2022/133539, filed on Nov. 22, 2022.

(51) Int. Cl. H04N 19/107; H04N 19/176; H04N 19/70

(52) U.S. Cl. CPC H04N 19/107; H04N 19/176; H04N 19/70

(57) ABSTRACT

The present application provides a video encoding method and a video decoding method, when the current block is encoded or decoded, N candidate weight derivation modes are determined, and then at least one candidate prediction mode is determined based on the N candidate weight derivation modes and the attribute information of the current block, and then a first weight derivation mode and K first prediction modes corresponding to the current block are determined based on the N candidate weight derivation modes and the at least one candidate prediction mode, and then the current block is predicted based on the first weight derivation mode and the K first prediction modes to obtain a prediction value of the current block.

### CROSS-REFERENCE TO RELATED APPLICATION

This application is a Continuation Application of International Application No. PCT/CN2022/133539 filed on Nov. 22, 2022, which is incorporated herein by reference in its entirety.

### TECHNICAL FIELD

The present application relates to the field of video coding technology, and in particular, to a video encoding method, a video decoding method, an apparatus, a device, a system and a storage medium.

### RELATED ART

Digital video technologies may be incorporated into a variety of video apparatuses, such as digital televisions, smartphones, computers, e-readers, or video players. With the development of video technology, the amount of data included in video data is large, and in order to facilitate transmission of the video data, video apparatuses employ video compression technology to implement efficient transmission or storage for the video data.

Since there is temporal or spatial redundancy in the video, the redundancy in the video may be eliminated or reduced by prediction to improve the compression efficiency. Currently, in order to improve prediction effect, multiple prediction modes may be used to predict the current block; for example, a candidate prediction mode list is constructed, and multiple prediction modes are selected from the candidate prediction mode list to predict the current block. However, the candidate prediction mode list currently constructed is not accurate enough, resulting in a decrease in prediction accuracy of the current block.

### SUMMARY

Embodiments of the present application provide a video encoding method, a video decoding method, apparatuses, a device, a system and a storage medium.

In a first aspect, the present application provides a video decoding method, applied to a decoder, includes:
determining N candidate weight derivation modes, where N is a positive integer;
determining at least one candidate prediction mode based on the N candidate weight derivation modes and attribute information of a current block;
determining a first weight derivation mode and K first prediction modes corresponding to the current block based on the N candidate weight derivation modes and the at least one candidate prediction mode, where K is a positive integer greater than 1; and predicting the current block based on the first weight derivation mode and the K first prediction modes to obtain a prediction value of the current block.

In a second aspect, the embodiments of the present application provide a video encoding method, which includes:
determining N candidate weight derivation modes, where N is a positive integer;
determining at least one candidate prediction mode based on the N candidate weight derivation modes and attribute information of a current block;
determining a first weight derivation mode and K first prediction modes corresponding to the current block based on the N candidate weight derivation modes and the at least one candidate prediction mode, where K is a positive integer greater than 1; and
predicting the current block based on the first weight derivation mode and the K first prediction modes to obtain a prediction value of the current block.

In a third aspect, the present application provides a video decoding apparatus, which is configured to perform the method in the first aspect or various implementations. In some implementation, the apparatus includes functional units configured to perform the method in the first aspect or various implementations of the method.

In a fourth aspect, the present application provides a video encoding apparatus, which is configured to perform the method in the second aspect or various implementations. In some implementation, the apparatus includes functional units configured to perform the method in the second aspect or various implementations of the method.

In a fifth aspect, a video decoder is provided, and the video decoder includes: a processor and a memory. The memory is configured to store a computer program, and the processor is configured to call the computer program stored in the memory and run the computer program to perform the method in the first aspect or various implementations of the method.

In a sixth aspect, a video encoder is provided, and the video encoder includes: a processor and a memory. The memory is configured to store a computer program, and the processor is configured to call the computer program stored in the memory and run the computer program to perform the method in the second aspect or various implementations of the method.

In a seventh aspect, a video encoding and decoding system is provided, and the video encoding and decoding system includes: a video encoder and a video decoder. The video decoder is configured to perform the method in the first aspect or various implementations of the method, and the video encoder is configured to perform the method in the second aspect or various implementations of the method.

In an eighth aspect, a chip is provided, which is configured to implement the method in any one of the above first to second aspects or various implementations of the method. In some implementation, the chip includes a processor configured to call a computer program from a memory and run the computer program to cause a device equipped with the chip to perform the method in any one of the above first to second aspects or various implementations of the method.

In a ninth aspect, a non-transitory computer-readable storage medium is provided, which is configured to store a computer program. The computer program causes a computer to perform the method in any one of the above first to second aspects or various implementations of the method.

In a tenth aspect, a computer program product is provided, which includes computer program instructions. The computer program instructions cause a computer to perform the method in any one of the above first to second aspects or various implementations of the method.

In an eleventh aspect, a computer program is provided, and the computer program, when executed on a computer, causes the computer to perform the method in any one of the above first to second aspects or various implementations of the method.

In a twelfth aspect, a bitstream is provided, which is generated based on the method in the second aspect. Optionally, the bitstream includes a first index, where the first index is used to indicate a first combination composed of one weight derivation mode and K prediction modes, where K is a positive integer greater than 1.

### BRIEF DESCRIPTION OF THE DRAWINGS

FIG. 1 is a schematic block diagram of a video encoding and decoding system involved in the embodiments of the present application.

FIG. 2 is a schematic block diagram of a video encoder involved in the embodiments of the present application.

FIG. 3 is a schematic block diagram of a video decoder involved in the embodiments of the present application.

FIG. 4 is a schematic diagram of weight allocation.

FIG. 5 is a schematic diagram of weight allocation.

FIG. 6A is a schematic diagram of inter prediction.

FIG. 6B is a schematic diagram of weighted inter prediction.

FIG. 7A is a schematic diagram of intra prediction.

FIG. 7B is a schematic diagram of intra prediction.

FIG. 8A-8I are schematic diagrams of intra prediction.

FIG. 9 is a schematic diagram of intra prediction modes.

FIG. 10 is a schematic diagram of intra prediction modes.

FIG. 11 is a schematic diagram of intra prediction modes.

FIG. 12 is a schematic diagram of MIP.

FIG. 13 is a schematic diagram of TIMD prediction.

FIG. 14A is a histogram corresponding to DIMD.

FIG. 14B is a schematic diagram of DIMD prediction.

FIG. 15 is a schematic diagram of a combined prediction.

FIG. 16 is a schematic diagram of a template.

FIG. 17A is a schematic diagram of inter-intra prediction.

FIG. 17B is a schematic diagram of another inter-intra prediction.

FIG. 18 is a schematic diagram of neighboring blocks.

FIG. 19 is a schematic flowchart of a video decoding method provided by an embodiment of the present application.

FIG. 20A is a schematic diagram of weight allocation.

FIG. 20B is a schematic diagram of weight allocation.

FIG. 21A is a schematic diagram of a template.

FIG. 21B is a schematic diagram of deriving a template weight.

FIG. 22A is a schematic diagram of a blending area.

FIG. 22B is a schematic diagram of another blending area.

FIG. 23 is a schematic flowchart of a video encoding method provided by an embodiment of the present application.

FIG. 24 is a schematic block diagram of a video decoding apparatus provided by an embodiment of the present application.

FIG. 25 is a schematic block diagram of a video encoding apparatus provided by an embodiment of the present application.

FIG. 26 is a schematic block diagram of an electronic device provided by the embodiments of the present application.

FIG. 27 is a schematic block diagram of a video encoding and decoding system provided by the embodiments of the present application.

### DETAILED DESCRIPTION

The present application may be applied to a field of picture encoding and decoding, a field of video encoding and decoding, a field of hardware video encoding and decoding, a field of dedicated circuit video encoding and decoding, a field of real-time video encoding and decoding, or the like. For example, the solution of the present application may be in conjunction with an audio video coding standard (AVS), such as H.264/audio video coding (AVC) standard, H.265/high efficiency video coding (HEVC) standard, and H.266/versatile video coding (VVC) standard. Alternatively, the solutions of the present application may be operated in conjunction with other dedicated or industrial standards, the standards include ITU-TH.261, ISO/IECMPEG-1 Visual, ITU-TH.262 or ISO/IECMPEG-2Visual, ITU-TH.263, ISO/IECMPEG-4Visual, ITU-TH.264 (also referred to as ISO/IECMPEG-4AVC), containing scalable video coding (SVC) and multi-view video coding (MVC) extensions. It should be understood that, the technologies of the present application are not limited to any particular encoding and decoding standard or technology.

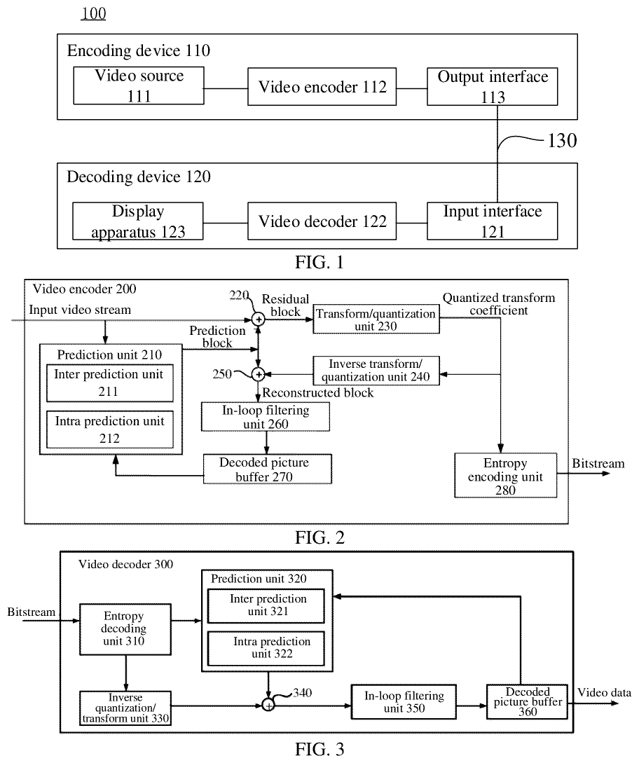

For ease of understanding, a video encoding and decoding system involved in the embodiments of the present application is first introduced in conjunction with FIG. 1.

FIG. 1 is a schematic block diagram of a video encoding and decoding system involved in the embodiments of the present application. It should be noted that FIG. 1 is only an example, and the video encoding and decoding system of the embodiments of the present application includes but is not limited to that shown in FIG. 1. As shown in FIG. 1, the video encoding and decoding system 100 includes an encoding device 110 and a decoding device 120. The encoding device is configured to encode (which may be understood as compression) video data to generate a bitstream, and transmit the bitstream to the decoding device. The decoding device decodes the bitstream generated by the encoding device to obtain decoded video data.

In the embodiments of the present application, the encoding device 110 may be understood as a device with a video encoding function, and the decoding device 120 may be understood as a device with a video decoding function; that is, in the embodiments of the present application, the encoding device 110 and the decoding device 120 include a wide range of apparatuses, such as a smartphone, a desktop computer, a mobile computing apparatus, a notebook (e.g., laptop) computer, a tablet computer, a set-top box, a television, a camera, a display apparatus, a digital media player, a video game console, an in-vehicle computer.

In some embodiments, the encoding device 110 may transmit encoded video data (e.g., a bitstream) to the decoding device 120 via a channel 130. The channel 130 may include one or more media and/or apparatuses which are able to transmit the encoded video data from the encoding device 110 to the decoding device 120.

In an instance, the channel 130 includes one or more communication media that enable the encoding device 110 to transmit the encoded video data directly to the decoding device 120 in real-time. In this instance, the encoding device 110 may modulate the encoded video data according to a communication standard and transmit modulated video data to the decoding device 120. The communication media includes a wireless communication media, e.g., a radio frequency spectrum. Optionally, the communication medium may include a wired communication media, e.g., one or more physical transmission lines.

In another instance, the channel 130 includes a storage medium, the storage medium may store the video data encoded by the encoding device 110. The storage media include a variety of local access data storage media, such as an optical disk, a DVD, a flash memory. In this instance, the decoding device 120 may obtain the encoded video data from the storage medium.

In still another instance, the channel 130 may include a storage server, the storage server may store the video data encoded by the encoding device 110. In this instance, the decoding device 120 may download the encoded video data stored in the storage server from the storage server. Optionally, the storage server, such as a web server (e.g., for a website), or a file transfer protocol (FTP) server, may store the encoded video data therein and transmit the encoded video data to the decoding device 120.

In some embodiments, the encoding device 110 includes a video encoder 112 and an output interface 113. The output interface 113 may include a modulator/demodulator (a modem) and/or a transmitter.

In some embodiments, the encoding device 110 may further includes a video source 111 in addition to the video encoder 112 and the output interface 113.

The video source 111 may include at least one of a video collecting apparatus (e.g., a video camera), a video archive, a video input interface, or a computer graphics system; the video input interface is used to receive video data from a video content provider, and the computer graphics system is used to generate video data.

The video encoder 112 encodes the video data from the video source 111 to generate a bitstream. The video data may include one or more pictures or sequences of pictures. The bitstream contains encoded information of the picture(s) or the sequence of pictures in the form of a bitstream. The encoded information may include encoded picture data and associated data. The associated data may include a sequence parameter set (which is abbreviated as SPS), a picture parameter set (which is abbreviated as PPS) and other syntax structures. The SPS may contain parameters applied to one or more sequences. The PPS may contain parameters applied to one or more pictures. A syntax structure is a set of one or more syntax elements arranged in a specified order in the bitstream.

The video encoder 112 transmits the encoded video data directly to the decoding device 120 via the output interface 113. The encoded video data may also be stored in a storage medium or a storage server for subsequent reading by the decoding device 120.

In some embodiments, the decoding device 120 includes an input interface 121 and a video decoder 122.

In some embodiments, the decoding device 120 may further include a display apparatus 123 in addition to the input interface 121 and the video decoder 122.

Here, the input interface 121 includes a receiver and/or a modem. The input interface 121 may receive the encoded video data via the channel 130.

The video decoder 122 is used to decode the encoded video data to obtain decoded video data, and transmit the decoded video data to the display apparatus 123.

The display apparatus 123 displays the decoded video data. The display apparatus 123 may be integrated with the decoding device 120 or is set to be outside of the decoding device 120. The display apparatus 123 may include various display apparatuses, such as a liquid crystal display (LCD), a plasma display, an organic light emitting diode (OLED) display, or other types of display apparatuses.

In addition, FIG. 1 is only an example, and the technical solution of the embodiments of the present application is not limited to FIG. 1. For example, the technology of the present application may also be applied to unilateral video encoding or unilateral video decoding.

The architecture of video encoding involved in the embodiments of the present application will be introduced below.

FIG. 2 is a schematic block diagram of a video encoder involved in the embodiments of the present application. It will be understood that the video encoder 200 may be used to perform lossy compression on a picture, or may be used to perform lossless compression on a picture. The lossless compression may be visually lossless compression or mathematically lossless compression.

The video encoder 200 may be applied to picture data in a luma and chroma (YCbCr, YUV) format. For example, a YUV ratio may be 4:2:0, 4:2:2 or 4:4:4, where Y represents luma, Cb(U) represents blue chroma, Cr(V) represents red chroma, U and V represent chroma for describing color and saturation. For example, in a color format, 4:2:0 means that there are 4 luma components and 2 chroma components (YYYYCbCr) for every 4 samples, 4:2:2 means that there are 4 luma components and 4 chroma components (YYYYCbCrCbCr) for every 4 samples, and 4:4:4 means full sample display (YYYYCbCrCbCrCbCrCbCr).

For example, the video encoder 200 reads video data, and for each picture in the video data, partitions one picture into several coding tree units (CTUs). In some examples, a CTB may be referred to as a “tree block”, “largest coding unit (LCU)” or “coding tree block (CTB)”. Each CTU may be associated with sample blocks with equal size in the picture. Each sample may correspond to one luma (luminance) sample and two chroma (chrominance) samples. Thus, each CTU may be associated with one luma sample block and two chroma sample blocks. A size of a CTU is, for example, 128×128, 64×64, 32×32. A CTU may be partitioned into several coding units (CUs) for encoding. A CU may be a rectangular block or a square block. Further, the CU may be partitioned into prediction units (PUs) and transform units (TUs), which makes encoding, prediction and transform separation more flexible in processing. In an example, a CTU is partitioned into CUs in a quadtree manner, and a CU is partitioned into TUs and PUs in the quadtree manner.

The video encoder and the video decoder may support various PU sizes. Assuming that the size of a specific CU is 2N×2N, the video encoder and the video decoder may support a PU size of 2N×2N or N×N for intra prediction, and support symmetric PUs with 2N×2N, 2N×N, N×2N, N×N or similar sizes for inter prediction. The video encoder and video decoder may also support asymmetric PUs with 2N×nU, 2N×nD, nL×2N, and nR×2N for inter prediction.

In some embodiments, as shown in FIG. 2, the video encoder 200 may include: a prediction unit 210, a residual unit 220, a transform/quantization unit 230, an inverse transform/quantization unit 240, a reconstructed unit 250, an in-loop filtering unit 260, a decoded picture buffer 270 and an entropy encoding unit 280. It will be noted that the video encoder 200 may include more, fewer or different functional components.

Optionally, in the present application, a current block may be referred to as a current coding unit (CU) or a current prediction unit (PU), or the like. A prediction block may also be referred to as a prediction picture block or a picture prediction block, and the reconstructed picture block may also be referred to as a reconstructed block or a picture reconstructed picture block.

In some embodiments, the prediction unit 210 includes an inter prediction unit 211 and an intra prediction unit 212. Since there is a strong correlation between neighboring samples in a frame of a video, in the video encoding and decoding technology, the intra prediction mode is used to eliminate spatial redundancy between the neighboring samples. Since there is strong similarity between neighboring frames in the video, in the video encoding and decoding technology, the inter prediction mode is used to eliminate temporal redundancy between the neighboring samples, thereby improving the encoding efficiency.

The inter prediction unit 211 may be used for inter prediction, and the inter prediction may include motion estimation and motion compensation, which may refer to picture information of different frames (pictures). In the inter prediction, motion information is used to find a reference block from a reference frame, and a prediction block is generated according to the reference block to eliminate temporal redundancy. Frames used for the inter prediction may include a P frame and/or a B frame, the P frame refers to a forward prediction frame, and the B frame refer to a bidirectional prediction frame. In the inter prediction, the motion information used to find the reference block from the reference frame, and the prediction block is generated according to the reference block. The motion information includes a reference frame list where the reference frame is located, a reference frame index, and a motion vector. The motion vector may belong to an integer sample or a fractional sample. If the motion vector belongs to the fractional sample, it is necessary to use interpolation filtering in the reference frame to obtain a block of the required fractional sample. Here, the block of the integer sample or fractional sample in the reference frame, which is found according to the motion vector, is called the reference block. The reference block is used as a prediction block directly in some technologies, while a prediction block is generated on the basis of processing the reference block in some technologies. The prediction block being generated on the basis of processing the reference block may also be understood as the reference block serving as a prediction block and then processing the prediction block to generate a new prediction block.

The intra prediction unit 212 only refers to information of a picture in a same frame to predict sample information of a current coding picture block to eliminate spatial redundancy. A frame used for intra prediction may be an I frame.

There are several prediction modes for intra prediction. Considering the H series of international digital video encoding standards as an example, H.264/AVC standard has 8 angle prediction modes and 1 non-angle prediction mode, and H.265/HEVC standard is expanded to have 33 angle prediction modes and 2 non-angle prediction modes. The intra prediction modes used by HEVC include a Planar mode, a DC mode and 33 angle modes, for a total of 35 prediction modes. The intra modes used by VVC includes a Planar mode, a DC mode, and 65 angle modes, for a total of 67 prediction modes.

It will be noted that with the addition of angle modes, the intra prediction will be more accurate and more in line with the requirements of the evolution of high-definition and ultra-high-definition digital video.

The residual unit 220 may generate a residual block of a CU based on a sample block of the CU and a prediction block of a PU of the CU. For example, the residual unit 220 may generate a residual block of the CU, so that each sample of the residual block has a value equal to a difference between: a sample of the sample block of the CU and a corresponding sample of the prediction block of the PU of the CU.

The transform/quantization unit 230 may quantize a transform coefficient. The transform/quantization unit 230 may quantize a transform coefficient associated with a TU of a CU based on a quantization parameter (QP) value associated with the CU. The video encoder 200 may adjust a quantization degree of the transform coefficient associated with the CU by adjusting the QP value associated with the CU.

The inverse transform/quantization unit 240 may apply both inverse quantization and inverse transform to a quantized transform coefficient to reconstruct a residual block from the quantized transform coefficient.

The reconstructed unit 250 may add a sample of the reconstructed residual block to a corresponding sample of one or more prediction blocks generated by the prediction unit 210 to generate a reconstructed picture block associated with the TU. By reconstructing the sample blocks of each TU of the CU in this method, the video encoder 200 may reconstruct the sample block of the CU.

The in-loop filtering unit 260 is used to process the inverse transformed and inverse quantized samples to compensate for distortion information, so as to provide a good reference for subsequent encoded samples. For example, a deblocking filtering operation may be performed to reduce the blocking effect of sample blocks associated with the CU.

In some embodiments, the in-loop filtering unit 260 includes a deblocking filtering unit and a sample adaptive offset/adaptive loop filtering (SAO/ALF) unit. The deblocking filtering unit is used for removing blocking effect, and the SAO/ALF unit is used for removing ringing effect.

The decoded picture buffer 270 may store the reconstructed sample blocks. The inter prediction unit 211 may use a reference picture containing the reconstructed sample blocks to perform the inter prediction on a PU of other pictures. In addition, the intra prediction unit 212 may use the reconstructed sample blocks stored in the decoded picture buffer 270 to perform intra prediction on other PUs of the same picture as the CU.

The entropy encoding unit 280 may receive the quantized transform coefficient from the transform/quantization unit 230. The entropy encoding unit 280 may perform one or more entropy coding operations on the quantized transform coefficient to generate entropy-coded data.

FIG. 3 is a schematic block diagram of a video decoder involved in the embodiments of the present application.

As shown in FIG. 3, the video decoder 300 includes an entropy decoding unit 310, a prediction unit 320, an inverse quantization/transform unit 330, a reconstructed unit 340, an in-loop filtering unit 350, and a decoded picture buffer 360. It will be noted that the video decoder 300 may include more, fewer or different functional components.

The video decoder 300 may receive a bitstream. The entropy decoding unit 310 may parse the bitstream to extract syntax elements from the bitstream. As a part of parsing the bitstream, the entropy decoding unit 310 may parse the entropy-coded syntax elements in the bitstream. The prediction unit 320, the inverse quantization/transform unit 330, the reconstructed unit 340, and the in-loop filtering unit 350 may decode video data according to the syntax elements extracted from the bitstream, so that decoded video data is generated.

In some embodiments, the prediction unit 320 includes an intra prediction unit 322 and an inter prediction unit 321.

The intra prediction unit 322 may perform intra prediction to generate a prediction block of a PU. The intra prediction unit 322 may use an intra prediction mode to generate a prediction block of the PU based on sample blocks of spatially neighboring PUs. The intra prediction unit 322 may further determine the intra prediction mode for the PU according to one or more syntax elements parsed from the bitstream.

The inter prediction unit 321 may construct a first reference picture list (list 0) and a second reference picture list (list 1) according to syntax elements parsed from the bitstream. Furthermore, if the PU is encoded using inter prediction, the entropy decoding unit 310 may parse motion information of the PU. The inter prediction unit 321 may determine one or more reference blocks of the PU according to the motion information of the PU. The inter prediction unit 321 may generate a prediction block of the PU based on one or more reference blocks of the PU.

The inverse quantization/transform unit 330 may inverse quantize (i.e., dequantize) a transform coefficient associated with a TU. The inverse quantization/transform unit 330 may use a QP value associated with a CU of the TU to determine a quantization degree.

After inverse quantizing the transform coefficient, the inverse quantization/transform unit 330 may apply one or more inverse transforms to the inverse quantized transform coefficient to generate a residual block associated with the TU.

The reconstructed unit 340 reconstructs a sample block of the CU by using the residual block associated with the TU of the CU and the prediction block of the PU of the CU. For example, the reconstructed unit 340 may add a sample of the residual block to a corresponding sample of the prediction block to reconstruct the sample block of the CU, so as to obtain a reconstructed picture block.

The in-loop filtering unit 350 may perform a deblocking filtering operation to reduce the blocking effect of the sample block associated with the CU.

The video decoder 300 may store the reconstructed picture of the CU in the decoded picture buffer 360. The video decoder 300 may use the reconstructed picture stored in the decoded picture buffer 360 as a reference picture for subsequent prediction, or transmit the reconstructed picture to a display apparatus for presentation.

The basic procedure of video encoding and decoding is as follows. At the encoding side, a frame of picture is partitioned into blocks, and for a current block, the prediction unit 210 generates a prediction block of the current block using intra prediction or inter prediction. The residual unit 220 may calculate a residual block based on the prediction block and an original block of the current block, i.e., a difference between the prediction block and the original block of the current block, the residual block may also being referred to as residual information. The transform/quantization unit 230 performs processes such as transform and quantization on the residual block to remove the information that is not sensitive to the human eye in the residual block to eliminate visual redundancy. Optionally, the residual block that has not been transformed and quantized by the transform/quantization unit 230 may be referred to as a temporal residual block, and the temporal residual block after being transformed and quantized by the transform/quantization unit 230 may be referred to as a frequency residual block or a frequency domain residual block. After receiving the quantized transform coefficient output by the transform/quantization unit 230, the entropy encoding unit 280 may perform entropy coding on the quantized transform coefficient to output a bitstream. For example, the entropy encoding unit 280 may eliminate character redundancy according to a target context model and probability information of a binary bitstream.

At the decoding side, the entropy decoding unit 310 may parse the bitstream to obtain prediction information, a quantization coefficient matrix, etc., of the current block, and the prediction unit 320 uses intra prediction or inter prediction for the current block based on the prediction information to generate a prediction block of the current block. The inverse quantization/transform unit 330 performs inverse quantization and inverse transform on the quantization coefficient matrix obtained from the bitstream to obtain a residual block. The reconstructed unit 340 adds the prediction block and the residual block to obtain a reconstructed block. Reconstructed blocks constitute a reconstructed picture. The in-loop filtering unit 350 performs in-loop filtering on the reconstructed picture based on a picture or on a block to obtain a decoded picture. At the encoding side, it also needs to perform operations similar to those at the decoding side to obtain the decoded picture. The decoded picture may also be referred to as a reconstructed picture, the reconstructed picture may be used as a reference frame of the inter prediction for a subsequent frame.

It will be noted that the block partition information, as well as the mode information or parameter information for prediction, transform, quantization, entropy coding, in-loop filtering, etc., that are determined by the encoding side, are carried in the bitstream if necessary. The decoding side determines the same block partitioned information, mode information or parameter information for prediction, transform, quantization, entropy coding, in-loop filtering, etc., as that at the encoding side by parsing the bitstream and performing analysis on the existing information, thereby ensuring that the decoded picture obtained at the encoding side is the same as the decoded picture obtained at the decoding side.

The above is the basic procedure of the video encoder and decoder under the block-based hybrid coding framework. With the evolution of technology, some modules or steps of the framework or processes may be optimized. The present application is applicable to the basic procedure of the video encoder and decoder under the block-based hybrid encoding framework, but is not limited to the framework and procedure.

In the embodiments of the present application, the current block may be a current coding unit (CU) or a current prediction unit (PU), etc. Due to a need for parallel processing, the picture may be partition into slices, and the slices of the same picture may be processed in parallel, that is, there is no data dependency between them. “Frame” is a commonly used term, which may be generally understood to means that one frame is one picture. In the application, the frame may also be replaced by a picture or slices, etc.

In the versatile video coding (VVC) that currently under development of the video encoding and decoding standard, there is an inter prediction mode called geometric partitioning mode (GPM). In the audio video coding standard (AVS) that currently under development of video encoding and decoding standard, there is an inter prediction mode called angular weighted prediction (AWP). Although these two modes have different names and exemplary implementation forms, they have something in common in principle.

It will be noted that the traditional unidirectional prediction only searches for one reference block with the same size as a current block, while the traditional bi-prediction uses two reference blocks with the same size as the current block; the sample value at each point in the prediction block is an average of the sample values at the corresponding positions in the two reference blocks, that is, all points in each reference block account for 50%. Bidirectional weighted prediction allows proportions of the two reference blocks to be different, for example, all points in a first reference block account for 75%, and all points in a second reference block account for 25%. However, all points in the same reference block account the same proportion. Some other optimization methods, such as using decoder side motion vector refinement (DMVR) technology and bi-directional optical flow (BIO), will cause some changes in the reference sample or predicted samples, but they are not related to the principles mentioned above. BIO may also be abbreviated as BDOF. Two reference blocks with the same size as the current block also be used for the GPM or AWP, but the sample values at the corresponding positions of the first reference block are 100% used in some sample positions, and the sample values at the corresponding positions of the second reference block are 100% used in some sample positions. In a boundary area or blending area, the sample values at the corresponding positions of the two reference blocks are used with a certain proportion. The weights of the boundary area also blending gradually. The exemplary allocation of these weights is determined by the mode of GPM or AWP. The weight of each sample position is determined according to the mode of GPM or AWP. Certainly, in some cases, such as a case where the block size is very small, it may be impossible to guarantee that in the mode of GPM or AWP, the sample values at the corresponding positions of the first reference block are 100% used in some sample positions, and the sample values at the corresponding positions of the second reference block are 100% used in some sample positions. It may also be considered that for GPM or AWP, two reference blocks with different sizes from the current block are used, that is, each reference block takes a required part as a reference block. That is, a part of which the weight is not 0 is used as the reference block, and a part of which the weight is 0 is removed. This is an implementation issue and is not the focus of present application.

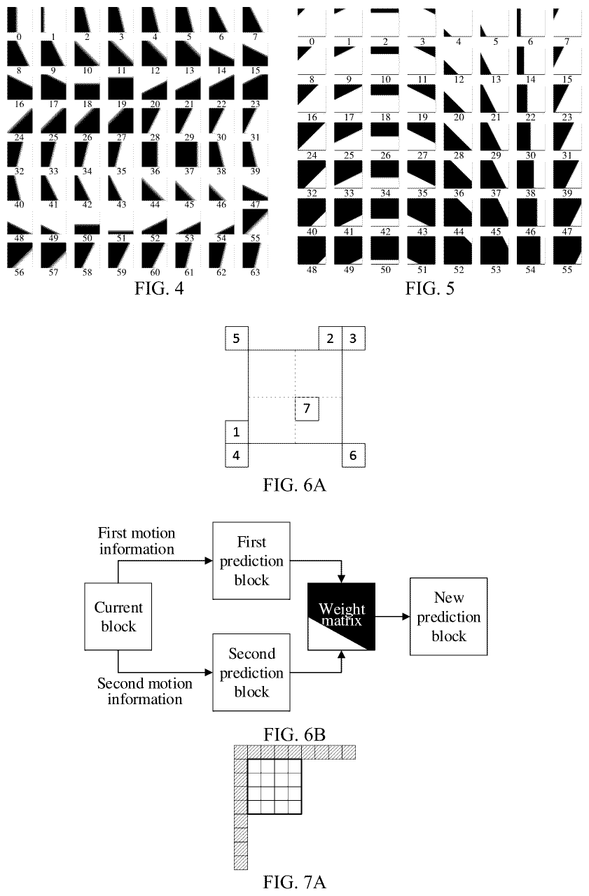

For example, FIG. 4 is a schematic diagram of a weight allocation. As shown in FIG. 4, it illustrates a schematic diagram of a weight allocation for multiple partitioning modes of GPM on a 64×64 current block provided by the embodiments of the present application, where there are 64 partition modes for the GPM. FIG. 5 is a schematic diagram of a weight allocation. As shown in FIG. 5, it illustrates a schematic diagram of weight allocation of multiple partitioning modes of AWP on a 64×64 current block provided by the embodiments of the present application, where there are 56 partition modes for the AWP. Whether it is FIG. 4 or FIG. 5, in each partition mode, a black area represents that a weight value at the corresponding position of the first reference block is 0%, a white area represents that the weight value at the corresponding position of the first reference block is 100%, and a gray area represents that the weight value at the corresponding position of the first reference block is a weight value greater than 0% and less than 100% according to the color depth, and the weight value at the corresponding position of the second reference block is 100% minus the weight value at the corresponding position of the first reference block.

The weight derivation methods for GPM and AWP are different. For GPM, the angle and offset is determined according to each mode and then the weight matrix for each mode is obtained. For AWP, a one-dimensional weight line is first made, and then a method similar to intra angular prediction is employed to spread the one-dimensional weight line across the entire matrix.

It will be understood that in early encoding and decoding technologies, there was only a rectangular partitioning method, whether it was a partition for CU, PU or transform unit (TU). However, for GPM or AWP, it is possible to achieve the predicted non-rectangular partition effect without partition. For the GPM and AWP, a mask, i.e., the weight diagram mentioned above, of the weights of two reference blocks is employed. This mask determines the weights of the two reference blocks in a case of generating a prediction block, or it may be simply understood that a part of the position of the prediction block comes from the first reference block and a part of the position comes from the second reference block, and the blending area is obtained by weighting the corresponding positions of the two reference blocks to make the blending smooth. For the GPM and AWP, it do not partition the current block into two CUs or PUs according to the partition line, so the transform, quantization, inverse transform, inverse quantization, etc. of the residual after prediction may be processed by considering the current block as a whole.

GPM simulates the partition of geometric shapes, or more precisely, the partition of predictions by using a weight matrix. To implement GPM, in addition to the weight matrix, two prediction values are required, each of which is determined by one unidirectional motion information. The two unidirectional motion information come from a motion information candidate list, for example, from a merge motion information candidate list (mergeCandList). GPM employs two indexes in the bitstream to determine the two unidirectional motion information from mergeCandList.

For inter prediction, motion information is used to represent “motion”. The basic motion information includes information of a reference frame (or reference picture) and information of a motion vector (MV). For commonly used bi-prediction, two reference blocks are used to predict the current block. The two reference blocks may be a forward reference block and a backward reference block. Optionally, the two reference blocks are both forward or both backward. The “forward” refers to that the time corresponding to the reference frame is before the current frame, and the “backward” refers to that the time corresponding to the reference frame is after the current frame. In other words, “forward” refers to that the position of the reference frame is before the current frame in the video, and “backward” refers to that the position of the reference frame is after the current frame in the video. In other words, the “forward” refers to that the picture order count (POC) of the reference frame is smaller than the POC of the current frame, and the “backward” refers to that the POC of the reference frame is larger than the POC of the current frame. In order to use bi-prediction, it is naturally necessary to find two reference blocks, so two sets of information of the reference frame and information of motion vector are needed. Each of these sets may be understood as a piece of uni-directional motion information, and these two sets are combined together to form a piece of bi-directional motion information. In exemplary implementation, the uni-directional motion information and bi-directional motion information may employ the same data structure, except that the two sets of information of the reference frame and information of the motion vector of the bi-directional motion information are both valid, while one set of information of the reference frame and information of the motion vector of the uni-directional motion information is invalid.

In some embodiments, two reference frame lists are supported, denoted as RPL0 and RPL1, where RPL is an abbreviation of reference picture list. In some embodiments, a P slice may only use RPL0, and a B slice may use RPL0 and RPL1. For a slice, each reference frame list contains several reference frames, and the video encoder and decoder find a certain reference frame via the reference frame index. In some embodiments, the motion information is represented by a reference frame index and a motion vector. For the bi-directional motion information, the reference frame index refIdxL0 corresponding to the reference frame list 0 and the motion vector mvL0 corresponding to the reference frame list 0, the reference frame index refIdxL1 corresponding to the reference frame list 1 and the motion vector mvL0 corresponding to the reference frame list 1 are used. Here, the reference frame index corresponding to the reference frame list 0 and the reference frame index corresponding to the reference frame list 1 may be understood as the information of the reference frame. In some embodiments, two flags are used to represent whether to use the motion information corresponding to reference frame list 0 and whether to use the motion information corresponding to reference frame list 1, which are respectively represented as predFlagL0 and predFlagL1. It may also be understood that predFlagL0 and predFlagL1 represent whether the uni-directional motion information is “valid or not”. Although the data structure of motion information is not explicitly mentioned, it uses the reference frame index, the motion vector and the flag of “valid or not” corresponding to each reference frame list to represent the motion information. In some standard texts, motion information does not appear, but motion vectors are used, which may be considered that the reference frame index and the flag of whether to use the corresponding motion information are attached to the motion vector. In the present application, “motion information” is still used for the convenience of description, but it will be understood that it may also be described as “motion vector”.

The motion information used by the current block may be saved. The blocks for subsequently encoding and decoding of the current frame may use the motion information of the previously encoded and decoded blocks, e.g., neighboring blocks, according to the neighboring position relationship. This utilizes the correlation in the spatial domain, so this encoded and decoded motion information is called motion information in the spatial domain. The motion information used by each block of the current picture frame may be saved. The frames for subsequently encoding and decoding may use the motion information of the previously encoded and decoded frames according to the reference relationship, which utilizes the correlation in the temporal, so the motion information of the encoded and decoded frame is called motion information in the temporal. The method for storing the motion information used by each block of the current frame generally uses a matrix of a fixed size, such as a 4×4 matrix, as a minimum unit, and each minimum unit stores a set of motion information separately. In this way, every time a block is encoded or decoded, the smallest unit corresponding to its position may store the motion information of the block. Therefore, in a case of using the motion information in the spatial domain or the motion information in the temporal domain, the motion information corresponding to the position may be directly found according to the position. If the traditional uni-prediction is used for a 16×16 block, then all 4×4 minimum units corresponding to this block store the motion information of this uni-prediction. If GPM or AWP is used for a block, then all minimum units corresponding to this block will determine the motion information stored in each minimum unit according to the mode of GPM or AWP, the first motion information, the second motion information and the position of each minimum unit. One method is that if all 4×4 samples corresponding to a minimum unit come from the first motion information, then the minimum unit stores the first motion information; if all 4×4 samples corresponding to a minimum unit come from the second motion information, then the minimum unit stores the second motion information. If the 4×4 samples corresponding to a minimum unit come from both the first motion information and the second motion information, for AWP, one of the motion information will be selected for storage; for GPM, if the two motion information point to different reference frame lists, then they are combined into bidirectional motion information for storage, otherwise only the second motion information is stored.

Optionally, the above mergeCandList is constructed according to spatial motion information, temporal motion information, history-based motion information, and some other motion information. For example, for the mergeCandList, spatial motion information is derived by using positions 1 to 5 as shown in FIG. 6A, and uses to derive temporal motion information is derived by using position 6 or 7 as shown in FIG. 6A. For the history-based motion information, each time a block is encoded or decoded, it is possible to add the motion information of the block to a first-in-first-out list; the adding process may require some checks, such as whether it duplicates the existing motion information in the list. In this way, the history-based motion information in the list may be referenced when encoding and decoding the current block.

In some embodiments, a syntax description of GPM is shown in Table 1.

TABLE 1

| | |
|---|---|
| regular_merge_flag[x0][y0] | ae(v) |
| if( regular_merge_flag[x0][y0] == 1 ) { | |
| if( sps_mmvd_enabled_flag ) | |
| mmyd_merge_flag[x0][y0] | ae(v) |
| if( mmvd_merge_flag[x0][y0] == 1 ) { | |
| if( MaxNumMergeCand > 1 ) | |
| mmvd_cand_flag[x0][y0] | ae(v) |
| mmvd_distance_idx[x0][y0] | ae(v) |
| mmvd_direction_idx[x0][y0] | ae(v) |
| } else if( MaxNumMergeCand > 1 ) | |
| merge_idx[x0][y0] | ae(v) |
| } else { | |
| if( sps_ciip_enabled_flag && sps_gpm_enabled_flag && | |
| sh_slice_type == B && | |
| cu_skip_flag[x0][y0] == 0 && cbWidth >= 8 && cbHeight >= 8 && | |
| cbWidth < (8*cbHeight) && cbHeight < (8*cbWidth) && | |
| cbWidth < 128 && cbHeight < 128 ) | |
| ciip_flag[x0][y0] | ae(v) |
| if( ciip_flag[x0][0] && MaxNumMergeCand > 1 ) | |
| merge_idx[x0][y0] | ae(v) |
| if( !ciip_flag[x0][y0] ) { | |
| merge_gpm_partition_idx[x0][y0] | ae(v) |
| merge_gpm_idx0[x0][y0] | ae(v) |
| if( MaxNumGpmMergeCand > 2 ) | |
| merge_gpm_idx1[x0][y0] | ae(v) |
| } | |
| } | |

As shown in Table 1, in the merge mode, if regular_merge_flag is not 1, CIIP or GPM may be used for the current block. If the CIIP is not used for the current block, then GPM is used, which is shown in the syntax “if (!ciip_flag [x0] [y0])” in Table 1.

As may be seen from Table 1, for the GPM, there is a need to transmit three pieces of information, i.e., “merge_gpm_partition_idx”, “merge_gpm_idx0”, and “merge_gpm_idx1” in the bitstream, where x0, y0 are used to determine the coordinates (x0, y0) of the top-left corner luma sample of the current block relative to the top-left corner luma sample of the picture. “merge_gpm_partition_idx” determines the partition shape of GPM, as mentioned above, which is “simulated partition”. “merge_gpm_partition_idx” is a weight matrix derivation mode or an index of the weight matrix derivation mode, or a weight derivation mode or an index of the weight derivation mode. “merge_gpm_idx0” is a first merge candidate index, and the first merge candidate index is used to determine first motion information or a first merge candidate according to mergeCandList. “merge_gpm_idx1” is a second merge candidate index, and the second merge candidate index is used to determine second motion information or a second merging candidate according to mergeCandList. If “MaxNumGpmMergeCand >2”, i.e., the length of the candidate list is greater than 2, “merge_gpm_idx1” needs to be decoded, otherwise it may be determined directly.

In some embodiments, a decoding process in GPM includes the following steps.

The input information during the decoding process includes: coordinates (xCb, yCb) of a luma position of a top-left corner of a current block relative to a top-left corner of a picture, a width cbWidth of a luma component of the current block, a height cbHeight of a luma component of the current block, luma motion vectors mvA and mvB with 1/16 sample accuracy, chroma motion vectors mvCA and mvCB, indexes of a reference frame refIdxA and refIdxB, and prediction list flags predListFlagA and predListFlagB.

For example, a motion vector, a reference frame index and a prediction list flag may be combined to represent the motion information. VVC supports two reference frame lists, each of which may have multiple reference frames. For the Uni-prediction, only one reference block in one reference frame in one of the reference frame lists is used as a reference, and for bi-prediction, each reference block in each reference frame in two reference frame lists is used as a reference. For the GPM in VVC, two uni-predictions is performed. In the mvA and mvB, mvCA and mvCB, refIdxA and refIdxB, predListFlagA and predListFlagB, A may be understood as a first prediction mode, and B may be understood as a second prediction mode. X represents A or B, “predListFlagX” represents whether X uses the first reference frame list or the second reference frame list, “refIdxX” represents the reference frame index in the reference frame list used by X, “mvX” represents the luma motion vector used by X, and “mvCX” represents the chroma motion vector used by X. To reiterate, in VVC, it is considered that the motion vector, reference frame index and prediction list flag may be combined to represent the motion information described herein.

The output information during the decoding process includes: a luma prediction sample matrix predSamplesL of (cbWidth) x (cbHeight); a prediction sample matrix of a Cb chroma component of (cbWidth/SubWidthC) x (cbHeight/SubHeightC), if necessary; and a prediction sample matrix of a Cr chroma component of (cbWidth/SubWidthC) x (cbHeight/SubHeightC), if necessary.

For example, the following will be made by taking the luma component as an example, and the processing for the chroma component is similar to that for the luma component.

Assume that predSamplesLAL and predSamplesLBL each have a size of (cbWidth)×(cbHeight), which are prediction sample matrices made according to two prediction modes. predSamplesL is derived as follows: predSamplesLAL and predSamplesLBL being determined according to the luma motion vectors mvA and mvB, the chroma motion vectors mvCA and mvCB, the reference frame indices refIdxA and refIdxB, and the prediction list flags predListFlagA and predListFlagB, respectively. That is, prediction is performed according to the motion information in the two prediction modes respectively, and the detailed process will not be repeated any more. GPM is a merge mode generally, and it may be considered that the two prediction modes of GPM are both merge modes.

According to merge_gpm_partition_idx [xCb][yCb], Table 2 is used to determine the partition angle index variable angleIdx and distance index variable distanceIdx for the GPM.

TABLE 2
Corresponding relationship between angleIdx and distanceIdx and merge_gpm_partition_idx

| merge_gpm_partition_idx | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| angleIdx | 0 | 0 | 2 | 2 | 2 | 2 | 3 | 3 | 3 | 3 | 4 | 4 | 4 | 4 | 5 | 5 |
| distanceIdx | 1 | 3 | 0 | 1 | 2 | 3 | 0 | 1 | 2 | 3 | 0 | 1 | 2 | 3 | 0 | 1 |
| merge_gpm_partition_idx | 16 | 17 | 18 | 19 | 20 | 21 | 22 | 23 | 24 | 25 | 26 | 27 | 28 | 29 | 30 | 31 |
| angleIdx | 5 | 5 | 8 | 8 | 11 | 11 | 11 | 11 | 12 | 12 | 12 | 12 | 13 | 13 | 13 | 13 |
| distanceIdx | 2 | 3 | 1 | 3 | 0 | 1 | 2 | 3 | 0 | 1 | 2 | 3 | 0 | 1 | 2 | 3 |
| merge_gpm_partition_idx | 32 | 33 | 34 | 35 | 36 | 37 | 38 | 39 | 40 | 41 | 42 | 43 | 44 | 45 | 46 | 47 |
| angleIdx | 14 | 14 | 14 | 14 | 16 | 16 | 18 | 18 | 18 | 19 | 19 | 19 | 20 | 20 | 20 | 21 |
| distanceIdx | 0 | 1 | 2 | 3 | 1 | 3 | 1 | 2 | 3 | 1 | 2 | 3 | 1 | 2 | 3 | 1 |
| merge_gpm_partition_idx | 48 | 49 | 50 | 51 | 52 | 53 | 54 | 55 | 56 | 57 | 58 | 59 | 60 | 61 | 62 | 63 |
| angleIdx | 21 | 21 | 24 | 24 | 27 | 27 | 27 | 28 | 28 | 28 | 29 | 29 | 29 | 30 | 30 | 30 |
| distanceIdx | 2 | 3 | 1 | 3 | 1 | 2 | 3 | 1 | 2 | 3 | 1 | 2 | 3 | 1 | 2 | 3 |

It will be noted that, since three components (such as Y, Cb, Cr) may be used for GPM, in some standard texts, the process of generating a prediction sample matrix for GPM for one component is packaged into a sub-process, that is, a weighted sample prediction process for geometric partitioning mode (GPM). This process will be invoked for All the three components, but the parameters invoked are different. Here, only the luma component is used as an example. The prediction matrix predSamplesL [xL] [yL] of the current luma block (where xL=0 . . . cbWidth−1, yL=0 . . . cbHeight−1) is derived through the weighted sample prediction process for GPM. Among them, nCbW is set to cbWidth, nCbH is set to cbHeight, the prediction sample matrices predSamplesLAL and predSamplesLBL, and angleIdx and distanceIdx that are made in the two prediction modes are used as input.

In some embodiments, a weighted prediction derivation process of the GPM includes the following steps.

The inputs of the process include: a width nCbW of the current block, a height nCbH of the current block; two (nCbW)×(nCbH) prediction sample matrices predSamplesLA and predSamplesLB; the partition angle index variable angleIdx for the GPM; the distance index variable distanceIdx for the GPM; and the component index variable cldx. In this example, chroma is taken as an example, the above cIdx is 0, indicating the chroma component.

The outputs for this process include: (nCbW)×(nCbH) prediction sample matrix pbSamples for the GPM.

For example, variables nW, nH, shift1, offset1, displacementX, displacementY, partFlip and shiftHor are derived as follows:

$$nW = ( cIdx == 0 ) ? nCbW : nCbW * SubWidthC ;$$

$$nH = ( cIdx == 0 ) ? nCbH : nCbH * SubHeightC ;$$

$$shift 1 = Max ( 5 , 17 - BitDepth ) , \\ where BitDepth is a bit depth of the encoding and decoding ;$$

$$offset 1 = 1 << ( shift 1 - 1 ) , where << means left shift ;$$

$$displacementX = angleIdx ;$$

$$displacementY = ( angleIdx + 8 ) \%32 ;$$

$$partFlip = ( angleIdx >= 13 \&\& angleIdx <= 27 ) ? 0 : 1 ;$$

$$shiftHor = ( angleIdx \% 16 == 8 ‖ ( angleIdx \%16 != 0 \&\& nH >= nW ) ) ? 0 : 1.$$

The variables offsetX and offsetY are derived as follows:
if the value of shiftHor is 0,

$$offsetX = ( - nW ) >> 1 ,$$

$$offsetY = ( ( - nH ) >> 1 ) + ( angleIdx < 16 ? ( distanceIdx * nH ) >> 3 : - ( ( distanceIdx * nH ) >> 3 ) ) .$$

if the value of shiftHor is 1:

$$offsetX = ( ( - nW ) >> 1 ) + ( angleIdx < 16 ? ( distanceIdx * nW ) >> 3 : - ( ( distanceIdx * nW ) >> 3 ) ) ,$$

$$offsetY = ( - nH ) >> 1.$$

The variables xL and yL are derived as follows:

$$xL = ( cIdx == 0 ) ? x : x * SubWidthC ,$$

$$yL = ( cIdx == 0 ) ? y : y * SubHeightC ,$$

The variable wValue indicating the weight of the prediction sample at the current position is derived as follows: wValue is the weight of the prediction value predSamplesLA[x][y] of the prediction matrix for the first prediction mode at the point (x, y), and (8−wValue) is the weight of the prediction value predSamplesLB[x][y] of the prediction matrix for the second prediction mode at the point (x, y).

The distance matrix disLut is determined according to Table 3.

TABLE 3

| idx | 0 | 2 | 3 | 4 | 5 | 6 | 8 | 10 | 11 | 12 | 13 | 14 |
|---|---|---|---|---|---|---|---|---|---|---|---|---|
| disLut[idx] | 8 | 8 | 8 | 4 | 4 | 2 | 0 | −2 | −4 | −4 | −8 | −8 |
| idx | 16 | 18 | 19 | 20 | 21 | 22 | 24 | 26 | 27 | 28 | 29 | 30 |
| disLut[idx] | −8 | −8 | −8 | −4 | −4 | −2 | 0 | 2 | 4 | 4 | 8 | 8 |

$$weightIdx = ( ( ( xL + offsetX ) << 1 ) + 1 ) * disLut [ displacementX ] + ( ( ( yL + offsetY ) << 1 ) + 1 ) * disLut [ displacementY ] ,$$

$$weightIdxL = partFlip ? 32 + weightIdx : 32 - weightIdx ,$$

$$wValue = Clip 3 ( 0 , 8 ( weightIdxL + 4 ) >> 3 ) .$$

The values of the prediction samples pbSamples[x][y] are derived as follows:

$$pbSamples [ x ] [ y ] = Clip 3 ( 0 , ( 1 << BitDepth ) - 1 , ( predSamplesLA [ x ] [ y ] * wValue + predSamplesLB [ x ] [ y ] * ( 8 - wValue ) + offset 1 ) >> shift 1 ) .$$

It will be noted that a weight value is derived for each position of the current block, and then a prediction value pbSamples[x][y] of the GPM is calculated. In this way, the weight wValue does not need to be written in a form of a matrix, but it may be understood that if the wValue at each position is saved in a matrix, then a weight matrix is formed. The weight is calculated for each point and then weighting is performed to obtain the prediction value of GPM, or all the weights are calculated and then weighting is performed uniformly to obtain the prediction sample matrix of GPM, both of which have the same principle. The term “weight matrix” used in many descriptions in the present application is to make the expression easy to understand, and the illustration with the weight matrix is more intuitive. In fact, the description may also be made according to the weight at each position. For example, the weight matrix derivation mode may also be referred to as the weight derivation mode.

In some embodiments, as shown in FIG. 6B, a decoding process for GPM may be expressed as: parsing a bitstream to determine whether a current block employs the GPM technology; if the current block employs the GPM technology, determining a weight derivation mode (or partition mode or weight matrix derivation mode), first motion information and second motion information; determining a first prediction block according to the first motion information, and determining a second prediction block according to the second motion information; determining a weight matrix according to the weight matrix derivation mode, and determining a prediction block of a current block according to the first prediction block, the second prediction block and the weight matrix.

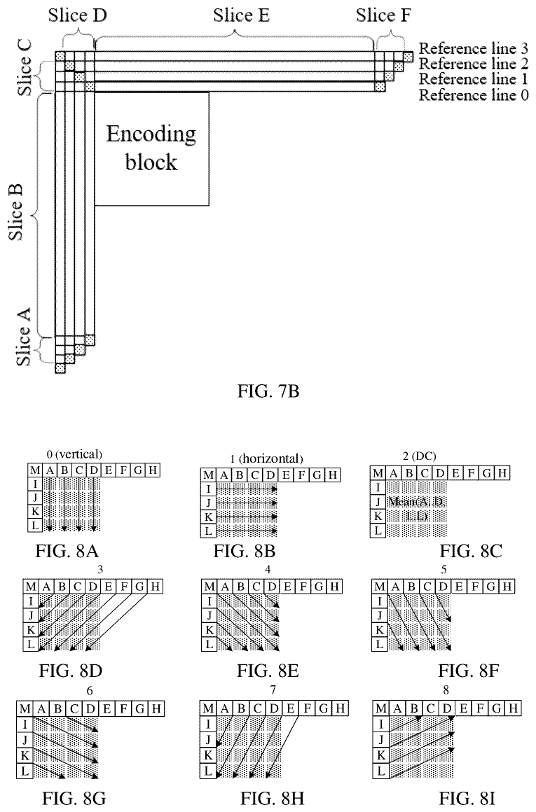

For the intra prediction mode, reconstructed samples that have been encoded and decoded around the current block may be used as reference samples for performing prediction on the current block. FIG. 7A is a schematic diagram of intra prediction. As shown in FIG. 7A, the size of the current block is 4×4, and the samples in a left row and a top column of the current block are reference samples of the current block. For the intra prediction, the prediction is performed on the current block by using these reference samples. For these reference samples, all of them be available, that is, all of them have been encoded or decoded; or some of them may be unavailable, for example, if the current block is at the leftmost portion of the whole frame, then the reference samples at the left of the current block are unavailable; or when encoding or decoding the current block, the bottom-left part of the current block has not been encoded or decoded, so the reference sample at the bottom-left is also unavailable. For the case that the reference samples are unavailable, available reference samples or certain values or methods may be used for padding or not.

FIG. 7B is a schematic diagram of intra prediction. As shown in FIG. 7B, for a multiple reference line (MRL) intra prediction mode, more reference samples may be used to improve coding efficiency; for example, four reference rows/columns are used as reference samples of a current block.

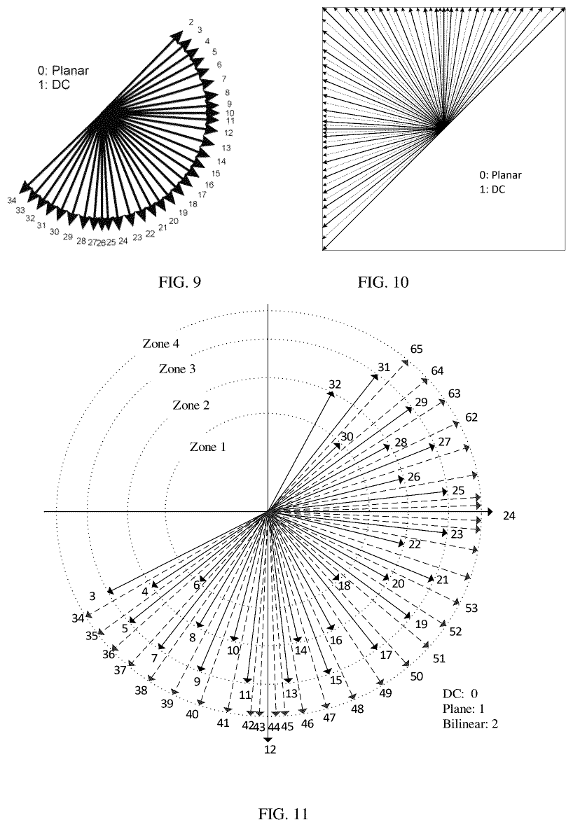

Furthermore, there are several prediction modes for intra prediction. FIG. 8A to 8I are schematic diagrams of intra prediction. As shown in FIG. 8A to 8I, intra prediction for 4×4 blocks in H.264 may mainly include 9 modes. for the mode 0 as shown in FIG. 8A, the samples at the top of the current block are copied in vertical direction to the current block as prediction values; for the mode 1 as shown in FIG. 8B, the reference samples at the left of the current block are copied in horizontal direction to the current block as prediction values; for the mode 2 (DC) as shown in FIG. 8C, the average value of the eight points A to D and I to L is used as a prediction value of all points; and for the modes 3 to 8 as shown in FIGS. 8D to 8I, the reference samples are copied to the corresponding positions of the current block at a certain angle, respectively. Since some certain positions of the current block cannot correspond exactly to the reference samples, a weighted average value of the reference samples, or interpolated fractional samples of the reference samples may need to be used.

In addition, there are a plane mode, a planar mode and other modes. With a development of technology and an expansion of a block, there are more and more angle prediction modes. FIG. 9 is a schematic diagram of intra prediction modes. As shown in FIG. 9, the intra prediction modes used in HEVC include a planar mode, a DC mode, and 33 angle modes, for a total of 35 prediction modes. FIG. 10 is a schematic diagram of intra prediction modes. As shown in FIG. 10, the intra prediction modes used in VVC include a planar mode, a DC mode, and 65 angle modes, for a total of 67 prediction modes. FIG. 11 is a schematic diagram of intra prediction modes. As shown in FIG. 11, 66 prediction modes, including a DC mode, a plane mode, a bilinear mode, a PCM mode, and 62 angle modes are used in VS3.

Furthermore, there are some other technologies to improve the prediction, such as improving a fractional sample interpolation of reference samples, or filtering the prediction samples. For example, the multiple intra prediction filter (MIPF) in AVS3 uses different filters to generate prediction values for different block sizes. For the samples at different positions in the same block, a filter is used for samples closer to the reference sample to generate prediction values, and another filter is used for samples farther from the reference sample to generate prediction values. By using the technology of filtering the prediction samples, such as the intraprediction filter (IPF) in AVS3, the filtering is performed on the reference samples to obtain the prediction values.

For intra prediction, the intra mode encoding technology of the most probable modes (MPM) list may be used to improve the encoding and decoding efficiency. A mode list is formed by using the intra prediction modes for the neighboring encoded and decoded blocks, as well as the intra prediction modes derived from the intra prediction modes for the neighboring encoded and decoded blocks, such as neighboring modes, and some of the intra frame prediction modes that are commonly used or have a relatively high probability of being used, such as a DC mode, a planar mode, a bilinear mode. The intra prediction mode that refers to neighboring encoded and decoded blocks utilizes the spatial correlation, because the texture has a some spatial continuity. MPM may be used for the prediction for intra prediction mode. That is, it is considered that the probability of using MPM for the current block will be higher than the probability of not using MPM. Therefore, during binarization, less codewords will be used for MPM, thereby saving overhead and improving encoding and decoding efficiency.

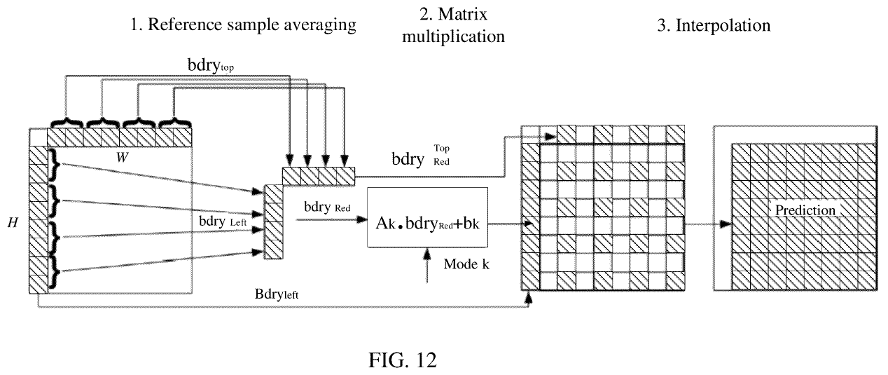

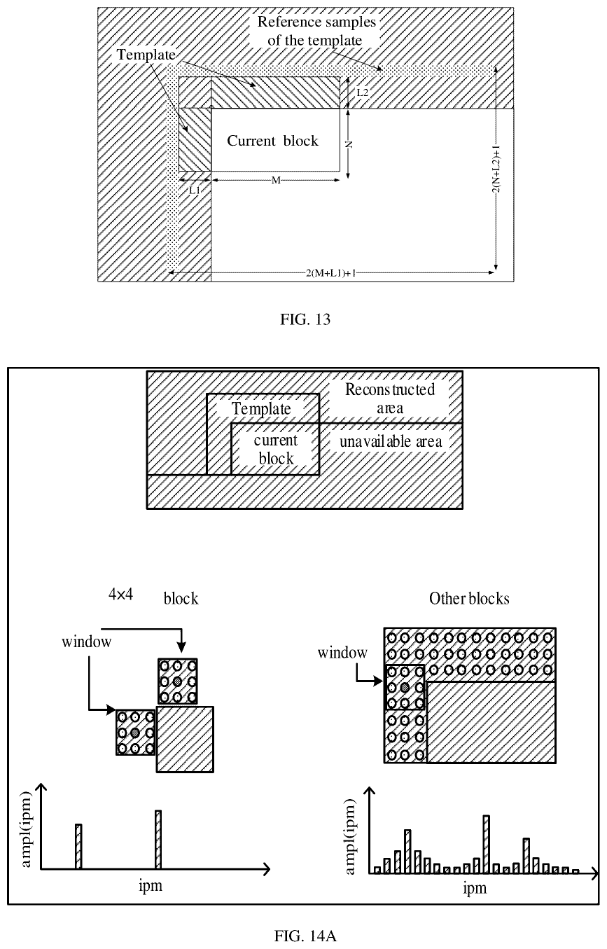

In some embodiments, matrix-based intra prediction (MIP), sometimes also written as matrix weighted intra prediction, may be used for intra prediction. As shown in FIG. 12, in order to predict a block with a width of W and a height of H, H reconstructed samples in a left column of the current block and W reconstructed samples in a top row of the current block are needed as inputs for MIP. A prediction block is generated in MIP based on the following three steps: reference sample averaging, matrix vector multiplication, and interpolation. Matrix vector multiplication is a core of MIP. MIP may be considered as a process of generating a prediction block using input samples (reference samples) in a matrix vector multiplication manner. A variety of matrices are provided in MIP, the difference in prediction modes are reflected in the differences in matrices. The same input sample will get different results using different matrices. The process of reference sample averaging and interpolation is a design that compromises performance and complexity. For a large block, the reference sample averaging is performed to achieve an effect similar to down-sampling, so that the inputs may adapted to a small matrix, while interpolation achieves an up-sampling effect. In this way, there is no need to provide an MIP matrix for the block with each size, but only matrices with one or more specific sizes are provided. As the demand for compression performance increases and hardware capabilities improve, a more complex MIP may appear in the next generation of standards.

MIP is similar to the planar mode, but obviously, the MIP is more complex and more flexible than the planar mode.

In some embodiments, a template-based intra mode derivation (TIMD) intra prediction technique may be used. Exemplarily, as shown in FIG. 13, for a current block, an area on the left and top of the current block is used as a template. Except for the boundary, when encoding and decoding the current block, reconstructed values may be obtained at the left and top of the current block theoretically, which is a basis of many template adaptation methods. For TIMD, the left and top areas of the current block shown in FIG. 13 is used as a template, and the samples in the left and top areas in the template are used as reference samples of the template. The decoder may employ a certain intra prediction mode to perform prediction on the template, and compare a prediction value with the reconstructed value to obtain a cost of the intra prediction mode on the template. For example, a sum of absolute difference (SAD), a sum of absolute transformed difference (SATD), or a sum of squared error (SSE). Since the template and the current block are neighboring and correlated, the performance of a prediction mode on the template may be used to estimate its performance on the current block. For TIMD, the template is predicted in some candidate intra prediction modes to obtain costs of the candidate intra prediction mode on the template, and one or two intra prediction modes with the lowest costs are taken as the intra prediction values of the current block.

It is found through researches that if the difference between the costs of two intra prediction modes on the template is not large, weighted average is performed on the prediction values of the two intra prediction modes to improve the compression performance. The weights of the prediction values of the two prediction modes are related to the above-mentioned costs. In some embodiments, the weights are inversely proportional to the costs.

To summarize, for TIMD, the prediction effects of the intra prediction modes on the template are used to select the intra prediction mode, and weighting is performed on the costs of the two intra prediction modes on the template. The advantage of TIMD is that if the current block selects the TIMD mode, then there is no need to indicate which specific intra prediction mode is used, but it is derived by the decoder itself through the above process, which saves overhead to a certain extent.

In some embodiments, an intra prediction technique of decoder-side intra mode derivation (DIMD) may be used. For DIMD, the prediction mode is derived by using the reconstructed samples on the left and top of the current block, but it does not perform prediction on the template, but perform analyzation on a gradient of the reconstructed samples. As shown in FIG. 14A, for DIMD, the gradient of a center point of a window is analyzed and an intra prediction mode is selected according to the gradient. All points that need to be checked are analyzed to obtain a result similar to a histogram shown in FIG. 14A. Certainly, the histogram is only for understanding, and it may be implemented in a variety of simple forms. In some embodiments, in DIMD, for two highest-probability intra prediction modes selected in the histogram, and the planar mode, for a total of three intra prediction modes, and weighting is performed on the prediction values of the three intra prediction modes, the weights are related to the analysis results.

In an example, a prediction process of DIMD is shown in FIG. 14B: for the two highest-probability intra prediction modes i.e., the intra prediction modes corresponding to M1 and M2, that are selected in the histogram, and the planar mode, for a total of three intra prediction modes, weights ω1, ω2 and ω3 corresponding to the three intra prediction modes are determined, and the prediction values Pred1, Pred2 and Pred3 corresponding to the three intra prediction modes are determined; based on the weights corresponding to the three intra prediction modes, the prediction values corresponding to the three intra prediction modes are weighted to obtain a final prediction block.

From the above, it may be seen that for DIMD, the intra prediction mode is selected by using the gradient analysis of reconstructed samples, and weighting is performed on the two intra prediction modes and the planar mode according to the analysis results. The advantage of DIMD is that if the current block selects the DIMD mode, then there is no need to represent which specific intra prediction mode is used, but it is derived by the decoder itself through the above process, which saves overhead to a certain extent.

TIMD and DIMD have many similarities, and in some embodiments, their names are even reversed, all of both support weighting for prediction values from two or more intra prediction modes.

For GPM, two inter prediction blocks are combined by using a weight matrix. In fact it may be extended to combine two arbitrary prediction blocks, such as two inter prediction blocks, two intra prediction blocks, one inter prediction block and one intra prediction block. Even in screen content coding, the prediction block of intra block copy (IBC) or palette may be used as one or two prediction blocks of the two inter prediction blocks.

In the present application, intra, inter, IBC, and palette are referred to as different prediction manners. For the sake of convenience, a term called prediction mode is used here. The prediction mode may be understood as that information of a prediction block of the current block is generated by the encoder and decoder according to the prediction mode. For example, in intra prediction, the prediction mode may be a certain intra prediction mode, such as modes of DC, planar, or various intra angular prediction modes. Certainly, one or some auxiliary information may also be superimposed, such as an optimization method for intra reference samples, or an optimization method after generating a preliminary prediction block (such as filtering). For example, in inter prediction, the prediction mode may be a skip mode, a merge mode or an MMVD (merge with motion vector difference) mode, or an AMVP (advanced motion vector predition), which may be uni-prediction, bi-prediction or multi-hypothesis prediction. In response to that the inter prediction mode uses uni-prediction, one piece of motion information can be determined in a prediction mode, and the prediction block may be determined according to the motion information. In response to that the inter prediction mode uses bi-prediction, two pieces of motion information can be determined in a prediction mode, and the prediction block may be determined according to the two pieces of motion information.

In this way, the information that needs to determine for GPM may be expressed as one weight derivation mode and two prediction modes. The weight derivation mode is used to determine the weight matrix or weights, and the two prediction modes are both used to determine a prediction block or prediction value. The weight derivation mode is also referred to as partition mode in some cases. However, because it is simulation partition, it is referred to as a weight derivation mode in the present application.

Optionally, the two prediction modes may come from the same or different prediction modes, where the prediction modes include but are not limited to an intra prediction, an inter prediction, IBC, and palette.

An exemplary example is as follows: GPM is used for a current block. This example is used in inter encoded blocks, allowing the use of merge mode in intra prediction and inter prediction. As shown in Table 4, a syntax element intra_mode_idx is added to represent which prediction mode is the intra prediction mode. For example, intra_mode_idx is 0, which represents that two prediction modes are both inter prediction modes, that is, mode0IsInter is 1 and mode0IsInter is 1; intra_mode_idx is 1, which represents that the first prediction mode is the intra prediction mode, and the second prediction mode is the inter prediction mode, that is, mode0IsInter is 0 and mode0IsInter is 1; intra_mode_idx is 2, which represents that the first prediction mode is the inter prediction mode, and the second prediction mode is the intra prediction mode, that is, mode0IsInter is 1 and mode0IsInter is 0; intra_mode_idx is 3, which represents that two prediction modes are both intra prediction modes, that is, mode0IsInter is 0 and mode0IsInter is 0.

TABLE 4

| | |
|---|---|
| { | |
| merge_gpm_partition_idx[x0][y0] | ae(v) |
| intra_mode_idx[x0][y0] | ae(v) |
| if( mode0IsInter ) | |
| merge_gpm_idx0[x0][y0] | ae(v) |
| if( (!mode0IsInter && mode1IsInter) \|\| (MaxNumGpmMergeCand > 2 && | |
| mode0IsInter && modelIsInter)) | |
| merge_gpm_idx1[x0][y0] | ae(v) |
| } | |

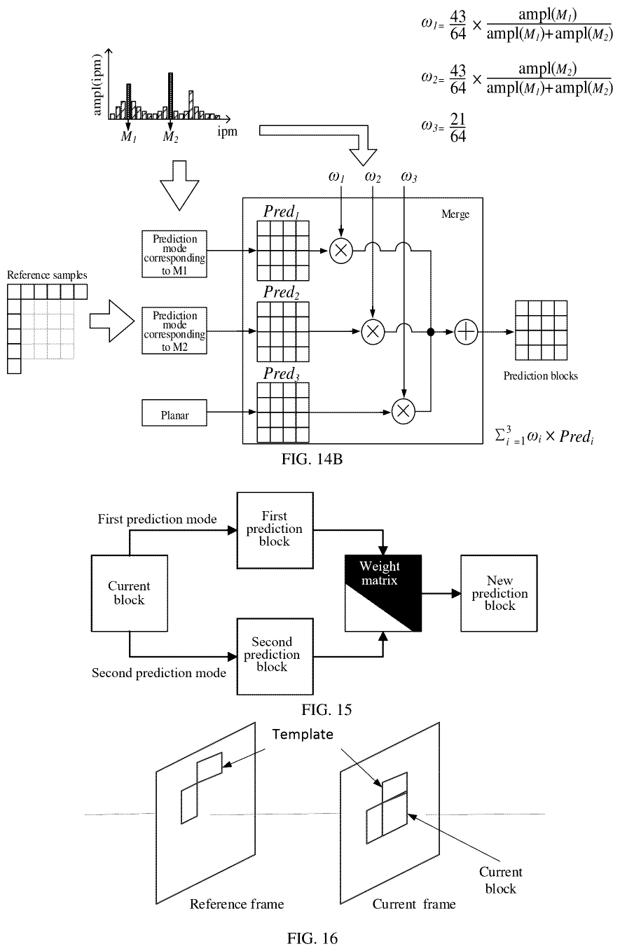

In some embodiments, as shown in FIG. 15, the decoding process in GPM may be expressed as: parsing a bitstream to determine whether a current block employs the GPM technology; if the current block employs the GPM technology, determining a weight derivation mode (or partition mode or weight matrix derivation mode), first prediction mode and a second prediction mode; determining a first prediction block according to the first prediction mode, and determining a second prediction block according to the second prediction mode; determining a weight matrix according to the weight matrix derivation mode, and determining a prediction block of the current block according to the first prediction block, the second prediction block and the weight matrix.

The method of template matching was first used in inter prediction, which uses the correlation between neighboring samples and takes some areas neighboring the current block as a template. When encoding and decoding are performed on the current block, the left and the top of the current block have already been encoded and decoded in an encoding order. Certainly, in existing hardware decoder implementations, there is no guarantee that the left and top neighboring blocks will have been decoded when decoding for the current block begins. This particularly applies to inter blocks. For example, in HEVC, when generating a prediction block for an inter-coding block, the neighboring reconstructed samples are not required, so the prediction process for the inter block may be performed in parallel. However, for the intra-coding block, the reconstructed samples at the left and top are required as reference samples. Theoretically, reference samples at the left and top are available, which means that it may be achieved by making corresponding adjustments on hardware design. Relatively speaking, reference samples at the right and bottom are not available in an encoding order in the current standard such as VVC.

As shown in FIG. 16, rectangular areas at the left and top of the current block are set as a template. The height of the left part of the template is generally the same as the height of the current block, and the width of the top part of the template is generally the same as the width of the current block. Alternatively, the template may have a different height or width from the current block. The optimal matching position of the template is found in a reference frame to determine motion information or a motion vector of the current block. This process may be generally described as follows. In a certain reference frame, search is performed within a certain range around the initial position starting from an initial position. The search rules may be pre-set, such as a search range, a search step. Upon moving to a position each time, a matching degree between the template corresponding to the position and the template neighboring the current block is calculated. The matching degree may be measured by some distortion costs, such as SAD (sum of absolute difference) and SATD (sum of absolute transformed difference). Generally, the transforms used by SATD are Hadamard transform, MSE (mean-square error), etc. The smaller the values of SAD, SATD, MSE, etc., the higher the matching degree. A cost is calculated based on the prediction block of the template corresponding to the position and the reconstructed blocks of the template neighboring the current block. In addition to searching for the position of an integer sample, searching may also be performed for the position of a fractional sample, and the motion information of the current block may be determined according to the searched position with the highest-probability matching degree. By utilizing the correlation between neighboring samples, the motion information that is appropriate for the template may also be the appropriate motion information for the current block. Certainly, the method of template matching may not be suitable for applicable to all blocks, so some methods may be used to determine whether the method of template matching is used for the current block; for example, a control switch is used for the current block to represent whether the method of template matching is used. Such method of template matching is referred to as DMVD (decoder side motion vector derivation). Both the encoder and the decoder may perform searching by using the template to derive motion information or fine better motion information based on the original motion information without transmitting specific motion vectors or a motion vector difference. Instead, both the encoder and decoder perform searching with the same regular to ensure consistency in encoding and decoding. The method of template matching may improve compression performance, but “searching” in the decoder still required to perform “searching”, which causes a certain degree of complexity for the decoder.

The above is a method of applying template matching to inter prediction, and the method of template matching may also be applied to intra prediction; for example, a template is used to determine an intra prediction mode. For the current block, the areas within a certain range at the top and left of the current block may also be used as a template, for example, the rectangular area on the left and the rectangular area on the top as shown in the FIG. 16. When encoding or decoding the current block, the reconstructed samples in the template are available. This process may be generally described as follows. A set of candidate intra prediction modes is determined for the current block, the candidate intra prediction modes constituting a subset of all available intra prediction modes. Certainly, the candidate intra prediction modes may be a universal set of all available intra prediction modes, which may be determined based on the trade-off of performance and complexity. The set of candidate intra prediction modes may be determined according to the MPM or some rules, such as equidistant selection. The cost, such as SAD, SATD, or MSE, of each candidate intra prediction mode on the template is calculated. A prediction block is obtained by performing a prediction on the template in this mode, and the cost is calculated based on the prediction block and the reconstructed block of the template. A mode with a small cost may be more consistent with the template. Based on the similarity between neighboring samples, an intra prediction mode that performs well on the template may also be an intra prediction mode that performs well on the current block. One or several modes with a small cost models are selected. Certainly, the above two steps may be repeated. For example, after selecting one or several modes with a small cost, the set of candidate intra prediction modes is determined again, a cost of the newly determined set of candidate intra prediction modes is calculated again, and one or several modes with a small cost are selected. This may also be understood as rough selection and fine selection. The finally selected intra prediction mode is determined as the intra prediction mode for the current block, or the finally selected several intra prediction modes are used as candidates of the intra prediction mode for the current block. Certainly, it is also possible to sort the candidate intra prediction mode set by using only the method of template matching; for example, the MPM list is sorted, that is, a prediction block is obtained for the template for each of the modes in the MPM list and the cost is determined, and there modes are sorted in terms of cost in an ascending order. Generally, the higher the mode is in the MPM list, the smaller the overhead is in the bitstream, which may also achieve the purpose of improving compression efficiency.

The method of template matching may be used to determine two prediction modes for GPM. If the method of template matching is used for GPM, for the current block, one control switch may be used to control whether template matching is used for the two prediction modes of the current block, or two control switches may each be used to control whether template matching is used for a respective one of the two prediction modes.

Another aspect is how to use template matching. For example, if GPM is used in merge mode, such as the GPM in VVC, merge_gpm_idxX is used to determine motion information from mergeCandList, where the capital letter X is 0 or 1. For the Xth piece of motion information, one method is to optimize using the method of template matching based on the piece of motion information; that is, a piece of motion information is determined from mergeCandList according to merge_gpm_idxX, if template matching is used for the piece of motion information, optimization is performed based on the piece of motion information by using the method of template matching; another method is not to use merge_gpm_idxX to determine a piece of motion information from mergeCandList, but to directly search based on the default motion information to determine the piece of motion information.

If the Xth prediction mode is an intra prediction mode, and the method of template matching is used for the Xth prediction mode of the current block, then an intra prediction mode may be determined by using the method of template matching without representing an index of the intra prediction mode in a bitstream. Alternatively, a candidate set or an MPM list is determined by using a method of template matching, and the index of the intra prediction mode needs to be indicated in the bitstream.

In an intra and inter prediction mode for GPM, a prediction value in GPM is obtained by weighting weights of an intra prediction value and an inter prediction value using a GPM mode. The prediction mode information (motion information) of inter prediction is obtained by a method similar to the derivation method in the VVC standard. However, the prediction mode of intra prediction is obtained as follows. There is a need to construct an intra prediction mode candidate list for a corresponding part of the GPM mode, the list may also be referred to as an MPM list. The encoder writes the intra prediction mode index selected for the current block into a bitstream. The decoder constructs the MPM list for the GPM mode in the same way during decoding, and determines the intra prediction mode according to the intra prediction mode index obtained by decoding. For example, the corresponding part of the GPM mode may be understood as the white part or the black part in the partition diagram of FIG. 4 or FIG. 5, and may be referred to as a first part or a second part for the convenience of expression hereinafter. In an example, a first part is a white part, and a second part is a black part. The first part corresponds to the first prediction mode, and the second part corresponds to the second prediction mode. The first part and second part are more intuitive and easier to understand, but in practice they may not appear in the specific algorithm.

In a case of constructing the MPM list for the intra prediction mode of a part corresponding to the GPM mode, the following types of intra prediction modes are added to the MPM list in an order until the list length reaches 3:
1. an intra prediction mode parallel to a partition line in GPM
2. an intra prediction mode derived from DIMD;
3. an intra prediction mode derived from TIMD;
4. an intra prediction mode of a neighboring block;
5. an intra prediction mode vertical to a partition line in GPM; and
6. a PLANAR mode.

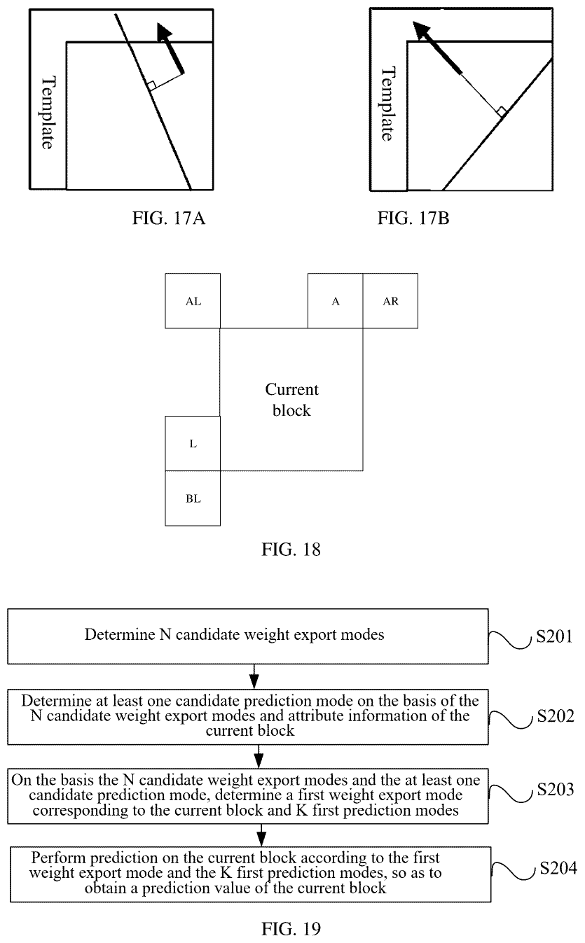

Among them, the intra prediction mode parallel to the partition line in GPM is shown in FIG. 17A, and the intra prediction mode vertical to the partition line in GPM is shown in FIG. 17B. The current exemplary implementation is to: determine an angle index angleIdx of partition in GPM according to the mode of GPM, construct a look-up table in which angleIdx corresponds to the intra prediction mode, and determine the intra prediction mode parallel to the partition line in GPM from the look-up table according to angleIdx. The vertical intra prediction mode is calculated based on the parallel intra prediction mode.

In some embodiments, in a case where the intra prediction modes of neighboring blocks are used, the intra prediction modes of up to 5 neighboring blocks are used, and the positions of the 5 neighboring blocks are shown in FIG. 18. The coordinates of the left-top corner of the current block are denoted as (x0, y0), the width of the current block is denoted as width, the height of the current block is denoted as height, and the 5 neighboring blocks are respectively a neighboring block AL determined by the coordinates (x0-1, y0-1), a neighboring block A determined by (x0+width-1, y0-1), a neighboring block AR determined by (x0+width, y0-1), a neighboring block L determined by (x0-1, y0+height-1), and a neighboring block BL determined by (x0-1, y0+height).

According to whether the intra prediction mode corresponds to the first portion or the second portion, and the angle index angleIdx corresponding to the mode of GPM, the range of the available neighboring blocks is determined by looking up Table 5 below.

TABLE 5

| Angle Index | 0 | 2 | 3 | 4 | 5 | 8 | 11 | 12 | 13 | 14 |
|---|---|---|---|---|---|---|---|---|---|---|
| First part | A | A | A | A | L + A | L + A | L + A | L + A | A | A |
| Second part | L + A | L + A | L + A | L | L | L | L | L + A | L + A | L + A |
| Angle Index | 16 | 18 | 19 | 20 | 21 | 24 | 27 | 28 | 29 | 30 |
| First part | A | A | A | A | L + A | L + A | L + A | L + A | A | A |
| Second part | L + A | L + A | L + A | L | L | L | L | L + A | L + A | L + A |

In Table 5, “A” may be understood as the neighboring block on the top of the current block, and L may be understood as the neighboring block on the left of the current block. If the result obtained by looking up Table 5 is A, then the intra prediction mode of the neighboring block A and the intra prediction mode of the neighboring block AR may be used. If the result obtained by looking up the table is L, then the intra prediction mode of the neighboring block L and the intra prediction mode of the neighboring block BL may be used. If the result obtained by looking up the table is L+A, then the intra prediction modes of the neighboring blocks A, AR, L, and BL may be used. The prediction mode of the neighboring block AL is always available. The order for checking neighboring blocks is L→A→BL→AR→AL.

From the above, it can be seen that there are 3 elements, one weight matrix and 2 prediction modes for GPM. The advantage of GPM is that more autonomous combinations may be achieved via the weight matrix. On the other hand, more information needs to be determined in GPM, so more overhead needs to be paid in the bitstream. Considering GPM as an example, optionally, GPM is used in merge mode. In the bitstream, merge_gpm_partition_idx, merge_gpm_idx0, merge_gpm_idx1 are used to determine the weight matrix, the first prediction mode and the second prediction mode respectively. The weight matrix and the 2 prediction modes each have multiple possible options. For example, the weight matrix in VVC has 64 possible options. Merge_gpm_idx0 and merge_gpm_idx1 each allow a maximum of 6 possible choices in VVC. Certainly, in VVC, it stipulates that merge_gpm_idx0 and merge_gpm_idx1 are not repeated, so there are 65×6×5 possible options for GPM. If MMVD is used to optimize 2 pieces of motion information (prediction modes), multiple possible options may be provided for each prediction mode. In this case, the number of possible options is quite huge. Furthermore, it may be found that the method of template matching may also be used to optimize two pieces of motion information (prediction modes), which also provides more possible options. Even the method of template matching is used for optimizing two pieces of motion information (prediction modes), based on the current state of technological evolution, it requires a block-level switch to indicate whether the method of template matching is used for the current block.

Moreover, if GPM uses 2 intra prediction modes, each of which may use 67 common intra prediction modes in VVC, and the two intra prediction modes are different, there are also 64×67×66 possible options. Certainly, to save overhead, each prediction mode may be restricted to use only a subset of all common intra prediction modes, but there are still many possible options.

If 1 intra prediction mode and 1 inter prediction mode are used for GPM, the situation may be deduced based on the above cases of intra prediction mode and inter prediction mode.

In some embodiments, the indication of 1 weight derivation mode and 2 prediction modes for GPM is encoded into a bitstream and the bitstream is parsed using respective syntax elements. That is, 1 weight derivation mode has its own one or more syntax elements, the first prediction mode has its own one or more syntax elements, and the second prediction mode has its own one or more syntax elements. Certainly, the standard may restrict that the second prediction mode cannot be the same as the first prediction mode in some cases, or some certain optimization methods may be used for both 2 prediction modes (which may also be understood as being used for the current block), but the three are relatively independent in the writing and parsing of syntax elements. The “relative independence” may also be understood as having a certain connection, but after removing the restrictions, other possible options are still independent.

For events of equal probability, it is more appropriate to use fixed-length encoding. For situations where the probabilities are obviously high and low, using short codes for high-probability events and long codes for low-probability events may improve encoding efficiency. For the weight derivation mode and the prediction mode, which are two modes of different dimensions, their probability estimates are separate from each other.

Since a weight derivation mode and 2 prediction modes are jointly used for generating a prediction block, this prediction block acts on the current block, and there is a connection between them. To give a few examples, if the current block contains edges of two objects moving relative to each other, which is an ideal scenario for inter prediction in GPM. In theory, this “partition” should occur at the edges of the objects, but in reality, there are limited probabilities for “partition”, which is impossible to cover any edge. Sometimes similar “partition” are chosen, so there may be more than one probability for similar “partition”. The choice depends on which “partition” produces the best result in a case of combining with the two prediction modes. Similarly, the choice of prediction mode sometimes also depends on which combination produces the best result, because even for the part to which this prediction mode is used, for natural video, this part is difficult to completely match the current block, and the final selection may be the one with the highest encoding efficiency. Another common use for GPM is a case where the current block contains parts of an object that are in relative motion. For example, a part of the arm for swing leads to distortion and deformation, such “partition” is even more vague, which may ultimately depend on which combination produces the best result. Another scenario is for intra prediction. Since the texture of some parts of a natural picture is very complex, some parts have a gradient from one texture to another texture, and the texture of some parts may not be able to be described in a simple direction. In this case, the intra prediction for GPM may provide more complex prediction blocks, and the intra encoding blocks usually have larger residuals than the inter encoding blocks under the same quantization. Thus, the choice for prediction mode may ultimately depend on which combination produces the best result.

“Combination” has been mentioned many times above, which means that it is not necessary to select the weight derivation mode and the prediction mode from 2 or 3 dimensions, but rather to combine them and to select a combination of the weight derivation mode and the prediction mode. Reflected in the syntax elements, a syntax element of “combination” is used to determine the weight derivation mode and 2 prediction modes.

That is to say, the encoder and decoder may each generate the same N candidate combinations. For example, the encoder and decoder each construct a list of N candidate combinations, and each candidate combination may derive a combination of 1 weight derivation mode and 2 prediction modes. For the bitstream, the encoder only needs to write which candidate combination is finally selected, and the decoder parses which candidate combination is finally selected by the encoder. This list is referred to as a GPM combination candidate list or candidate combination list in the present application.

In an example, in the GPM combination candidate list, candidate combinations are arranged substantially in descending order of probability of combination being selected, so for the candidate combinations arranged in the front, a shorter codeword than the existing method may be used, and a longer codeword is used for some combinations with small probability of being selected. Thus, the overall coding efficiency may be improved. Since the existing method is partitioned into three parts, theoretically the solution provided by the present application may achieve greater flexibility and more easily approximate the most effective probability and codeword correspondence.

Certainly, as mentioned above, in some cases the number of possible combinations for GPM is quite huge. In order to represent a huge number of candidate combinations, a long codeword is required. However, if certain combinations with a very small probability of occurrence may be eliminated in advance, the cost of combinations with a great probability of occurrence may be reduced. Certainly, the existing method may exclude cases with too small probability of occurrence based on each part, but the manner to select a combination is also more flexible. For example, if the existing method is to exclude a kind of “partition”, then all possibilities based on this “partition” are excluded.

Another benefit is that it makes the syntax simple, and there is no need to determine various cases during analysis.

As for how to encode gpm_cand_idx, it was mentioned above that this is related to their probability. In an example, Exponential-Golomb coding is used. If the number of candidate combinations is relatively small, only a few modes with the highest probability may be selected, a fixed-length code may also be used. For example, if there are only 16 candidate combinations, the 16 candidate combinations are uniformly encoded with a fixed bit length.

For blocks with different sizes, different numbers of candidate combinations may be set. For example, for a small block, similar weight derivation modes or prediction modes have little effect on the prediction result, while for a large block, similar weight derivation modes or prediction modes have a more obvious effect on the prediction result. Therefore, one method is to set a smaller number of candidate combinations for smaller blocks and a larger number of candidate combinations for larger blocks. The size of the block may be determined based on the width and height of the block or the number of samples of the block. In an example, it is to set the number of candidate combinations to 8 for blocks with less than (or less than or equal to) 256 samples, and to set the number of candidate combinations to 16 for blocks with greater than or equal to (or greater than) 256 samples.

The following is an introduction to a process of constructing the GPM combination candidate list.

In some embodiments, more relevant information may be used to analyze the probability of occurrence of various combinations. For example, the pattern information of neighboring blocks, and reconstructed samples are used.

One approach is to use a template to construct the GPM combination candidate list.

In general, the height of the top part of the template is consistent with the width of the left part of the template, and this value may be 1, 2, 4, etc. in an example, in a case of constructing a GPM combination candidate list based on the template, a template whose top part has a height of 1 and/or left part have a width of 1 may be used, which appropriately reduce the computational complexity. It will be noted that the height of the top part of the template is 1, which may be understood as the top part of the template for the current block includes a row of decoded or encoded samples on the top of the current block; and the width of the left part of the template is 1, which may be understood as the left part of the template for the current block includes decoded or encoded samples on the left of the current block.

In a case of using a template, since the current block may use more relevant information, i.e., the information that has been reconstructed around the current block, the correlation between the above three elements may be utilized well. That is, the information that has been reconstructed around the current block is used to estimate some cases about the current block.

One method is to use the GPM method to predict the template for each combination to obtain the prediction block of the combination for the template. Since the template has obtained the reconstructed value, the prediction block of the combination and the reconstructed block for the template may be used to calculate the cost of the prediction distortion, for example, to calculate SAD, SATD, SSE. The various combinations are sorted according to the cost of prediction distortion, or construct a list that top N combinations with the smallest cost of prediction distortion are only maintained. Thus, a GPM combination candidate list may be constructed.

In the above method, for a certain combination, the first prediction mode is used to generate a first prediction value of a template, the second prediction mode is used to generate a second prediction value of the template, the weight derivation mode is used to derive a weight of the sample position on the template, and the prediction value of the template is determined based on the first prediction value, the second prediction value and the weight.

Both the encoder and decoder must use the same construction method for GPM combination candidate list to ensure consistent encoding and decoding. As mentioned above, the number of all possible combinations for GPM may be quite huge. The above method is an exhaustive method. In practical implementation, a fast algorithm may be used to construct a GPM combination candidate list, but the encoder and decoder must employ the same algorithm. For example, for various combinations, hierarchical filtering is performed, or some combinations with high probability deduced according to known information are checked preferentially, and some early termination conditions are set, etc.

In some embodiments, this embodiment is used for blocks encoded by intra-coding, and is not used for blocks encoded by screen content coding. Here, it does not mean that the solution in the present application cannot be used in blocks encoded by screen content coding, but just to illustrate the solution in the present application with the simplest example, because in the blocks encoded by intra-coding and not by screen content coding, only the intra prediction mode needs to be considered, and there is no need to consider screen content encoding modes such as IBC and palette, as well as various inter coding modes. This solution may be used in any case where GPM is available, which has been described above.

It is assumed here that there are 64 possible weight derivation modes for GPM and 67 possible intra prediction modes for GPM, which may be found in the VVC standard. However, it is not limited to only 64 possible weight derivation modes for GPM, or which 64 weight derivation modes are available. On the other hand, we should know that the reason for selecting 64 kinds for GPM in VVC is also a trade-off between an improvement of prediction effect and an improvement of overhead in the bitstream. In the present solution, a fixed logic is no longer used to performing encoding in the weight derivation mode, so in theory various weight derivation modes are used for the present solution and they are used more flexibly. Likewise, it is not limited to only 67 intra prediction modes for GPM, or which 67 intra prediction modes are available. Theoretically, all possible intra prediction modes may be used for GPM. For example, if the intra angular prediction mode is made more detailed and more intra angular prediction modes are generated, then more intra angular prediction modes are used for GPM. For example, the MIP (matrix-based intra prediction) mode in VVC may also be used in this solution, but considering that MIP has multiple sub-modes that can be selected, MIP is not provided in the embodiments for ease of understanding. There are also some wide-angle modes that may also be used in this solution, which will not be described in this embodiments.

If 2 intra prediction modes are not allowed to be the same, there are a total of 64*67*66 possible combinations in these embodiments. If an exhaustive method is used, all possible combinations are used for prediction for the template, and the distortion cost of this combination is calculated. Each intra prediction mode may not be used because the MPM list for the current block may be obtained according to the prediction mode of the neighboring block; for example, in VVC, an MPM list with a length of 6 is obtained for the current block. In addition, in some subsequent technological evolutions, there is a secondary MPM solution, which may derive an MPM list with a length of 22. In other words, a sum of the lengths of the first MPM list and the second MPM list is 22. In this solution, the MPM list may be used to perform a selection on the intra prediction modes. Certainly, an MPM list suitable for the GPM mode of the current block may also be constructed, for example, the prediction modes used for all blocks neighboring to the current block are added to the MPM list. For example, if the MPM list does not contain special prediction modes such as DC, horizontal prediction mode or vertical prediction mode, then add one or several of the special prediction modes to the candidate intra prediction modes of the present solution. For example, the intra prediction modes related to the weighted partition line are added to the candidate intra prediction modes of the present solution, one of which is one or several intra angular prediction modes parallel to or substantially parallel to the partition line, and another one of which is one or several intra angular prediction modes perpendicular to or substantially perpendicular to the partition line. Alternatively, the intra prediction mode candidates of the present solution may be determined according to the weight derivation mode. Alternatively, the intra prediction mode candidates of the present solution may be determined for each of the two intra prediction modes. In summary, at least one GPM intra prediction mode candidate set/list may be obtained. Certainly, the total number of available prediction modes may also be limited to ensure the complexity of the decoding side, for example, the number of available prediction modes is limited up to 6. All of the above methods may be used individually or in any combination.

As may be seen from the above, using the intra prediction mode for GPM requires constructing an MPM list or selecting a list or set of candidate prediction modes, which helps reduce overhead or complexity. An example of reducing complexity is that in the above-mentioned GPM combination coding, intra prediction modes are selected to reduce the number of possible combinations that need to be tried, thereby reducing the amount of calculation to reduce complexity.

Currently, the difference between the GPM and the prediction for the entire block is that, for the GPM, a block is partitioned into 2 parts. It may be understood that each part has a strong correlation with the neighboring blocks or reference samples and has a weak correlation with the non-neighboring reference samples. For example, for the mode in which the GPM index is 0 in VVC, the current block is partitioned into 2 parts in a vertical direction, which are called the left part and the right part. Then the left part has a strong correlation with the neighboring blocks or reference samples on the left, while the right part has a weak correlation with the neighboring blocks or reference samples on the left because they are not neighboring. However, currently, in a case of determining the list of candidate prediction modes, neighboring blocks are simply partitioned into two categories of top and left, which is not precise enough, and thus the determined candidate prediction modes are not accurate enough. When predicting the current block based on the candidate prediction modes, the prediction accuracy is poor.

In order to solve the above technical problems, in the present application, when performing encoding or decoding on the current block, N candidate weight derivation modes are firstly determined, and then at least one candidate prediction mode is determined based on the N candidate weight derivation modes and attribute information of the current block, and then, a first weight derivation mode and K first prediction modes corresponding to the current block are determined based on the N candidate weight derivation modes and the at least one candidate prediction mode, and then, the current block are predicted using the first weight derivation mode and the K first prediction modes to obtain a prediction value of the current block. That is, in the embodiments of the present application, when determining the at least one candidate prediction mode, the weight derivation modes and the attribute information of the current block are taken into account, thereby improving the accuracy of determining the candidate prediction mode. When predicting the current block based on the accurately determined candidate prediction mode, the prediction accuracy of the current block may be improved, thereby improving coding performance.

In a first clause, a video decoding method is provided, which includes:
determining N candidate weight derivation modes, where N is a positive integer;
determining at least one candidate prediction mode based on the N candidate weight derivation modes and attribute information of a current block;
determining a first weight derivation mode and K first prediction modes corresponding to the current block based on the N candidate weight derivation modes and the at least one candidate prediction mode, where K is a positive integer greater than 1; and
predicting the current block based on the first weight derivation mode and the K first prediction modes to obtain a prediction value of the current block.

In a second clause, according to the first clause, where determining the at least one candidate prediction mode based on the N candidate weight derivation modes and the attribute information of the current block includes:

for an i-th candidate weight derivation mode of the N candidate weight derivation modes, determining a candidate prediction mode list corresponding to the i-th candidate weight derivation mode based on the i-th candidate weight derivation mode and the attribute information of the current block, where i is a positive integer less than or equal to N.

In a third clause, according to the second clause, where determining the candidate prediction mode list corresponding to the i-th candidate weight derivation mode based on the i-th candidate weight derivation mode and the attribute information of the current block includes:
determining a candidate prediction mode list of at least one prediction mode of K prediction modes corresponding to the i-th candidate weight derivation mode based on the i-th candidate weight derivation mode and the attribute information of the current block.

In a fourth clause, according to the third clause, where in response to that the at least one prediction mode corresponds to a candidate prediction mode list, determining the candidate prediction mode list of the at least one prediction mode of the K prediction modes corresponding to the i-th candidate weight derivation mode based on the i-th candidate weight derivation mode and the attribute information of the current block includes:
for a j-th prediction mode of the at least one prediction mode, determining a candidate prediction mode list of the j-th prediction mode based on the i-th candidate weight derivation mode and the attribute information of the current block, where j is a positive integer; and
determining the candidate prediction mode list of the at least one prediction mode based on the candidate prediction mode list of the j-th prediction mode.

In a fifth clause, according to the fourth clause, where determining the candidate prediction mode list of the at least one prediction mode based on the candidate prediction mode list of the j-th prediction mode includes:
determining the candidate prediction mode list of the j-th prediction mode as the candidate prediction mode list of the at least one prediction mode.

In a sixth clause, according to the fourth clause, where determining the candidate prediction mode list of the at least one prediction mode based on the candidate prediction mode list of the j-th prediction mode includes:
in response to that the candidate prediction mode list of the j-th prediction mode includes a preset prediction mode, determining the candidate prediction mode list of the j-th prediction mode as the candidate prediction mode list of the at least one prediction mode.

In a seventh clause, according to the fourth clause, where determining the candidate prediction mode list of the at least one prediction mode based on the candidate prediction mode list of the j-th prediction mode includes:
in response to that the candidate prediction mode list of the j-th prediction mode does not includes a preset prediction mode, adding the preset prediction mode to the candidate prediction mode list of the j-th prediction mode to obtain the candidate prediction mode list of the at least one prediction mode.

In an eighth clause, according to the third clause, where in response to that each prediction mode of the at least one prediction mode corresponds to a candidate prediction mode list, determining the candidate prediction mode list of the at least one prediction mode of the K prediction modes corresponding to the i-th candidate weight derivation mode based on the i-th candidate weight derivation mode and the attribute information of the current block includes:
for a j-th prediction mode of the at least one prediction mode, determining a candidate prediction mode list of the j-th prediction mode based on the i-th candidate weight derivation mode and the attribute information of the current block, where j is a positive integer.

In a ninth clause, according to the fourth clause or the eighth clause, where determining the candidate prediction mode list of the j-th prediction mode based on the i-th candidate weight derivation mode and the attribute information of the current block includes:
determining a first look-up table, where the first look-up table includes neighboring blocks corresponding to different prediction modes under different block attribute information and different weight derivation modes;
determining neighboring blocks corresponding to the j-th prediction mode in the first look-up table based on the attribute information of the current block and the i-th candidate weight derivation mode; and
determining the candidate prediction mode list of the j-th prediction mode based on prediction modes of the neighboring blocks corresponding to the j-th prediction mode.

In a tenth clause, according to the fourth clause or the eighth clause, where determining the candidate prediction mode list of the j-th prediction mode based on the i-th candidate weight derivation mode and the attribute information of the current block includes:
determining weights of neighboring blocks of the current block with respect to the j-th prediction mode based on the i-th candidate weight derivation mode and the attribute information of the current block; and
determining the candidate prediction mode list of the j-th prediction mode based on the weights of the neighboring blocks with respect to the j-th prediction mode.

In an eleventh clause, according to the tenth clause, where determining the weights of the neighboring blocks of the current block with respect to the j-th prediction mode based on the i-th candidate weight derivation mode and the attribute information of the current block includes:
determining a weight of a first point in the neighboring blocks based on the i-th candidate weight derivation mode and the attribute information of the current block; and
determining the weight of the first point as the weights of the neighboring blocks with respect to the j-th prediction mode.

In a twelfth clause, according to the eleventh clause, where determining the weight of the first point in the neighboring blocks based on the i-th candidate weight derivation mode and the attribute information of the current block includes:
determining the weight of the first point based on the i-th candidate weight derivation mode, the attribute information of the current block and a template of the current block.

In a thirteenth clause, according to the twelfth clause, where determining the weight of the first point based on the i-th candidate weight derivation mode, the attribute information of the current block and the template of the current block includes:
determining a weight of the template based on the i-th candidate weight derivation mode, the attribute information of the current block and the template of the current block; and
determining a weight corresponding to the first point in the weight of the template as the weight of the first point.

In a fourteenth clause, according to the eleventh clause, where determining the weight of the first point in the neighboring blocks based on the i-th candidate weight derivation mode and the attribute information of the current block includes:
determining a second point in the current block corresponding to the first point;
determining a weight of the second point based on the i-th candidate weight derivation mode and the attribute information of the current block; and
determining the weight of the first point based on the weight of the second point.

In a fifteenth clause, according to the fourteenth clause, where the second point is a point in the current block that is neighboring to the first point.

In a sixteenth clause, according to any of the eleventh clause to the fifteenth clause, where the first point is any point in the neighboring blocks.

In a seventeenth clause, according to any of the eleventh clause to the fifteenth clause, where the first point is a point in the neighboring blocks that is neighboring to the current block.

In an eighteenth clause, according to the tenth clause, where determining the candidate prediction mode list of the j-th prediction mode based on the weights of the neighboring blocks with respect to the j-th prediction mode includes:
in response to that the weights of the neighboring blocks with respect to the j-th prediction mode are greater than or equal to a preset threshold, obtaining prediction modes of the neighboring blocks; and
determining the candidate prediction mode list of the j-th prediction mode based on the prediction modes of the neighboring blocks.

In a nineteenth clause, according to the eighteenth clause, where in response to that a value of the weight is in a range from 0 to n, the preset threshold is n/2, and n is a positive number.

In a twentieth clause, according to the tenth clause, where in response to that the value of the weight is a first value or a second value, determining the candidate prediction mode list of the j-th prediction mode based on the weights of the neighboring blocks with respect to the j-th prediction mode includes:
in response to that the weights of the neighboring blocks with respect to the j-th prediction mode are equal to the first value, obtaining the prediction modes of the neighboring blocks, the first value being greater than the second value;
determining the candidate prediction mode list of the j-th prediction mode based on the prediction modes of the neighboring blocks.

In a twenty-first clause, according to the eighteenth clause or the twentieth clause, where obtaining the prediction modes of the neighboring blocks includes:
according to a preset checking order, sequentially obtaining prediction modes of neighboring blocks whose weight with respect to the j-th prediction mode are greater than or equal to the preset threshold or equal to the first value of the neighboring blocks of the current block.

In a twenty-second clause, according to the twenty-first clause, where determining the candidate prediction mode list of the j-th prediction mode based on the prediction modes of the neighboring blocks includes:
according to the checking order, sequentially adding the obtained prediction modes of the neighboring blocks to the candidate prediction mode list of the j-th prediction mode.

In a twenty-third clause, according to the twenty-first clause, where in response to that the neighboring blocks of the current block include a left neighboring block, a top neighboring block, a bottom-left neighboring block, a top-right neighboring block and a top-left neighboring block, the preset checking order is the left neighboring block, the top neighboring block, the bottom-left neighboring block, the top-right neighboring block and the top-left neighboring block.

In a twenty-fourth clause, according to the eighteenth clause or the twentieth clause, where determining the candidate prediction mode list of the j-th prediction mode based on the prediction modes of the neighboring blocks includes:
in response to that the candidate prediction mode list of the j-th prediction mode does not include the prediction modes of the neighboring blocks, adding the prediction modes of the neighboring blocks to the candidate prediction mode list of the j-th prediction mode.

In a twenty-fifth clause, according to the eighteenth clause or the twentieth clause, where the method further includes:
in response to that the weights of the neighboring blocks with respect to the j-th prediction mode are less than a preset threshold or equal to a second value, skipping obtaining the prediction modes of the neighboring blocks.

In a twenty-sixth clause, according to the tenth clause, where in response to that M neighboring blocks are included for the current block, determining the candidate prediction mode list of the j-th prediction mode based on the weights of the neighboring blocks with respect to the j-th prediction mode includes:
determining the candidate prediction mode list of the j-th prediction mode based on the weights of the M neighboring blocks respectively with respect to the j-th prediction mode and prediction modes of the M neighboring blocks, where M is a positive integer.

In a twenty-seventh clause, according to the twenty-sixth clause, where determining the candidate prediction mode list of the j-th prediction mode based on the weights of the M neighboring blocks respectively with respect to the j-th prediction mode and the prediction modes of the M neighboring blocks includes:
adding the prediction modes of the M neighboring blocks to the candidate prediction mode list based on the weights of the M neighboring blocks respectively with respect to the j-th prediction mode until a length of the candidate prediction mode list reaches a preset length.

In a twenty-eighth clause, according to the twenty-sixth clause, where the M neighboring blocks include at least one of a left neighboring block, a top neighboring block, a bottom-left neighboring block, a top-right neighboring block or a top-left neighboring block.

In a twenty-ninth clause, according to the fourth clause or the eighth clause, where before determining the candidate prediction mode list of the j-th prediction mode based on the i-th candidate weight derivation mode and the attribute information of the current block, the method further includes:
determining whether the candidate prediction mode list of the j-th prediction mode includes prediction modes of neighboring blocks;
where determining the candidate prediction mode list of the j-th prediction mode based on the i-th candidate weight derivation mode and the attribute information of the current block includes:
in response to determining that the candidate prediction mode list of the j-th prediction mode includes the prediction modes of the neighboring blocks, determining the candidate prediction mode list of the j-th prediction mode based on the i-th candidate weight derivation mode and the attribute information of the current block.

In a thirtieth clause, according to the twenty-ninth clause, where determining whether the candidate prediction mode list of the j-th prediction mode includes the prediction modes of the neighboring blocks includes:
decoding a bitstream to obtain first information, where the first information is used for indicating whether the candidate prediction mode list includes the prediction modes of neighboring blocks;
determining whether the candidate prediction mode list of the j-th prediction mode includes the prediction modes of the neighboring blocks based on the first information.

In a thirty-first clause, according to the twenty-ninth clause, where determining whether the candidate prediction mode list of the j-th prediction mode includes the prediction modes of the neighboring blocks includes:

in response to that the length of the candidate prediction mode list does not reach a preset length after adding, according to a preset order, each prediction mode located before the prediction modes of the neighboring blocks in the preset order to the candidate prediction mode list, determining that the candidate prediction mode list of the j-th prediction mode includes the prediction modes of the neighboring blocks.

In a thirty-second clause, according to the thirty-first clause, where the preset order includes: a prediction mode whose prediction angle is parallel to a partition line of the i-th candidate weight derivation mode, a candidate prediction mode derived based on a template of the current block, a candidate prediction mode derived based on reconstructed samples neighboring to the current block, the prediction modes of the neighboring blocks, a prediction mode whose prediction angle is perpendicular to the partition line of the i-th candidate weight derivation mode and a preset mode.

In a thirty-third clause, according to the thirty-second clause, where the preset mode includes a PLANAR mode.

In a thirty-forth clause, according to any of the first clause to the eighth clause, where determining the first weight derivation mode and the K first prediction modes corresponding to the current block based on the N candidate weight derivation modes and the at least one candidate prediction mode includes:
decoding a bitstream to obtain a first index, where the first index is used to indicate a first combination, the first combination including the first weight derivation mode and the K first prediction modes;
determining a candidate combination list based on the N candidate weight derivation modes and the at least one candidate prediction mode, where the candidate combination list includes at least one candidate combination, the candidate combination including one weight derivation mode and K prediction modes; and
determining the first combination from the candidate combination list based on the first index.

In a thirty-fifth clause, according to the thirty-forth clause, where determining the candidate combination list based on the N candidate weight derivation modes and the at least one candidate prediction mode includes:
obtaining T second combinations based on the N candidate weight derivation modes and the at least one candidate prediction mode, where any second combination of the T second combinations includes one weight derivation mode and K prediction modes, and weight derivation mode and K prediction modes included in any two combinations of the T second combinations are not exactly the same, T being a positive integer greater than 1; and
obtaining the candidate combination list based on the T second combinations.

In a thirty-sixth clause, according to the thirty-fifth clause, where obtaining the candidate combination list based on the T second combinations includes:
for any second combination of the T second combinations, determining a cost corresponding to the second combination in a case where the template of the current block is predicted based on the weight derivation mode and the K prediction modes in the second combination; and
determining the candidate combination list according to costs corresponding to all second combinations in the T second combinations.

In a thirty-seventh clause, according to any of the 1 to 8, where a height of a top part of a template of the current block is 1, and/or a width of a left part of the template of the current block is 1.

In a thirty-eighth clause, according to any of the first clause to the eighth clause, where the attribute information of the current block includes size information of the current block.

In a thirty-ninth clause, the method includes:
determining N candidate weight derivation modes, where N is a positive integer;
determining at least one candidate prediction mode based on the N candidate weight derivation modes and attribute information of a current block;
determining a first weight derivation mode and K first prediction modes corresponding to the current block based on the N candidate weight derivation modes and the at least one candidate prediction mode, where K is a positive integer greater than 1; and
predicting the current block based on the first weight derivation mode and the K first prediction modes to obtain a prediction value of the current block.

In a fortieth clause, according to the thirty-ninth clause, where determining the at least one candidate prediction mode based on the N candidate weight derivation modes and the attribute information of the current block includes:
for an i-th candidate weight derivation mode of the N candidate weight derivation modes, determining a candidate prediction mode list corresponding to the i-th candidate weight derivation mode based on the i-th candidate weight derivation mode and the attribute information of the current block, where i is a positive integer less than or equal to N.

In a forty-first clause, according to the fortieth clause, where determining the candidate prediction mode list corresponding to the i-th candidate weight derivation mode based on the i-th candidate weight derivation mode and the attribute information of the current block includes:
determining a candidate prediction mode list of at least one prediction mode of K prediction modes corresponding to the i-th candidate weight derivation mode based on the i-th candidate weight derivation mode and the attribute information of the current block.

In a forty-second clause, according to the forty-first clause, where in response to that the at least one prediction mode corresponds to a candidate prediction mode list, determining the candidate prediction mode list of the at least one prediction mode of the K prediction modes corresponding to the i-th candidate weight derivation mode based on the i-th candidate weight derivation mode and the attribute information of the current block includes:
for a j-th prediction mode of the at least one prediction mode, determining a candidate prediction mode list of the j-th prediction mode based on the i-th candidate weight derivation mode and the attribute information of the current block, where j is a positive integer; and
determining the candidate prediction mode list of the at least one prediction mode based on the candidate prediction mode list of the j-th prediction mode.

In a forty-third clause, according to the forty-second clause, where determining the candidate prediction mode list of the at least one prediction mode, based on the candidate prediction mode list of the j-th prediction mode includes:
determining the candidate prediction mode list of the j-th prediction mode as the candidate prediction mode list of the at least one prediction mode.

In a forty-fourth clause, according to the forty-second clause, where determining the candidate prediction mode list of the at least one prediction mode based on the candidate prediction mode list of the j-th prediction mode includes:
in response to that the candidate prediction mode list of the j-th prediction mode includes a preset prediction mode, determining the candidate prediction mode list of the j-th prediction mode as the candidate prediction mode list of the at least one prediction mode.

In a forty-fifth clause, according to the forty-second clause, where determining the candidate prediction mode list of the at least one prediction mode based on the candidate prediction mode list of the j-th prediction mode includes:
in response to that the candidate prediction mode list of the j-th prediction mode does not includes a preset prediction mode, adding the preset prediction mode to the candidate prediction mode list of the j-th prediction mode to obtain the candidate prediction mode list of the at least one prediction mode.

In a forty-sixth clause, according to the forty-first clause, where in response to that each prediction mode of the at least one prediction mode corresponds to a candidate prediction mode list, determining the candidate prediction mode list of the at least one prediction mode of the K prediction modes corresponding to the i-th candidate weight derivation mode based on the i-th candidate weight derivation mode and the attribute information of the current block includes:
for a j-th prediction mode of the at least one prediction mode, determining a candidate prediction mode list of the j-th prediction mode, based on the i-th candidate weight derivation mode and the attribute information of the current block, where j is a positive integer.

In a forty-seventh clause, according to the forty-second clause or the forty-sixth clause, where determining the candidate prediction mode list of the j-th prediction mode based on the i-th candidate weight derivation mode and the attribute information of the current block includes:
determining a first look-up table, where the first look-up table includes neighboring blocks corresponding to different prediction modes under different block attribute information and different weight derivation modes;
determining neighboring blocks corresponding to the j-th prediction mode in the first look-up table based on the attribute information of the current block and the i-th candidate weight derivation mode; and
determining the candidate prediction mode list of the j-th prediction mode based on prediction modes of the neighboring blocks corresponding to the j-th prediction mode.

In a forty-eighth clause, according to the forty-second clause or the forty-sixth clause, where determining the candidate prediction mode list of the j-th prediction mode based on the i-th candidate weight derivation mode and the attribute information of the current block includes:
determining weights of neighboring blocks of the current block with respect to the j-th prediction mode, based on the i-th candidate weight derivation mode and the attribute information of the current block; and
determining the candidate prediction mode list of the j-th prediction mode based on the weights of the neighboring blocks with respect to the j-th prediction mode.

In a forty-ninth clause, according to the forty-eighth clause, where determining the weights of the neighboring blocks of the current block with respect to the j-th prediction mode based on the i-th candidate weight derivation mode and the attribute information of the current block includes:
determining a weight of a first point in the neighboring blocks based on the i-th candidate weight derivation mode and the attribute information of the current block; and
determining the weight of the first point as the weights of the neighboring blocks with respect to the j-th prediction mode.

In a fiftieth clause, according to the forty-ninth clause, where determining the weight of the first point in the neighboring blocks based on the i-th candidate weight derivation mode and the attribute information of the current block includes:
determining the weight of the first point based on the i-th candidate weight derivation mode, the attribute information of the current block and a template of the current block.

In a fifty-first clause, according to the fiftieth clause, where determining the weight of the first point based on the i-th candidate weight derivation mode, the attribute information of the current block and the template of the current block includes:
determining a weight of the template based on the i-th candidate weight derivation mode, the attribute information of the current block and the template of the current block; and
determining a weight corresponding to the first point in the weight of the template as the weight of the first point.

In a fifty-second clause, according to the forty-ninth clause, where determining the weight of the first point in the neighboring blocks based on the i-th candidate weight derivation mode and the attribute information of the current block includes:
determining a second point in the current block corresponding to the first point;
determining a weight of the second point based on the i-th candidate weight derivation mode and the attribute information of the current block; and
determining the weight of the first point based on the weight of the second point.

In a fifty-third clause, according to the fifty-second clause, where the second point is a point in the current block that is neighboring to the first point.

In a fifty-fourth clause, according to any of the forty-ninth clause to the fifty-third clause, where the first point is any point in the neighboring blocks.

In a fifty-fifth clause, according to any of the forty-ninth clause to the fifty-third clause, where the first point is a point in the neighboring blocks that is neighboring to the current block.

In a fifty-sixth clause, according to the forty-eighth clause, where determining the candidate prediction mode list of the j-th prediction mode based on the weights of the neighboring blocks with respect to the j-th prediction mode includes:
in response to that the weights of the neighboring blocks with respect to the j-th prediction mode are greater than or equal to a preset threshold, obtaining prediction modes of the neighboring blocks; and
determining the candidate prediction mode list of the j-th prediction mode based on the prediction modes of the neighboring blocks.

In a fifty-seventh clause, according to the fifty-sixth clause, where in response to that a value of the weight is in a range from 0 to n, the preset threshold is n/2, and n is a positive number.

In a fifty-eighth clause, according to the forty-eighth clause, where in response to that the value of the weight is a first value or a second value, determining the candidate prediction mode list of the j-th prediction mode based on the weights of the neighboring blocks with respect to the j-th prediction mode includes:
in response to that the weights of the neighboring blocks with respect to the j-th prediction mode are equal to the first value, obtaining the prediction modes of the neighboring blocks, the first value being greater than the second value;
determining the candidate prediction mode list of the j-th prediction mode based on the prediction modes of the neighboring blocks.

In a fifty-ninth clause, according to the fifty-sixth clause or the fifty-eighth clause, where obtaining the prediction modes of the neighboring blocks includes:
according to a preset checking order, sequentially obtaining prediction modes of neighboring blocks whose weights with respect to the j-th prediction mode are greater than or equal to the preset threshold or equal to the first value of the neighboring blocks of the current block.

In a sixtieth clause, according to the fifty-ninth clause, where determining the candidate prediction mode list of the j-th prediction mode based on the prediction modes of the neighboring blocks includes:
according to the checking order, sequentially adding the obtained prediction modes of the neighboring blocks to the candidate prediction mode list of the j-th prediction mode.

In a sixty-first clause, according to the fifty-ninth clause, where in response to that the neighboring blocks of the current block include a left neighboring block, a top neighboring block, a bottom-left neighboring block, a top-right neighboring block and a top-left neighboring block, the preset checking order is the left neighboring block, the top neighboring block, the bottom-left neighboring block, the top-right neighboring block and the top-left neighboring block.

In a sixty-second clause, according to the fifty-sixth clause or the fifty-eighth clause, where determining the candidate prediction mode list of the j-th prediction mode based on the prediction modes of the neighboring blocks includes:
in response to that the candidate prediction mode list of the j-th prediction mode does not include the prediction modes of the neighboring blocks, adding the prediction modes of the neighboring blocks to the candidate prediction mode list of the j-th prediction mode.

In a sixty-third clause, according to the 56 or 58, where the method further includes:
in response to that the weights of the neighboring blocks with respect to the j-th prediction mode are less than a preset threshold or less than a second value, skipping obtaining the prediction modes of the neighboring blocks.

In a sixty-fourth clause, according to the forty-eighth clause, where in response to that M neighboring blocks are included for the current block, determining the candidate prediction mode list of the j-th prediction mode based on the weights of the neighboring blocks with respect to the j-th prediction mode includes:
determining the candidate prediction mode list of the j-th prediction mode, based on the weights of the M neighboring blocks respectively with respect to the j-th prediction mode and prediction modes of the M neighboring blocks, where M is a positive integer.

In a sixty-fifth clause, according to the sixty-fourth clause, where determining the candidate prediction mode list of the j-th prediction mode based on the weights of the M neighboring blocks respectively with respect to the j-th prediction mode and the prediction modes of the M neighboring blocks includes:
adding the prediction modes of the M neighboring blocks to the candidate prediction mode list based on the weights of the M neighboring blocks respectively with respect to the j-th prediction mode until a length of the candidate prediction mode list reaches a preset length.

In a sixty-sixth clause, according to the sixty-fifth clause, where the M neighboring blocks include at least one of a left neighboring block, a top neighboring block, a bottom-left neighboring block, a top-right neighboring block, or a top-left neighboring block.

In a sixty-seventh clause, according to the sixty-second clause or the sixty-sixth clause, where before determining the candidate prediction mode list of the j-th prediction mode based on the i-th candidate weight derivation mode and the attribute information of the current block, the method further includes:
determining whether the candidate prediction mode list of the j-th prediction mode includes prediction modes of neighboring blocks;
where determining the candidate prediction mode list of the j-th prediction mode based on the i-th candidate weight derivation mode and the attribute information of the current block includes:
in response to determining that the candidate prediction mode list of the j-th prediction mode includes the prediction modes of the neighboring blocks, determining the candidate prediction mode list of the j-th prediction mode based on the i-th candidate weight derivation mode and the attribute information of the current block.

In a sixty-eighth clause, according to the sixty-seventh clause, where determining whether the candidate prediction mode list of the j-th prediction mode includes the prediction modes of the neighboring blocks includes:
in response to that the length of the candidate prediction mode list does not reach a preset length after adding, according to a preset order, each prediction mode located before the prediction modes of the neighboring blocks in the preset order to the candidate prediction mode list, determining that the candidate prediction mode list of the j-th prediction mode includes the prediction modes of the neighboring blocks.

In a sixty-ninth clause, according to the sixty-eighth clause, where the preset order includes: a prediction mode whose prediction angle is parallel to a partition line of the i-th candidate weight derivation mode, a candidate prediction mode derived based on a template of the current block, a candidate prediction mode derived based on reconstructed samples neighboring to the current block, the prediction modes of the neighboring blocks, a prediction mode whose prediction angle is perpendicular to the partition line of the i-th candidate weight derivation mode and a preset mode.

In a seventieth clause, according to the sixty-ninth clause, where the preset mode includes a PLANAR mode.

In a seventy-first clause, according to the sixty-eighth clause, where the method further includes:
encoding first information into a bitstream, where the first information is used for indicating whether the candidate prediction mode list includes the prediction modes of the neighboring blocks.

In a seventy-second clause, according to any of the thirty-ninth clause to the forty-sixth clause, where determining the first weight derivation mode and the K first prediction modes corresponding to the current block based on the N candidate weight derivation modes and the at least one candidate prediction mode includes:
determining a candidate combination list based on the N candidate weight derivation modes and the at least one candidate prediction mode, where the candidate combination list includes at least one candidate combination, the candidate combination including one weight derivation mode and K prediction modes; and
determining a first combination from the candidate combination list, where the first combination includes the first weight derivation mode and the K first prediction modes.

In a seventy-third clause, according to the seventy-second clause, where determining the candidate combination list based on the N candidate weight derivation modes and the at least one candidate prediction mode includes:
obtaining T second combinations based on the N candidate weight derivation modes and the at least one candidate prediction mode, where any second combination of the T second combinations includes one weight derivation mode and K prediction modes, and weight derivation mode and K prediction modes included in any two combinations of the T second combinations are not exactly the same, T being a positive integer greater than 1; and
obtaining the candidate combination list based on the T second combinations.

In a seventy-forth clause, according to the seventy-third clause, where obtaining the candidate combination list based on the T second combinations includes:
for any second combination of the T second combinations, determining a cost corresponding to the second combination in a case where the template of the current block is predicted based on the weight derivation mode and the K prediction modes in the second combination; and
determining the candidate combination list according to costs corresponding to all second combinations in the T second combinations.

In a seventy-fifth clause, according to the seventy-second clause, where the method further includes:
encoding a first index into a bitstream, where the first index is used to indicate the first combination.

In a seventy-sixth clause, according to any of the thirty-ninth clause to the forty-sixth clause, where a height of a top part of a template of the current block is 1, and/or a width of a left part of the template of the current block is 1.

In a seventy-seventh clause, according to any of the thirty-ninth clause to the forty-sixth clause, where the attribute information of the current block includes size information of the current block.

In conjunction with FIG. 19, a video decoding method provided by the embodiments of the present application will be introduced by taking a decoding side as an example.

FIG. 19 is a schematic flowchart of a video decoding method provided by an embodiment of the present application. The embodiments of the present application are applied to the video decoder shown in FIGS. 1 and 3. As shown in FIG. 19, the method of the embodiments of the present application include following steps.

S101, N candidate weight derivation modes are determined.

Here, N is a positive integer. Optionally, N is a preset value or a default value. Optionally, an encoder indicates N to the decoder. For example, the encoder determines N candidate weight derivation modes and then writes N into a bitstream, so that the decoder obtains N by decoding the bitstream. Optionally, N may also be determined by the decoding side in other manners, which is not limited in the embodiments of the present application.

From the above, it may be seen that in the embodiments of the present application, one weight derivation mode and K prediction modes are jointly for generating a prediction block, and the prediction block acts on the current block; that is, a weight is determined according to the weight derivation mode, and the current block is predicted based on the K prediction modes to obtain K prediction values, and the K prediction values are weighted according to the weight to obtain a prediction value of the current block.

That is, at the decoding side, when decoding the current block, N candidate weight derivation modes and multiple candidate prediction modes are need to be determined, and then a weight derivation mode is selected from the N candidate weight derivation modes, and K prediction modes are selected from multiple candidate prediction modes, and then, the selected weight derivation mode and the K prediction modes are used to predict the current block to obtain the prediction value of the current block.

The exemplary method of determining the N candidate weight derivation modes at the decoding side is not limited in the embodiments of the present application.

In a possible implementation, there are 56 weight derivation modes for AWP and 64 weight derivation modes for GPM. The N candidate weight derivation modes include at least one weight derivation mode of the 56 weight derivation modes in the AWP, or include at least one weight derivation mode of the 64 weight derivation modes in the GPM.

In a possible implementation, some weight derivation modes in the AWP or GPM may be selected as the N candidate weight derivation modes. That is, the N candidate weight derivation modes in the embodiments of the present application are a subset of all weight derivation modes in the AWP or the GPM. For example, the same “partition” angle in the weight derivation mode may correspond to multiple offsets, such as the modes 10, 11, 12 and 13 in FIG. 4 or 5 whose “partition” angles are the same but the offsets are different. Modes corresponding to some offsets may be removed in the embodiments of the present application. Certainly, modes corresponding to some “partition” angles may also be removed. In this way, the total number of possible combinations will be reduced, and the difference between possible combinations is made obvious. Certainly, different selection methods may be set for blocks with different sizes. For example, fewer weight derivation modes are used for smaller blocks and more weight derivation modes are used for larger blocks. In addition, different selection methods may also be set for blocks with different shapes, one explanation of which is that the shape if the block refers to a ratio of width to height.

In this implementation, N candidate weight derivation modes are selected in a same manner at the encoding side and the decoding side. In an example, the manner in which the N candidate weight derivation modes are selected is default at both encoding side and decoding side. In another example, at the encoding side may indicate the manner of selecting the N candidate weight derivation modes to the decoding side, so that at the decoding side, the same manner is used to select the same N candidate weight derivation modes as that selected at the encoding side.

In some embodiments, weight derivation modes corresponding to preset partition angles and/or preset offsets are removed from preset M weight derivation modes to obtain N weight derivation modes. Since the same partition angle in the weight derivation mode may correspond to multiple offsets, as shown in FIG. 4, the weight derivation modes 10, 11, 12 and 13 have the same partition angle but different offsets; in this case, weight derivation modes corresponding to some preset offsets may be removed, and/or weight derivation modes corresponding to some preset partition angles may also be removed.

In some embodiments, selection conditions corresponding to different blocks may be different. Therefore, in a case of determining the N weight derivation modes corresponding to the current block, a selection condition corresponding to the current block is first determined, and the N weight derivation modes are selected from the preset M weight derivation modes according to the selection condition corresponding to the current block.

In some embodiments, the selection conditions corresponding to the current block include a selection condition corresponding to a size of the current block and/or a selection condition corresponding to a shape of the current block. When predicting, for smaller blocks, similar weight derivation modes have little effect on the prediction result, while for larger blocks, similar weight derivation modes have a more obvious effect on the prediction result. Based on this, in the embodiments of the present application, different N values are set for blocks of different sizes; that is, a larger N value is set for a larger block, and a smaller N value is set for a smaller block.

In a possible implementation, the N candidate weight derivation modes are indicated to the decoding side.

In some embodiments, the above selection conditions include an array; the array includes N elements, the N elements are in one-to-one correspondence with N weight derivation modes, the element corresponding to each weight derivation mode is used to indicate whether the weight derivation mode is available.

The above array may be a single-digit value or a two-digit value.

For example, considering GPM as an example, there are a total of 64 possible weight derivation modes. At the encoding side, a look-up table containing 64 elements is provided, and a value of each element represents whether to use the corresponding weight derivation mode.

In an example, considering a single-digit value as an example, an exemplary example is as follows, an array of g_sgpm_splitDir is set:
g_sgpm_splitDir [64]={
1,1,1,0,1,0,1,0,
1,0,1,0,1,0,1,0,
1,0,1,1,1,0,1,0,
1,0,1,0,1,0,1,0,
0,0,0,0,1,1,0,1,
0,0,1,0,0,1,0,0,
1,0,1,1,0,1,0,0,
1,0,0,1,0,0,1,0
};

where a value of g_sgpm_splitDir[x] is 1, which represents that the weight derivation mode with index x may be used, otherwise represents that the weight derivation mode with index x cannot be used. In this example, at the decoding side, 26 candidate weight derivation modes are determined via the array.

In another example, an array may be used to indicate N candidate weight derivation modes, and the array only contains indexes of the available weight derivation modes. For example, an array with a length of 26 g_sgpm_splitDir [26]={0,1,6,8,10,12,14,16,18, 19,20,22,24,26,28,30,36,37,42,45,48,50,51,53,56, 59} is used to indicate 26 candidate weight derivation modes. At the decoding side, based on the indexes of the weight derivation modes included in the array, the weight derivation modes corresponding to the indexes are determined as candidate weight derivation modes, so as to obtain 26 candidate weight derivation modes.

In some embodiments, in a case where the selection conditions corresponding to the current block include selection condition corresponding to the size of the current block and selection condition corresponding to the shape of the current block; for the same weight derivation mode, if the selection condition corresponding to the size of the current block and the selection condition corresponding to the shape of the current block represent that the weight derivation mode is available, then the weight derivation mode is determined to be one of the N weight derivation modes; if at least one of the selection condition corresponding to the size of the current block and the selection condition corresponding to the shape of the current block represents that the weight derivation mode is unavailable, then the weight derivation mode is determined not to be used to constitute the N weight derivation modes.

In some embodiments, the selection condition corresponding to the blocks with different sizes and the selection condition corresponding to the blocks with different shapes may each be implemented using multiple arrays.

In some embodiments, the selection condition corresponding to the blocks with different sizes and the selection condition corresponding to the blocks with different shapes may be implemented using a two-bit array; that is, a two-bit array includes both selection condition corresponding to the size of the block and selection condition corresponding to the shape of the block.

Exemplarily, the selection conditions corresponding to a block with a size of A and a shape of B are as follows, and the selection conditions are represented by a two-bit array:
g_sgpm_splitDir [64]={
(1,1), (1,1), (1,1), (1,0), (1,0), (0,0), (1,0), (1,1),
(1,1), (0,0), (1,1), (1,0), (1,0), (0,0), (1,0), (1,1),
(0,1), (0,0), (1,1), (0,0), (1,0), (0,0), (1,0), (0,0),
(1,1), (0,0), (0,1), (1,0), (1,0), (1,0), (1,0), (0,0),
(0,0), (0,0), (1,1), (0,0), (1,1), (1,1), (1,0), (0,1),
(0,0), (0,0), (1,1), (0,0), (1,0), (0,0), (1,0), (0,0),
(1,0), (0,0), (1,1), (1,0), (1,0), (1,0), (0,0), (0,0),
(1,1), (0,0), (1,1), (0,0), (0,0), (1,0), (1,1), (0,0)
};

where values of g_sgpm_splitDir [x] are all 1, indicating that the weight derivation mode with index x is available; one of the values of g_sgpm_splitDir [x] is 0, indicating that the weight derivation mode with index x is not available. For example, g_sgpm_splitDir [4]=(1,0), which indicates that weight derivation mode 4 is available for blocks with the size of A, but not for blocks with the shape of B. Therefore, if the size of the block is A and the shape of the block is B, the weight derivation mode is not available.

It will be noted that the above description is made by taking an example in which there are 64 weight derivation modes included in GPM, but the weight derivation modes in the embodiments of the present application include but are not limited to the 64 weight derivation modes included in GPM and the 56 weight derivation modes included in AMP.

In some embodiments, at the decoding side, before determining the N candidate weight derivation modes, it is necessary to first determine whether K different prediction modes are used for performing weighted prediction processing on the current block. In response to that, at the decoding side, if it is determined that K different prediction modes are used for performing weighted prediction processing on the current block, then the S101 is performed to determine the N candidate weight derivation modes. At the decoding side, it is determined that the K different prediction modes are not used for performing weighted prediction processing on the current block, S101 is skipped.

In a possible implementation, at the decoding side, it is determined that whether K different prediction modes are used for performing weighted prediction processing on the current block by determining the prediction mode parameter of the current block.

Optionally, in the implementations of the present application, the prediction mode parameter may indicate whether the GPM or the AWP mode are used for the current block, i.e., indicate whether K different prediction modes are used for performing prediction processing on the current block.

It may be understood that, in the embodiments of the present application, the prediction mode parameter may be understood as a flag indicating whether the GPM or the AWP mode is used. In some implementation, the encoder may use a variable as a prediction mode parameter, so that the prediction mode parameter may be set by setting a value of the variable. Exemplarily, in the present application, if the GPM or the AWP mode is used for the current block, the encoder may set the value of the prediction mode parameter to indicate that the GPM or the AWP mode is used for the current block. In some implementation, the encoder may set the value of the variable to 1. Exemplarily, in the present application, if the GPM or the AWP mode is not used for the current block, the encoder may set the value of the prediction mode parameter to indicate that the GPM or the AWP mode is not used for the current block. In some implementation, the encoder may set the variable value to 0. Furthermore, in the embodiments of the present application, after completing the setting of the prediction mode parameter, the encoder may encode the prediction mode parameter into a bitstream and transmit the prediction mode parameter to the decoder, so that the decoder may obtain the prediction mode parameter after parsing the bitstream.

Based on this, at the decoding side, the bitstream is decoded to obtain the prediction mode parameter, and then it is determined that whether uses the GPM or the AWP mode is used for the current block according to the prediction mode parameter. If the GPM or the AWP mode is used for the current block, i.e., in a case where K different prediction modes are used for prediction processing, the N candidate weight derivation modes corresponding to the current block are determined.

In some embodiments, the conditions for the use of GPM or AWP mode for the current block will be limited in the embodiments of the present application; that is, when it is determined that the current block meets a preset condition, it is determined that K prediction modes are used for performing weighted prediction on the current block; and then, N candidate weight derivation modes corresponding to the current block are determined.

Exemplarily, in a case where the GPM or the AWP mode is applied, the size of the current block may be limited.

It may be understood that since the prediction method proposed in the embodiments of the present application needs to use K different prediction modes to generate K prediction values respectively, and then perform weighting according to the weights to obtain the prediction value of the current block. In order to reduce the complexity and consider the trade-off between compression performance and complexity, in the embodiments of the present application, it is possible to limit the use of the GPM or AWP mode for blocks with certain sizes. Therefore, in the present application, the decoder may first determine a size parameter of the current block, and then determine whether the GPM or the AWP mode is used for the current block according to the size parameter.

In the embodiments of the present application, the size parameter of the current block may include a height and width of the current block. Therefore, the decoder may determine whether the GPM or the AWP mode is used for the current block according to the height and width of the current block.

Exemplarily, in the present application, if the width is greater than threshold 1 and the height is greater than threshold 2, it is determined that the GPM or the AWP mode is used for the current block. It may be seen that a possible limitation is that the GPM or the AWP mode is only used in a case where the width of the block is greater than (or greater than or equal to) threshold 1 and the height of the block is greater than (or greater than or equal to) threshold 2. The values of threshold 1 and threshold 2 may be 4, 8, 16, 32, 128, 256, etc., and threshold 1 may be equal to threshold 2.

Exemplarily, in the present application, if the width is less than threshold 3 and the height is greater than threshold 4, it is determined that the GPM or the AWP mode may be used for the current block. It may be seen that a possible limitation is that the GPM or the AWP mode is only used in a case where the width of the block is less than (or less than or equal to) threshold 3 and the height of the block is greater than (or greater than or equal to) threshold 4. The values of threshold 3 and threshold 4 may be 4, 8, 16, 32, 128, 256, etc., and threshold 3 may be equal to threshold 4.

Furthermore, in the embodiments of the present application, it is possible to limit the sample parameters to achieve a limitation on the size of the block that the GPM or the AWP mode may be used.

Exemplarily, in the present application, the decoder may first determine the sample parameters of the current block, and then further determine whether the GPM or the AWP mode may be used for the current block according to the sample parameters and threshold 5. It may be seen that a possible limitation is that the GPM or the AWP mode is only used in a case where a number of samples of the block is greater than (or greater than or equal to) the threshold 5. Here, a value of threshold 5 may be 4, 8, 16, 32, 128, 256, 1024, etc.

That is, in the present application, the GPM or the AWP mode may be used for the current block only in the case where the size parameter of the current block meets a size requirement.

Exemplarily, in the present application, there may be a frame-level flag to determine whether the present application is used for a current frame to be decoded. For example, it may be configured that the present application is used for intra frame (such as I-frame) and the present application is not used for inter frame (such as B-frame or P-frame). Alternatively, it may be configured that the present application is not used for the intra frame and the present application is used for the inter frame. Alternatively, it may be configured that the present application is used for certain inter frames and the present application is not used for another certain inter frames. Intra prediction may also be used for inter frame, so the present application may also be used for inter frame.

In some embodiments, there may also be a flag below the frame-level to determine whether the present application is used for the current block.

After determining N candidate weight derivation modes at the decoding side, the following S102 will be performed.

S102, at least one candidate prediction mode is determined based on the N candidate weight derivation modes and attribute information of the current block.

Currently, for example, in the GPM intra and inter prediction mode, neighboring blocks are partitioned into two categories of top and left, according to the partition line angle, and then, at least one candidate prediction mode of the current block is determined based on the prediction modes of the top and left neighboring blocks. However, this partition is not precise enough. For example, in the weight derivation mode with index 0, the current block is partitioned vertically into two parts of left part and right part. As shown in Table 5, it may be determined that the neighboring blocks corresponding to the second part (i.e., the second prediction mode) is L+A. That is, in a case of constructing the candidate prediction mode list corresponding to the second prediction mode, the intra prediction modes of the neighboring blocks A, AR, AL, L and BL may be used. However, as can be seen from FIGS. 4 and 18, the second part of the current block, i.e., a black part corresponding to the second prediction mode, is not neighboring to a top neighboring block A and a top-right neighboring block AR, and has a weak correlation with the neighboring block A and the neighboring block AR. Therefore, currently, when determining candidate prediction mode list of the second prediction mode of the current block directly based on the intra prediction modes of the neighboring blocks A, AR, AL, L, and BL, there may be a problem that the determined candidate prediction mode list is inaccurate.

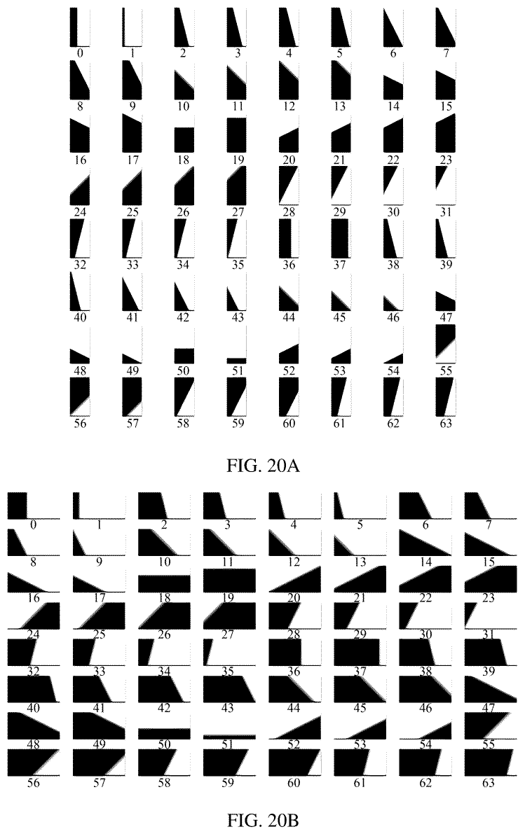

In addition, as shown in FIGS. 20A and 20B, a same weight derivation matrix for blocks with different shapes may have different effects on the two prediction modes. For example, in the mode of GPM with index 13 in VVC, in a block with an aspect ratio of 1:2, a white part does not reach a top-left corner of the current block, while in a block with an aspect ratio of 2:1, the white part reaches a top-left corner of the current block. That is, the attribute information of the current block also responds to a correlation of the neighboring blocks with a first part and a second part of the current block.

Based on the above description, in the embodiments of the present application, when determining at least one candidate prediction mode, not only the impact of the candidate weight derivation mode on the candidate prediction mode is considered, but also the impact of the attribute information of the current block on the candidate prediction mode is considered, thereby improving an accuracy of determining the candidate prediction mode.

The content of the attribute information of the current block is not limited in the embodiments of the present application.

In some embodiments, the attribute information of the current block includes size information of the current block. The size information of the current block includes the length and width of the current block, the aspect ratio of the current block, or a number of samples included in the current block.

In some embodiments, the attribute information of the current block further includes shape information of the current block. For example, the shape of the current block is a square, or the shape of the current block is a rectangle, or the shape of the current block is a preset shape such as a polygon or a circle.

In the embodiments of the present application, determining the at least one candidate prediction mode based on the N candidate weight derivation modes and the attribute information of the current block may be understood as determining prediction modes of which neighboring blocks of the current block may be used to determine the candidate prediction mode based on the N candidate weight derivation modes and the attribute information of the current block. For example, the weights of the neighboring blocks are determined based on the candidate weight derivation modes and the attribute information of the current block, and based on the weights of the neighboring blocks, it is determined prediction modes of which neighboring blocks are selected for determining the candidate prediction mode.

In the embodiments of the present application, the prediction mode of the neighboring block refers to the prediction mode used when decoding the neighboring block.

Exemplarily, if in a certain GPM weight derivation mode, for a certain prediction mode (the first prediction mode or the second prediction mode), the weight of the neighboring block is greater than (or greater than or equal to) a certain threshold, then it represents that the neighboring block has a strong correlation with the area occupied in the current prediction mode; otherwise, it represents that the neighboring block has a weak correlation with the area occupied in the current prediction mode.

In some embodiments, at the decoding side, at least one candidate prediction mode is determined based on the N candidate weight derivation modes and the attribute information of the current block, and the at least one candidate prediction mode constitutes a candidate prediction mode list. That is, in these embodiments, the N candidate weight derivation modes correspond to a candidate prediction mode list. For example, if the partition line angles and offsets of the N candidate weight derivation modes are not significantly different, in order to reduce the amount of calculation and improve decoding efficiency, at the decoding side, a candidate weight derivation mode A is determined from the N candidate weight derivation modes, and a candidate prediction mode list is determined based on the candidate weight derivation mode and the attribute information of the current block. In an example, the candidate weight derivation mode A may be a default candidate weight derivation mode of the N candidate weight derivation modes. In another example, the encoding side may indicate the index of the candidate weight derivation mode A to the decoding side, so that the bitstream is obtained at the decoding side to obtain the index of the candidate weight derivation mode A.

In some embodiments, at least one candidate weight derivation mode of the N candidate weight derivation modes each corresponds to a respective candidate prediction mode list. For example, at the decoding side, a candidate prediction mode list for each of the N candidate weight derivation modes is determined. In this case, the S102 includes the following step S102-A.

S102-A, for an i-th candidate weight derivation mode of the N candidate weight derivation modes, a candidate prediction mode list corresponding to the i-th candidate weight derivation mode is determined based on the i-th candidate weight derivation mode and the attribute information of the current block.

In these embodiments, the method of determining the candidate prediction mode list corresponding to each candidate weight derivation mode of the N candidate weight derivation modes is the same. For the sake of ease of description, the i-th candidate weight derivation mode of the N candidate weight derivation modes is taken as an example for explanation. The i-th candidate weight derivation mode may be understood as any candidate weight derivation mode of the N candidate weight derivation modes.

The exemplary method of determining the candidate prediction mode list corresponding to the i-th candidate weight derivation mode based on the i-th candidate weight derivation mode and the attribute information of the current block is not limited in the embodiments of the present application.

In some embodiments, the i-th candidate weight derivation mode corresponds to a candidate prediction mode list; that is, a candidate prediction mode list corresponding to the i-th candidate prediction mode is determined based on the i-th candidate weight derivation mode and the attribute information of the current block. In this way, when predicting the current block, K prediction modes are determined from the candidate prediction mode list corresponding to the i-th candidate weight derivation mode, and then the current block is predicted based on the i-th candidate weight derivation mode and the K prediction modes to obtain a prediction value of the current block. For example, the weight is determined based on the i-th candidate weight derivation mode, the current block is predicted based on K prediction modes to obtain K prediction values, and the K prediction values are weighted using weights to obtain the prediction value of the current block in the i-th candidate weight derivation mode.

In an example of these embodiments, the method of determining the candidate prediction mode list corresponding to the i-th candidate weight derivation mode based on the i-th candidate weight derivation mode and the attribute information of the current block may be as follows. A partition line corresponding to the i-th candidate weight derivation mode is determined based on the i-th candidate weight derivation mode, and the partition for the current block is determined using the partition line to obtain a first part and a second part based on the attribute information of the current block; the first part may be understood as a part corresponding to the first prediction mode, and the second part may be understood as a part corresponding to the second prediction mode. In this way, the candidate prediction mode list corresponding to the i-th candidate weight derivation mode may be determined based on the prediction modes of the neighboring blocks neighboring to the first part of the current block of the neighboring blocks of the current block.

In another example of these embodiments, the method of determining the candidate prediction mode list corresponding to the i-th candidate weight derivation mode based on the i-th candidate weight derivation mode and the attribute information of the current block may be: determining weight of each neighboring block of the current block based on the i-th candidate weight derivation mode and the attribute information of the current block, and then determining the candidate prediction mode list corresponding to the i-th candidate weight derivation mode based on the weights of the neighboring blocks. For example, the candidate prediction mode list corresponding to the i-th candidate weight derivation mode is determined based on the prediction modes of the neighboring blocks with large weights.

In some embodiments, for the K prediction modes corresponding to the i-th candidate weight derivation mode, the S102-A includes the following S102-A1.

S102-A1, a candidate prediction mode list of at least one prediction mode of K prediction modes corresponding to the i-th candidate weight derivation mode is determined based on the i-th candidate weight derivation mode and the attribute information of the current block.

In these embodiments, at the decoding side, the candidate prediction mode list of at least one prediction mode of K prediction modes corresponding to the i-th candidate derivation mode is determined.

For example, if K=2, at the decoding side, based on the i-th candidate weight derivation mode and the attribute information of the current block, a candidate prediction mode list may be determined for the first prediction mode, but a candidate prediction mode list may not be determined for the second candidate prediction mode. Optionally, a candidate prediction mode list may be determined for the second prediction mode, but a candidate prediction mode list may not be determined for the first candidate prediction mode. Optionally, a candidate prediction mode list may be determined for the first prediction mode, and a candidate prediction mode list may be determined for the second candidate prediction mode. Optionally, a common candidate prediction mode list may be determined for the first prediction mode and the second prediction mode.

In the embodiments of the present application, a candidate prediction mode list is determined for at least one prediction mode corresponding to the i-th candidate weight derivation mode, and then at least one prediction mode corresponding to the i-th candidate weight derivation mode is accurately determined from the constructed candidate prediction mode list.

In some embodiments, if the at least one prediction mode corresponds to one candidate prediction mode list, the S102-A1 includes the following steps S102-A1-11 and S102-A1-12:
S102-A1-11, for a j-th prediction mode of the at least one prediction mode, a candidate prediction mode list of the j-th prediction mode is determined based on the i-th candidate weight derivation mode and the attribute information of the current block, where j is a positive integer; and
S102-A1-12, the candidate prediction mode list of the at least one prediction mode is determined based on the candidate prediction mode list of the j-th prediction mode.

In these embodiments, at least one prediction mode corresponding to the i-th candidate weight derivation mode corresponds to one candidate prediction mode list; that is, the candidate prediction mode lists corresponding to the at least one prediction mode are the same, which is a same candidate prediction mode list. Thus, it may be possible to reduce the complexity of determining the candidate prediction mode list to improve decoding efficiency. In this case, at the decoding side, one candidate prediction mode list is determined for the at least one prediction mode.

In some implementation, the candidate prediction mode list of the j-th prediction mode of the at least one prediction mode is determined based on the i-th candidate weight derivation mode and the attribute information of the current block. Optionally, the j-th prediction mode is any prediction mode of the at least one prediction mode. Then, the candidate prediction mode list of the at least one prediction mode is determined based on the candidate prediction mode list of the j-th prediction mode.

Determining the candidate prediction mode list of the at least one prediction mode based on the candidate prediction mode list of the j-th prediction mode in S102-A1-12 include but are not limited to the following manners.
Manner 1: directly determining the candidate prediction mode list of the j-th prediction mode as the candidate prediction mode list of the at least one prediction mode.
Manner 2: determining whether the candidate prediction mode list of the j-th prediction mode includes a preset prediction mode; in response to that the candidate prediction mode list of the j-th prediction mode includes the preset prediction mode, determining the candidate prediction mode list of the j-th prediction mode as the candidate prediction mode list of the at least one prediction mode; in response to that the candidate prediction mode list of the j-th prediction mode does not include the preset prediction mode, adding the preset prediction mode to the candidate prediction mode list of the j-th prediction mode to obtain the candidate prediction mode list of the at least one prediction mode.

The preset prediction mode in Manner 2 is not limited in the embodiments of the present application, and it is determined according to actual needs.

An exemplary process of determining the candidate prediction mode list of the at least one prediction mode in a case where the at least one prediction mode corresponds to one candidate prediction mode list has been introduced in these embodiments.

In some embodiments, if each prediction mode of the at least one prediction mode corresponds to one candidate prediction mode list, the S102-A1 includes the following step S102-A1-21.

S102-A1-21, for the j-th prediction mode of the at least one prediction mode mentioned above, a candidate prediction mode list of the j-th prediction mode is determined based on the i-th candidate weight derivation mode and the attribute information of the current block, where j is a positive integer.

In these embodiments, each prediction mode of the above at least one prediction mode corresponds to one candidate prediction mode list. Therefore, at the decoding side, a candidate prediction mode list is determined for each prediction mode of the at least one prediction mode corresponding to the i-th candidate weight derivation mode. For example, the at least one prediction mode includes a first prediction mode and a second prediction mode corresponding to the i-th candidate weight derivation mode; and then, at the decoding side, a candidate prediction mode list is determined for the first prediction mode, and a candidate prediction mode is determined for the second prediction mode.

In these embodiments, the process of determining a candidate prediction mode list corresponding to each prediction mode of the above at least one prediction mode is the same. For the sake of ease of description, determining the candidate prediction mode list of the j-th prediction mode in the above at least one prediction mode is taken as an example for explanation in the embodiments of the present application.

The following is an introduction to the process of determining the candidate prediction mode list of the j-th prediction mode based on the i-th candidate weight derivation mode and the attribute information of the current block in the S102-A1-11 and the S102-A1-21.

In the embodiments of the present application, determining the candidate prediction mode list of the j-th prediction mode based on the i-th candidate weight derivation mode and the attribute information of the current block include at least the following two implementations.

Implementation 1: at the decoding side, the candidate prediction mode list of the j-th prediction mode is determined via the following steps 11 to 13:
Step 11, determining a first look-up table, where the first look-up table includes neighboring blocks corresponding to different prediction modes under different block attribute information and different weight derivation modes;
Step 12, determining neighboring blocks corresponding to the j-th prediction mode in the first look-up table based on the attribute information of the current block and the i-th candidate weight derivation mode; and
Step 13, determining the candidate prediction mode list of the j-th prediction mode based on prediction modes of the neighboring blocks corresponding to the j-th prediction mode.

In Implementation 1, a first look-up table is determined based on different block attribute information. The first look-up table includes neighboring blocks corresponding to different prediction modes under different block attribute information and different weight derivation modes. In this way, the neighboring blocks corresponding to the j-th prediction mode may be obtained directly by searching the first look-up table, and then the candidate prediction mode list of the j-th prediction mode may be determined based on the prediction modes of the neighboring blocks corresponding to the j-th prediction mode.

The form of the first look-up table is not limited in the embodiments of the present application.

In a possible implementation, the first look-up table includes P different sub look-up tables, where the P sub look-up tables are look-up tables corresponding to the blocks with P pieces of attribute information, and the look-up table includes neighboring blocks corresponding to different prediction modes under different weight derivation modes. In this way, at the decoding side, a first sub look-up table corresponding to the current block may be determined in the P sub look-up tables based on the attribute information of the current block, where the first sub look-up table includes neighboring blocks corresponding to different prediction modes under different weight derivation modes; then, the neighboring blocks corresponding to the j-th prediction mode are determined in the first sub look-up table based on the i-th candidate weight derivation mode; and then, the candidate prediction mode list of the j-th prediction mode is determined based on the prediction modes of the neighboring blocks corresponding to the j-th prediction mode.

In the embodiments of the present application, different sub look-up tables are determined based on different block attribute information, where the look-up table includes the neighboring blocks corresponding to different prediction modes under different weight derivation modes.

In an example, it is assumed that the attribute information of the block includes an aspect ratio of the block. Assume that the P sub look-up tables include a look-up table corresponding to a block with an aspect ratio of 1:2, a look-up table corresponding to a block with an aspect ratio of 1:1, and a look-up table corresponding to a block with an aspect ratio of 2:1.

Exemplarily, the sub look-up table corresponding to the block with the aspect ratio of 1:2 is shown in Table 6.

TABLE 6

| | Weight derivation mode | | | | | | | | | |
|---|---|---|---|---|---|---|---|---|---|---|
| | a1 | a2 | a3 | a4 | a5 | a6 | a7 | a8 | a9 | a10 |
| First part | A | A | A | A | L + A | L + A | L + A | L + A | A | A |
| Second part | L | L | L | L + A | L + A | L | L | L + A | L + A | L + A |

| | Weight derivation mode | | | | | | | | | |
|---|---|---|---|---|---|---|---|---|---|---|
| | a11 | a12 | a13 | a14 | a15 | a16 | a17 | a18 | a19 | . . . |
| First part | A | A | A | A | L + A | L + A | L + A | L + A | A | . . . |
| Second part | L + A | L + A | L + A | L | L | L | L | L + A | L + A | . . . |

In this way, when the current block is decoded, based on the size information of the current block, if it is determined that the aspect ratio of the current block is 1:2, the first sub look-up table shown in Table 6 is obtained from the P sub look-up tables. Then, based on the i-th candidate weight derivation mode, the neighboring blocks corresponding to the j-th prediction mode are determined in the first sub look-up table. In some implementation, based on the i-th candidate weight derivation mode, determining the neighboring blocks corresponding to the j-th prediction mode in the first sub look-up table is as follows. Assume that K=2, the j-th prediction mode is a first prediction mode, which corresponds to the first part in the Table 6. In this way, based on the i-th candidate weighted derivation mode, the neighboring blocks corresponding to the i-th prediction mode may be determined in the neighboring blocks corresponding to the first part. For example, the i-th candidate weight derivation mode is a4, and the neighboring block of the first part corresponding to a4 is A. Therefore, a top-left neighboring block, a top neighboring block and a top-right neighboring block of the current block may be determined as the neighboring blocks corresponding to the i-th prediction mode; and then, based on the prediction modes of the top-left neighboring block, the top neighboring block and the top-right neighboring block of the current block, the candidate prediction mode list of the j-th prediction mode is determined. For example, the prediction modes of the top-left neighboring block, the top neighboring block and the top-right neighboring block of the current block are added to the candidate prediction mode list of the j-th prediction mode in a preset order.

Exemplarily, the sub look-up table corresponding to the block with the aspect ratio of 1:1 is shown in Table 7.

TABLE 7

| | Weight derivation mode | | | | | | | | | |
|---|---|---|---|---|---|---|---|---|---|---|
| | a1 | a2 | a3 | a4 | a5 | a6 | a7 | a8 | a9 | a10 |
| First part | A | L + A | A | A | L + A | L + A | L + A | L + A | A | A |
| Second part | L + A | L | L | L + A | L + A | L | L | L + A | L + A | L + A |

Weight derivation mode

| | a11 | a12 | a13 | a14 | a15 | a16 | a17 | a18 | a19 | . . . |
|---|---|---|---|---|---|---|---|---|---|---|
| First part | A | A | A | A | L + A | L + A | L + A | L + A | A | . . . |
| Second part | L + A | L + A | L + A | L | L | L | L | L + A | L + A | . . . |

In this way, when the current block is decoded, based on the size information of the current block, if it is determined that the aspect ratio of the current block is 1:1, the first sub look-up table shown in Table 7 is obtained from the P sub look-up tables. Then, based on the i-th candidate weight derivation mode, the neighboring blocks corresponding to the j-th prediction mode are determined in the first look-up table. In some implementation, based on the i-th candidate weight derivation mode, determining the neighboring blocks corresponding to the j-th prediction mode in the first sub look-up table is as follows. Assume that K=2, the j-th prediction mode is the first prediction mode, which corresponds to the first part in Table 7. In this way, based on the i-th candidate weighted derivation mode, the neighboring blocks corresponding to the i-th prediction mode may be determined in the neighboring blocks corresponding to the first part. For example, the i-th candidate weight derivation mode is a2, and the neighboring blocks of the first part corresponding to a2 is L+A. Therefore, a left neighboring block, a bottom-left neighboring block, a top-left neighboring block, a top neighboring block and a top-right neighboring block of the current block may be determined as the neighboring blocks corresponding to the i-th prediction mode, and then, based on the prediction modes of the left neighboring block, the bottom-left neighboring block, the top-left neighboring block, the top neighboring block and the top-right neighboring block of the current block, the candidate prediction mode list of the j-th prediction mode is determined. For example, the prediction modes of the left neighboring block, the bottom-left neighboring block, the top-left neighboring block, the top neighboring block and the top-right neighboring block of the current block are added to the candidate prediction mode list of the j-th prediction mode in the preset order.

Exemplarily, the sub look-up table corresponding to the block with the aspect ratio of 2:1 is shown in Table 8.

TABLE 8

| | Weight derivation mode | | | | | | | | | |
|---|---|---|---|---|---|---|---|---|---|---|
| | a1 | a2 | a3 | a4 | a5 | a6 | a7 | a8 | a9 | a10 |
| First part | L | L + A | A | A | L + A | L + A | L + A | L + A | A | A |
| Second part | L + A | L | L | L + A | L + A | L | L | L + A | L + A | L + A |

Weight derivation mode

| | a11 | a12 | a13 | a14 | a15 | a16 | a17 | a18 | a19 | . . . |
|---|---|---|---|---|---|---|---|---|---|---|
| First part | L | A | A | A | L + A | L + A | L + A | L + A | A | . . . |
| Second part | L + A | L + A | L + A | L | L | L | L | L + A | L + A | . . . |

In this way, when the current block is decoded, based on the size information of the current block, if it is determined that the aspect ratio of the current block is 2:1, the first sub look-up table shown in Table 8 is obtained from the P sub look-up tables. Then, based on the i-th candidate weight derivation mode, the neighboring blocks corresponding to the j-th prediction mode are determined in the first sub look-up table. In some implementation, based on the i-th candidate weight derivation mode, the neighboring blocks corresponding to the j-th prediction mode are determined in the first sub look-up table. Assume that K=2, the j-th prediction mode is the first prediction mode, which corresponds to the first part of the Table 8. In this way, based on the i-th candidate weighted derivation mode, the neighboring blocks corresponding to the i-th prediction mode may be determined in the neighboring blocks corresponding to the first part. For example, the i-th candidate weight derivation mode is a1, and the neighboring block of the first part corresponding to a1 is L. Therefore, a left neighboring block, a bottom-left neighboring block and a top-left neighboring block of the current block may be determined as the neighboring blocks corresponding to the i-th prediction mode, and then, based on the prediction modes of the left neighboring block, the bottom-left neighboring block and the top-left neighboring block of the current block, the candidate prediction mode list of the j-th prediction mode is determined. For example, the prediction modes of the left neighboring block, the bottom left neighboring block and the top-left neighboring block of the current block are added to the candidate prediction mode list of the j-th prediction mode in a preset order.

It will be noted that the Table 6, Table 7 and Table 8 are only examples and are not limitations on the embodiments of the present application. The contents included in the sub look-up table corresponding to the blocks of different attribute information in the embodiments of the present application are determined according to actual conditions.

Tables 7 and 8 show neighboring blocks corresponding to different prediction modes (i.e., different part) under different candidate weight derivation modes. The candidate weight derivation mode may be understood as an index of the candidate weight derivation mode.

In some embodiments, an angle index may be used to replace the candidate weight derivation mode; that is, the sub look-up table includes neighboring blocks corresponding to different prediction modes under different angle indexes. In this way, when searching for neighboring blocks, the first sub look-up table is first determined from the P look-up tables based on the attribute information of the current block, then an angle index corresponding to the i-th candidate prediction mode is determined, and then, based on the angle index, the neighboring blocks corresponding to the j-th prediction mode are determined from the first sub look-up table.

In some embodiments, the aspect ratio of the current block may be replaced by a shape index of the current block. For example, a shape index of 0 represents that the aspect ratio is 1:1, a shape index of 1 represents that the aspect ratio is 2:1, a shape index of 2 represents that the aspect ratio is 1:2, and so on. In the embodiments of the present application, the index of each shape is used to construct a sub look-up table, and thus there are P look-up tables.

The exemplary method in which P sub look-up tables are determined at the decoding side is not limited in the embodiments of the present application.

In a possible implementation, the encoding side transmits P sub look-up tables to the decoding side. Since the P sub look-up tables do not include picture information, in an example, the encoding side may transmit the P sub look-up tables to the decoding side in a manner of transmitting other data. In another example, the encoding side encodes the P sub look-up tables into a bitstream and transmits the bitstream to the decoding side.

In another possible implementation, at the decoding side, P sub look-up tables are obtained from other storage devices.

In yet another possible implementation, P sub look-up tables are stored in the decoding side.

In still another possible implementation, at the decoding side, P sub look-up tables may be constructed. For example, for each candidate weight derivation pattern of the N candidate weight derivation patterns, based on the candidate weight derivation mode and the attribute information of the block, the first neighboring block that has a strong correlation with the first part of the block and the second neighboring block that has a strong correlation with the second part of the block are determined, and then, based on the first neighboring block and the second neighboring block, sub look-up tables as shown in Tables 6 to 8 are constructed.

In some embodiments, the first look-up table is a table including neighboring blocks corresponding to different prediction modes under different block attribute information and different weight derivation modes. That is, the sub look-up tables shown in Table 6 to Table 7 are combined into one look-up table.

TABLE 9

Weight derivation mode

| | | a1 | a2 | a3 | a4 | a5 | a6 | a7 | a8 | . . . |
|---|---|---|---|---|---|---|---|---|---|---|
| 1:2 | First part | L | L + A | A | A | L + A | L + A | L + A | L + A | . . . |
| | Second part | L + A | L | L | L + A | L + A | L | L | L + A | . . . |

| | | Weight derivation mode | | | | | | | | |
|---|---|---|---|---|---|---|---|---|---|---|
| | | a11 | a12 | a13 | a14 | a15 | a16 | a17 | a18 | . . . |
| 1:1 | First part | L | A | A | A | L + A | L + A | L + A | L + A | . . . |
| | Second part | L + A | L + A | L + A | L | L | L | L | L + A | . . . |
| . . . | . . . | . . . | . . . | . . . | . . . | . . . | . . . | . . . | . . . | . . . |

In this way, at the decoding side, the neighboring block corresponding to the j-th prediction mode may be determined from the first look-up table shown in Table 9 based on the attribute information of the current block and the i-th candidate weight derivation mode, and determine the candidate prediction mode list of the j-th prediction mode based on the prediction mode of the neighboring block corresponding to the j-th prediction mode.

Implementation 1 described above shows that based on the i-th candidate weight derivation mode and the attribute information of the current block, the candidate prediction mode list of the j-th prediction mode is determined by searching for a look-up table.

In some embodiments, the candidate prediction mode list of the j-th prediction mode may also be determined by the following Implementation 2.

Implementation 2, at the decoding side, a candidate prediction mode list of the j-th prediction mode is determined via the following steps 21 and 22:
Step 21, determining weights of neighboring blocks of the current block with respect to the j-th prediction mode based on the i-th candidate weight derivation mode and the attribute information of the current block; and
Step 22, determining the candidate prediction mode list of the j-th prediction mode based on the weights of the neighboring blocks with respect to the j-th prediction mode.

In the Implementation 2, a weight of each of the neighboring blocks of the current block with respect to the j-th prediction mode is determined to select prediction modes of which neighboring blocks of the current block, and thus, a candidate prediction mode list of the j-th prediction mode is constructed.

An exemplary process of determining the weights of the neighboring blocks of the current block with respect to the j-th prediction mode based on the i-th candidate weight derivation mode and the attribute information of the current block will be introduced below.

In the step 21, determining the weights of the neighboring blocks of the current block with respect to the j-th prediction mode include but are not limited to the following manners.

Manner 1, for any neighboring block of the current block, a weight of each point in this neighboring block with respect to the j-th prediction mode are determined based on the i-th candidate weight derivation mode and the attribute information of the current block; the weight of the neighboring block with respect to the j-th prediction mode is determined based on the weights of all the points in the neighboring block with respect to the j-th prediction mode.

In an example, an average value of the weights of all the points in the neighboring block with respect to the j-th prediction mode is determined as the weight of the neighboring block with respect to the j-th prediction mode.

In another example, a weighted average of the weights of all the points in the neighboring block with respect to the j-th prediction mode is determined as the weight of the neighboring block with respect to the j-th prediction mode. Optionally, when determining the weighted average, samples in the neighboring block that are neighboring to the current block are assigned a larger weight, and samples in the neighboring block that are farther from the current block are assigned a smaller weight.

In yet another example, a sum of the weights of all the points in the neighboring block with respect to the j-th prediction mode is determined as the weight of the neighboring block with respect to the j-th prediction mode.

In another example, a weighted sum of the weights of all the points in the neighboring block with respect to the j-th prediction mode is determined as the weight of the neighboring block with respect to the j-th prediction mode. Optionally, when determining the weighted sum value, samples in the neighboring block that are neighboring to the current block are assigned a larger weight, and samples in the neighboring block that are farther from the current block are assigned a smaller weight.

In Manner 1, the weight of each point in the neighboring block with respect to the j-th prediction mode is determined based on the i-th candidate weight derivation mode and the attribute information of the current block in a same way. In some embodiments, since the neighboring blocks of the current block are located in a template of the current block, after a weight of the template of the current block is determined, the weight of each point in the neighboring block may be determined.

For example, a weight of a template of the current block is determined based on the i-th weight derivation mode, the attribute information of the current block and the template of the current block. For Point 1 in the neighboring block, the weight corresponding to Point 1 in the weight of the template of the current block is determined as the weight of the point 1 with respect to the j-th prediction mode. Referring to this manner, the weight of each point in the neighboring block with respect to the j-th prediction mode may be determined.

Manner 2: a weight of a certain point in the neighboring block is determined as the weight of the neighboring block with respect to the j-th prediction mode. In this case, the step 21 includes the following steps:
Step 21-A, determining a weight of a first point in the neighboring block based on the i-th candidate weight derivation mode and the attribute information of the current block; and
Step 21-B, determining the weight of the first point as the weight of the neighboring block with respect to the j-th prediction mode.

In the Manner 2, at the decoding side, the weight of the neighboring block with respect to the j-th prediction mode is determined by determining the weight of the first point in the neighboring block with respect to the j-th prediction mode, which may reduce the amount of calculation for determining the weight of the neighboring block, thereby improving the decoding efficiency.

The position of the first point in the neighboring block is not limited in the embodiments of the present application.

In a possible implementation, the first point is any point in the neighboring block.

In another possible implementation, the first point is a point in the neighboring block that is neighboring to the current block.

In the Manner 2, determining the weight of the first point in the neighboring block includes at least the following manners.

In a first manner, the weight of the first point in the neighboring block is directly determined. In this case, the above step 21-A includes the following step:
Step 21-A11, determining the weight of the first point based on the i-th candidate weight derivation mode, the attribute information of the current block and the template of the current block.

In the embodiments of the present application, since the neighboring block is located in the template area of the current block, the first point in the neighboring block is located in the template area of the current block. Thus, the weight of the first point may be determined by referring to the method of determining the weight of the template of the current block, which includes, for example, the following examples.

Example 1: in the case where the weight of each point in the template is determined, and a matrix composed of the weights of all the points is determined as the weight of the template, at the decoding side, the weight of the first point may be directly determined based on the i-th candidate weight derivation mode, the attribute information of the current block and the template of the current block, and the position information (x, y) of the first point in the template.

In some implementation, the angle index and distance index corresponding to the i-th candidate weight derivation mode are determined, and a first parameter of the first point in the template is determined according to the angle index, distance index, the size of the template, and the position information (x, y) of the first point. In some embodiments, the first parameter is also referred to as the weight index weightIdx; the weight of the first point in the template is determined based on the first parameter of the first point in the template.

In a possible implementation, the weight of the first point in the template may be determined in the following manner.

The inputs of the weight derivation process of the first point in the template are: a width nCbW of the current block, a height nCbH of the current block; a width nVmW of the left part of the template, a height nVmH of the top of the template; a “partition” angle index variable angleId of the i-th candidate weight derivation mode, a distance index variable distanceIdx of the i-th candidate weight derivation mode, and a component index variable cIdx. Exemplarily, the chroma component is taken as an example in the present application, so cIdx is 0, indicating a chroma component.

Variables nW, nH, shift1, offset1, displacementX, displacementY, partFlip and shiftHor are derived as follows:

$$nW = ( cIdx == 0 ) ? nCbW : nCbW * EubWidthC$$

$$nH = ( cIdx == 0 ) ? nCbH : nCbH * EubHeightC$$

$$shift 1 = Max ( 5 , 17 - BitDepth ) , \\ where BitDepth is a bit depth of the encoding and decoding$$

$$offset 1 = 1 << ( shift 1 - 1 )$$

$$displacementX = angleIdx$$

$$displacementY = ( angleIdx + 8 ) \%32$$

$$partFlip = ( angleIdx >= 13 \&\& angleIdx <= 27 ) ? 0 : 1$$

$$shiftHor = ( angleIdx \% 16 == 8 ‖ ( angleIdx \%16 != 0 \&\& nH >= nW ) ) ? 0 : 1$$

The offsets offsetX and offsetY are derived as follows:
if a value of shiftHor is 0:

$$offsetX = ( - nW ) >> 1$$

$$offsetY = ( ( - nH ) >> 1 ) + ( angleIdx < 16 ? ( distanceIdx * nH ) >> 3 : - ( ( distanceIdx * nH ) >> 3 ) )$$

Otherwise (i.e., the value of shiftHor is 1):

$$offsetX = ( ( - nW ) >> 1 ) + ( angleIdx < 16 ? ( distanceIdx * nW ) >> 3 : - ( ( distanceIdx * nW ) >> 3 ) )$$

$$offsetY = ( - nH ) >> 1$$

For template weight matrix wVemplateValue [x] [y] (where x=−nVmW . . . nCbW-1, y=−nVmH . . . nCbH−1, excluding the case where x and y are both greater than or equal to 0), it will noted that in this example, the coordinates of the top-left corner of the current block are (0, 0), and the template weight matrix is derived as follows:
the variables xL and yL are derived as follows:

$$xL = ( cIdx == 0 ) ? x : x * EubWidthC$$

$$yL = ( cIdx == 0 ) ? y : y * EubHeightC$$

disLut is determined according to Table 3.

The first parameter weightIdx is derived as follows:

$$weightIdx = ( ( ( xL + offsetX ) << 1 ) + 1 ) * disLut [ displacementX ] + ( ( ( yL + offsetY ) << 1 ) + 1 ) * disLut [ displacementY ]$$

After the first parameter weightIdx corresponding to the first point is determined in the above manner, the weight of the first point may be determined in at least two manners as follows.

One possible manner is that the weight of the first point in the template is determined according to the following formula:

$$weightIdxL = partFlip ? 32 + weightIdx : 32 - weightIdx$$

$$wVemplateValue [ x ] [ y ] = Clip 3 ( 0 , 8 ( weightIdxL + 4 ) >> 3 )$$

Here, wVemplateValue [x] [y] is the weight of the first point (x, y) in the template, weightIdxL is the weight index under the first component (e.g., the luma component), wVemplate Value [x] [y] is the weight of the first point (x, y) in the template, partFlip is an intermediate variable, which is determined according to the angle index angleIdx; for example, as described above, partFlip=(angleIdx>=13 && angleIdx <=27)? 0:1; that is, a value of partFlip is 1 or 0; in response to that partFlip is 0, weightIdxL is 32-weightIdx; in response to that partFlip is 1, weightIdxL is 32+weightIdx. It will be noted that 32 here is just an example, which is not limited in the present application.

Another possible manner is that the weight of the first point is determined according to the first parameter weightIdx, a first threshold and a second threshold corresponding to the first point in the template.

In order to reduce the computational complexity of the weight of the first point, in a second manner, the weight of the sample in the template is limited to the first threshold or the second threshold, that is, the weight of the first point is either the first threshold or the second threshold, thereby reducing the computational complexity of the first point weight.

The values of the first threshold and the second threshold are not limited in the present application.

Optional, the first threshold is 1.

Optionally, the second threshold is 0.

In an example, the weight of the first point may be determined through the following formula:

$$wVemplateValue [ x ] [ y ] = ( partFlip ? weightIdx : - weightIdx ) > 0 ? 1 : 0$$

Here, wVemplate Value [x] [y] is the weight of the midpoint (x, y) of the template, and in the above “1:0”, 1 is the first threshold and 0 is the second threshold.

It will be noted that the above description is made by taking the j-th prediction mode as the first prediction mode as an example, that is, what is determined above is the weight of the first point with respect to the first prediction mode. In a case where the j-th prediction mode is the second prediction mode, the weight of the first point with respect to the second prediction mode is 8-wVemplateValue[x][y], where 8 is only an example and may be replaced by other values, which is not limited in the embodiments of the present application.

In the above Example 1, the weight of the first point in the neighboring block is determined by referring to the manner in which the weight of the sample in the template is determined. The whole process is simple, and the weight of the first point determined is accurate.

Example 2: from the above, it may be seen that the first point is a point in the template, so the weight of the entire template may be determined, and then, the weight of the first point may be determined based on the weight of the template. In this case, the above step 21-A11 includes: determining the weight of the template based on the i-th candidate weight derivation mode, the attribute information of the current block and the template of the current block; and determining the weight corresponding to the first point in the weight of the template as the weight of the first point.

In some implementation, the angle index and distance index corresponding to the i-th candidate weight derivation mode are determined, a size of the current block based on the attribute information of the current block is determined, and the first parameter of each sample in the template is determined according to the angle index, distance index, the size of the current block and the size of the template. In some embodiments, the first parameter is also referred to as the weight index weightIdx; the weight of the template is determined according to the first parameter of each sample in the template.

In a possible implementation, the weight of the template may be determined in the following manner.

The inputs of the template weight derivation process are: a width nCbW, of the current block, and a height nCbH of the current block; a width nVmW of the left of template, and a height nVmH of the top of template; a “partition” angle index variable angleld of GPM; a distance index variable distanceIdx of GPM, and the component index variable cIdx. Exemplarily, the chroma component is taken as an example in the present application, so cldx is 0, indicating a chroma component.

Variables nW, nH, shift1, offset1, displacementX, displacementY, partFlip and shiftHor are derived as follows:

$$nW = ( cIdx == 0 ) ? nCbW : nCbW ⋆ EubWidthC$$

$$nH = ( cIdx == 0 ) ? nCbH : nCbH ⋆ EubHeightC$$

$$shift 1 = Max ( 5 , 17 - BitDepth ) , where BitDepth is the bit depth of the enconding and decoding$$

$$offset 1 = 1 << ( shift 1 - 1 )$$

$$displacementX = angleIdx$$

$$displacementY = ( angleIdx + 8 ) \% 32$$

$$partFlip = ( angleIdx >= 13 \&\& angleIdx <= 27 ) ? 0 : 1$$

$$shiftHor = ( angleIdx \% 16 == 8 \vert \vert ( angleIdx \% 16 != 0 \&\& nH >= nW ) ) ? 0 : 1$$

The offsets offsetX and offsetY are derived as follows:
if a value of shiftHor is 0:

$$offsetX = ( - n W ) >> 1$$

$$offsetY = ( ( - nH ) >> 1 ) + ( angleIdx < 16 ? ( distanceIdx ⋆ nH ) >> 3 : - ( ( distanceIdx ⋆ nH ) >> 3 ) )$$

otherwise (i.e., the value of shiftHor is 1):

$$offsetX = ( ( - n W ) >> 1 ) + ( angleIdx < 16 ? ( distanceIdx ⋆ nW ) >> 3 : - ( ( distanceIdx ⋆ nH ) >> 3 ) )$$

$$offsetY = ( - nH ) >> 1$$

For template weight matrix w Vemplate Value [x] [y] (where x=−nVmW . . . nCbW−1, y=−nVmH . . . nCbH−1, excluding the case where x and y are both greater than or equal to 0), it will noted that in this example, the coordinates of the top-left corner of the current block are (0, 0), and the template weight matrix is derived as follows:
the variables xL and yL are derived as follows:

$$x L = ( cIdx == 0 ) ? x : x ⋆ EubWidthC$$

$$yL = ( cIdx == 0 ) ? y : y ⋆ EubHeightC$$

disLut is determined according to Table 3.

The first parameter weightIdx is derived as follows:

$$weightIdx = ( ( ( xL = offsetX ) << 1 ) + 1 ) ⋆ disLut [ displacementX ] + ( ( ( yL + offsetY ) << 1 ) + 1 ) ⋆ disLut [ displacementY ]$$

In some embodiments, after the first parameter weightIdx is determined in the above manner, the weight of the sample in the template is determined according to the following formula:

$$weightIdxL = partFlip ? 32 + weightIdx : 32 - weightIdx$$

$$wVemplateValue [ x ] [ y ] = C lip 3 ( 0 , 8 , ( weightIdxL + 4 ) >> 3 )$$

Here, wVemplateValue [x] [y] is the weight of the point (x, y) of the template, weightIdxL is the weight index under the first component (e.g., the luma component), wVemplateValue[x][y] is the weight of the point (x, y) of the template, partFlip is an intermediate variable, which is determined according to the angle index angleIdx; for example, as described above, partFlip=(angleIdx>=13 && angleIdx <=27)? 0:1; that is, a value of partFlip is 1 or 0; in response to that partFlip is 0, weightIdxL is 32-weightIdx; in response to that partFlip is 1, weightIdxL is 32+weightIdx. It will be noted that 32 here is just an example, which is not limited in the present application.

In some embodiments, according to the above method, after the first parameter weightIdx is determined, the weight of the sample in the template is determined according to the first parameter weightIdx, the first threshold and the second threshold of the sample in the template.

In order to reduce the computational complexity of the weight of the template, in the embodiments, the weight of the sample in the template is limited to the first threshold or the second threshold, i.e., the weight of sample in the template is either the first threshold or the second threshold, thereby reducing the computational complexity of the template weights.

In an example, the weights of the samples in the template may be determined by the following formula:

$$wVemplateValue [ x ] [ y ] = ( partFlip ? weightIdx : - weightIdx ) > 0 ? 1 : 0$$

where wVemplate Value [x] [y] is the weight of the point (x, y) of the template, and in the above “1:0”, 1 is the first threshold, and 0 is the second threshold.

In the above implementation, the weight of each point in the template is determined via the weight derivation mode, and the weight matrix composed of the weights of all the points in the template is used as the template weight.

In another possible implementation, the merged area composed of the current block and the template is taken as a whole, the weights of the samples in the merged area are derived according to the weight derivation mode, and then the weight of the template is determined based on the weights of the merged area.

Exemplarily, at the decoding side, the weights of the samples in the merged area composed of the current block and the template are determined based on the angle index, the distance index, the size of the template and the size of the current block; and then, the template weight is determined based on the size of the template and the weights of the samples in the merged area.

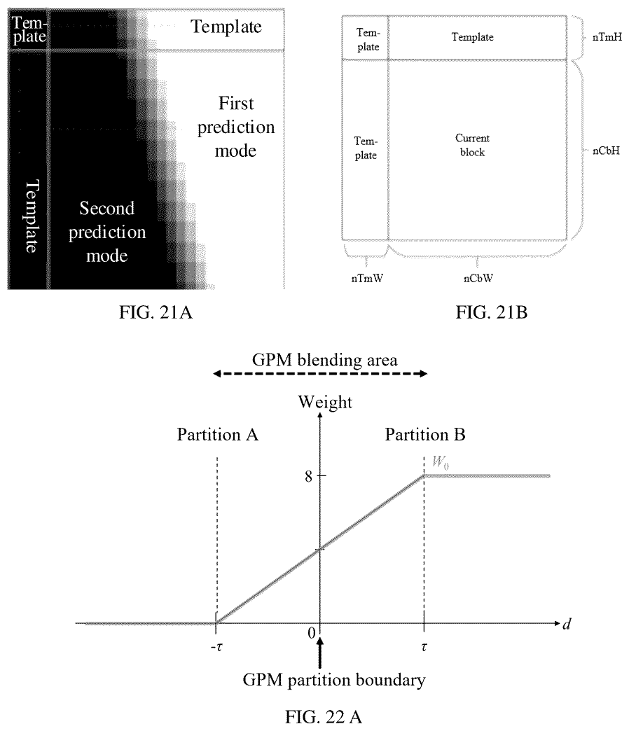

In this implementation, the current block and the template are taken as a whole, and the weights of the samples in the merged area composed of the current block and the template are determined based on the angle index, the distance index, the size of the template and the size of the current block. Then, the weight corresponding to the template of the merged area is determined as the weight of the template according to the size of the template. For example, as shown in FIGS. 21A and 21B, the weight corresponding to the L-shaped template area in the merged area is determined as the weight of the template.

In an example, in this implementation, the process of deriving the template weight is as follows.

The inputs of this process are: a width nCbW of the current block, a height nCbH of the current block, a width nTmW of the left part of the template, a height nTmH of the top part of the template, a “partition” angle index variable angleIdx of GPM, a distance index variable distanceIdx of GPM, and a component index variable cIdx. Because only chroma is used as an example in this example, cIdx is 0 in this example, indicating the chroma component.

The output of this process is the template weight matrix wTemplate Value.

Variables nW, nH, shift1, offset1, displacementX, displacementY, partFlip and shiftHor are derived as follows:

$$nW = ( cIdx == 0 ) ? nCbW : nCbW ⋆ SubWidthC$$

$$nH = ( cIdx == 0 ) ? nCbH : nCbH ⋆ SubHeightC$$

$$shift 1 = Max ( 5 , 17 - BitDepth ) , where BitDeph ) , where bitDepth is the depth enconding and decoding$$

$$offset 1 = 1 << ( shift 1 - 1 )$$

$$displacementX = angleIdx )$$

$$displacementY = ( angleIdx + 8 ) \% 32$$

$$partFlip = ( angleIdx >= 13 \&\& angleIdx <= 27 ) ? 0 : 1$$

$$shiftHor = ( angleIdx \% 16 == 8 \vert \vert ( angleIdx \%16 != 0 \&\& nH >= nW ) ) ? 0 : 1$$

The variables offsetX and offsetY are derived as follows:
if a value of shiftHor is 0:

$$offsetX = ( ( - nW ) >> 1 )$$

$$offsetY = ( ( - nH ) >> 1 ) + ( angleIdx < 16 ? ( distanceIdx ⋆ nH ) >> 3 : - ( ( distanceIdx ⋆ nH ) >> 3 ) )$$

otherwise (i.e., the value of shiftHor is 1):

$$offsetX = ( ( - nW ) >> 1 ) + ( angleIdx < 16 ? ( distanceIdx ⋆ nW ) >> 3 : - ( ( distanceIdx ⋆ nW ) >> 3 ) )$$

$$offsetY = ( ( - nH ) >> 1 )$$

For the template weight matrix wTemplateValue [x] [y] (where x=−nTmW . . . nCbW−1, y=−nTmH . . . nCbH−1, excluding the case where x and y are both greater than or equal to 0), it will noted that in this example, the coordinates of the top-left corner of the current block are (0, 0), and the template weight matrix is derived as follows:
the variables xL and yL are derived as follows:

$$xL = ( cIdx == 0 ) ? x : x ⋆ SubWidthC$$

$$yL = ( cIdx == 0 ) ? y : y ⋆ SubHeightC$$

disLut is determined according to Table 3.

$$weightIdx = ( ( ( xL = offsetX ) << 1 ) + 1 ) ⋆ disLut [ displacementX ] + ( ( ( yL + offsetY ) << 1 ) + 1 ) ⋆ disLut [ displacementY ]$$

$$weightIdxL = partFlip ? 32 + weightIdx : 32 - weightIdx$$

$$wVemplateValue [ x ] [ y ] = ( Clip 3 ( 0 , 8 , ( weightIdxL + 4 ) >> 3 )$$

In some embodiments, for ease of calculation, the template weight may be set to only two possible values, such as 0 and 1.

In an example, the weight of the sample in the template may be determined by the following formula:

$$wVemplateValue [ x ] [ y ] = ( partFlip ? weightIdx : - weightIdx ) > 0 ? 1 : 0$$

It will be noted that the above description is made by taking the j-th prediction mode as the first prediction mode as an example, that is, what is determined above is the weight of the template with respect to the first prediction mode. In a case where the j-th prediction mode is the second prediction mode, the weight of the template with respect to the second prediction mode is 8-wVemplate Value [x] [y], where 8 is only an example and may be replaced with other values, which is not limited in the embodiments of the present application.

In the Example 2, the weight of the template with respect to the j-th prediction mode is determined in the i-th candidate weight derivation mode, and then the weight of the first point in the weight of the template with respect to the j-th prediction mode is determined as the weight of the first point in the neighboring block with respect to the j-th prediction mode.
In the above Manner 1, the weight of the first point in the neighboring block is directly determined by referring to the method of determining the weight of the template, so that the weight of the first point may be accurately determined. In this way, the weight of the neighboring block with respect to the j-th prediction mode may be accurately determined based on the weight of the first point.
Manner 2, the weight of the first point in the neighboring block is determined based on the weight of the second point in the current block; in this case, the step 21-A includes the following steps:
Step 21-A-21, determining a second point in the current block corresponding to the first point;
Step 21-A-22, determining a weight of the second point based on the i-th candidate weight derivation mode and the attribute information of the current block; and
Step 21-A-23, determining the weight of the first point based on the weight of the second point.
In the Manner 2, it may be seen from the above that when the weight of the first point in the neighboring block is directly determined, it is necessary to consider the relevant information of the template, resulting in the increase of the complexity of determining the weight of the first point. In the Manner 2, the weight of the first point in the neighboring block is determined through the weight of the second point in the current block. When the weight of the second point is determined, there is no need to consider the relevant information of the template, thereby reducing the complexity of determining the weight of the first point.

The position of the second point in the current block corresponding to the first point is not limited in the embodiments of the present application.

In some embodiments, the second point is a point in the current block that is closest to the first point.

In an example, the second point is a point in the current block that is neighboring to the first point. For example, as shown in FIG. 18, the first point is a point at (x0-1, y0-1) in the neighboring block, and the second point may be a point at (x0, y0) in the current block. For another example, as shown in FIG. 18, the first point is a point at (x0-1, y0+height−1) in the neighboring block, and the second point may be a point at (x0, y0+height−1) in the current block.

In the Manner 2, an exemplary process of determining the weight of the second point based on the i-th candidate weight derivation mode and the attribute information of the current block may be as follows: determining a partition angle index variable angleIdx and a distance index variable distanceIdx corresponding to the i-th candidate weight derivation mode based on the i-th candidate weight derivation mode, and determining the size (nCbW) X (nCbH) of the current block based on the attribute information of the current block. The weight of the second point in the current block is determined with reference to above method of determining the weight of the prediction value. It will be noted that the above description is made by taking the j-th prediction mode is the first prediction mode as an example, i.e., what is determined above is the weight of the second point with respect to the first prediction mode. In a case where the j-th prediction mode is the second prediction mode, the weight of the second point with respect to the first prediction mode is 8-wVemplateValue [x] [y], where 8 is only an example and may be replaced with other values, which is not limited in the embodiments of the present application.

After the weight of the second point in the current block with respect to the j-th prediction mode is determined at the decoding side, the weight of the first point in the neighboring block is determined based on the weight of the second point. For example, in response to that the second point is neighboring to the first point, the weight of the second point may be directly determined as the weight of the first point. For another example, in response to that the second point is not neighboring to the first point, the weight of the second point may be corrected to obtain the weight of the first point, the correction method is not limited in the embodiments of the present application; for example, a preset value may be added or subtracted based on the weight of the second point to obtain the weight of the first point.

It will be noted that, for the process of determining the weight of the first point shown in the Manner 1 and determining the weight of the second point shown in the Manner 2, the influence of a weight gradient parameter is not considered.

In some embodiments, if the influence of the weight gradient parameter is considered in the process of determining the weight of the first point, at the decoding side, it also needs to determine the weight gradient parameter, and then determine the weight of the first point in the neighboring blocks based on the i-th candidate weight derivation mode, the attribute information of the current block and the weight gradient parameter.

The variable weight gradient may adjust a gradient of the weight change, so that blending areas with different widths may be obtained for the GPM in a case where the partition line angle and the partition line offset are the same.

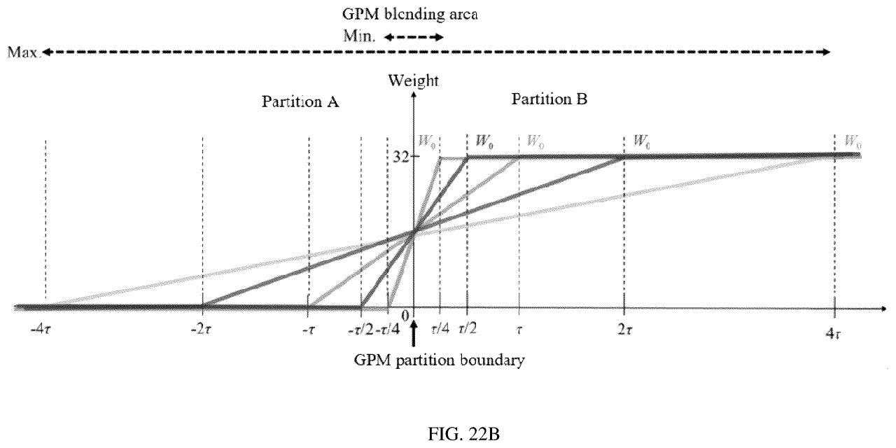

Exemplarily, as shown in FIGS. 22A and 22B, FIG. 22A is a schematic diagram of a blending area for GPM in VVC, and FIG. 22B is an example of a variable weight gradient for GPM.

A value of blendingCoeff may be ¼, ½, 1, 2, 4, etc.

Exemplarily, the value of blendingCoeff may be derived from the weight gradient index gpm_blending_idx.

In some embodiments, the weight gradient index is also referred to as a blending gradient parameter or a blending parameter.

In the embodiments of the present application, determining the weight gradient parameter include at least the following manners.

Manner 1: a bitstream is decoded to obtain a second index, where the second index is used to indicate a weight gradient parameter, and the weight gradient parameter is determined based on the second index. In some implementation, at encoding side, after the weight gradient parameter is determined, the second index corresponding to the weight gradient parameter is encoded into the bitstream. Then, at the decoding side, the second index is obtained by decoding the bitstream, and the weight gradient parameter is determined according to the second index.

In some embodiments, the second index is also referred to as a weight gradient index.

In the embodiments of the present application, the exemplary manner in which the weight gradient parameter is determined based on the second index is not limited.

In some embodiments, at the decoding side, a candidate blending parameter list is determined, and the candidate blending parameter list includes multiple candidate blending parameters, and a candidate blending parameter corresponding to the second index in the candidate blending parameter list is determined as the weight gradient parameter.

The manner in which the candidate blending parameter list is determined is not limited in the embodiments of the present application.

In an example, the candidate blending parameters in the candidate blending parameter list are preset.

In another example, at the decoding side, at least one blending parameter from is selected from multiple preset blending parameters based on the feature information of the current block to constitute a candidate blending parameter list. For example, based on the picture information of the current block, a blending parameter that matches the picture information of the current block is selected from the multiple preset blending parameters to constitute a candidate blending parameter list.

For example, assuming that the picture information includes a clarity of picture edge, in response to that the clarity of the image edge of the current block is less than a preset value, at least one first-type weight gradient parameter, such as ¼, ½, is selected from the preset multiple weight gradient parameters to constitute a candidate weight gradient parameter list; in response to that the clarity of the picture edge of the current block is greater than or equal to the preset value, at least one second-type weight gradient parameter, such as 2, 4, is selected from the preset multiple weight gradient parameters to constitute a candidate weight gradient parameter list.

Exemplarily, the candidate weight gradient parameter list in the embodiments of the present application is shown in Table 10.

TABLE 10

| Index | Candidate weight gradient parameter |
|---|---|
| 0 | Candidate weight gradient parameter 1 |
| 1 | Candidate weight gradient parameter 2 |
| . . . | . . . |
| i | Candidate weight gradient parameter i |
| . . . | . . . |

As shown in Table 10, the candidate weight gradient parameter list includes multiple candidate weight gradient parameters, and each candidate weight gradient parameter corresponds to an index.

Exemplarily, in the above Table 10, a ranking of the candidate weight gradient parameters in the candidate weight gradient parameter list is used as the index. Optionally, the indexes of the candidate weight gradient parameters in the candidate weight gradient parameter list may also be reflected in other ways, which is not limited in the embodiments of the present application.

Based on the above Table 10, at the decoding side, the candidate weight gradient parameter corresponding to the second index in Table 10 is determined as the weight gradient parameter according to the second index.

At the decoding side, the bitstream is decoded via the Manner 1 to obtain the second index, and then the weight gradient parameter is determined according to the second index. Alternatively, the weight gradient parameter may be determined in to the following Manner 2.

In some embodiments, the weight gradient index may not be transmitted in the bitstream, but a weight gradient index gpm_blending_idx or blendingCoeff may be directly derived based on the size of the block or the like. At the decoding side, the weight gradient parameter may also be determined in the following Manner 2.

Manner 2, at the decoding side, multiple candidate weight gradient parameters are determined, where G is a positive integer; and the weight gradient parameter is determined from the multiple candidate weight gradient parameters.

In the Manner 2, the weight gradient parameter is determined at the decoding side itself to avoid that the second index is encoded in the bitstream at the encoding side, thereby saving codewords. In some implementation, at the decoding side, multiple candidate weight gradient parameters are first determined, and then a candidate weight gradient parameter is determined from the multiple candidate weight gradient parameters as the weight gradient parameter.

The exemplary manner in which multiple candidate weight gradient parameters are determined at the decoding side is not limited in the embodiments of the present application.

In a possible implementation, the above multiple candidate weight gradient parameters are preset, that is, for the decoding side and the encoding side, it is agreed to determine several preset weight gradient parameters as G candidate weight gradient parameters.

In another possible implementation, the multiple candidate weight gradient parameters may be indicated at the encoding side, for example, at the encoding side, several weight gradient parameters of the preset multiple weight gradient parameters are indicated to be used as multiple candidate weight gradient parameters.

In another possible implementation, multiple candidate weight gradient parameters may be determined based on the size of the current block.

In another possible implementation, picture information of the current block is determined; and multiple candidate weight gradient parameters are determined from multiple preset candidate weight gradient parameters based on the picture information of the current block.

At the decoding side, after multiple candidate weight gradient parameters are determined, a weight gradient parameter is determined from the multiple candidate weight gradient parameters.

The exemplary manner in which the weight gradient parameter is determined from the multiple candidate weight gradient parameters is not limited in the embodiments of the present application.

In some embodiments, any candidate weight gradient parameter of the multiple candidate weight gradient parameters is determined as the weight gradient parameter.

In some embodiments, a cost corresponding to each candidate weight gradient parameter of the multiple candidate weight gradient parameters is determined; and a weight gradient parameter is determined from the multiple candidate weight gradient parameters based on the costs. For example, a weight gradient parameter with the minimum cost is determined as the gradient parameter corresponding to the current block.

Manner 3: the weight gradient parameter is determined based on the size of the current block.

It may be seen from the above that there is a certain correlation between the weight gradient parameter and the size of the block. Therefore, the weight gradient parameter may also be determined based on the size of the current block in the embodiments of the present application.

In a possible implementation, a certain fixed weight gradient parameter is determined as the weight gradient parameter based on the size of the current block.

For example, in response to that the size of the current block is less than a first set threshold, the weight gradient parameter is determined to be a first value.

For another example, in response to that the size of the current block is greater than or equal to a first set threshold, the weight gradient parameter is determined to be a second value, the second value being less than the first value.

The values of the first value, the second value and the first set threshold are not limited in the embodiments of the present application

Exemplarily, the first value is 1 and the second value is ½.

Exemplarily, in response to that the size of the current block is indicated by a number of samples (or sampling points) of the current block, the first set threshold may be 256 or the like.

In another possible implementation, the value range of the weight gradient parameter is determined based on the size of the current block, and then the weight gradient parameter is determined to be a value within the value range.

For example, in response to that the size of the current block is less than the first set threshold, it is determined that the weight gradient parameter is within a value range of the weight gradient parameter. For example, the weight gradient parameter is any weight gradient parameter such as the minimum weight gradient parameter, the maximum weight gradient parameter, or the intermediate weight gradient parameter within the value range of the weight gradient parameter. For another example, the weight gradient parameter is the weight gradient parameter with the minimum cost within the value range of the weight gradient parameter. The method of determining the cost of the weight gradient parameter may refer to the description of other embodiments of the present application, which will not be repeated here.

For another example, in response to that the size of the current block is greater than or equal to the first set threshold, it is determined that the weight gradient parameter is within a second value range of the weight gradient parameter. For example, the weight gradient parameter is any weight gradient parameter such as the minimum weight gradient parameter, the maximum weight gradient parameter, or the intermediate weight gradient parameter within the second value range of the weight gradient parameter. For another example, the weight gradient parameter is the weight gradient parameter with the minimum cost within the second value range of the weight gradient parameter. The minimum value of the second value range of the weight gradient parameter is less than the minimum value of the value range of the weight gradient parameter, and the value range of the weight gradient parameter may or may not overlap with the second value range of the weight gradient parameter, which will not be repeated in the embodiments of the present application.

At the decoding side, after the weight gradient parameter is determined according to the above steps, the weight of the first point in the neighboring block is determined based on the i-th candidate weight derivation mode, the attribute information of the current block and the weight gradient parameter.

In an example, at the decoding side, the weight index weightIdx, such as the weight index weightIdx corresponding to the first point in the above neighboring block or the weight index weightIdx corresponding to the second point in the current block, is determined based on the i-th candidate weight derivation mode and the attribute information of the current block. Then, the weight index weightIdx is processed using the weight gradient parameters determined above to obtain the processed weight index weightIdx; and the weight wVemplateValue of the first point or the second point is determined according to the processed weight index weightIdx.

In an example, the weight wVemplateValue of the first point or the second point may be determined using the weight gradient parameters in the following manner:

$$weightIdx = ( ( ( xL = offsetX ) << 1 ) + 1 ) ⋆ disLut [ displacementX ] + ( ( ( yL + offsetY ) << 1 ) + 1 ) ⋆ disLut [ displacementY ]$$

$$weightIdxL = weightIdx ⋆ blendingCoeff$$

$$weightIdxL = partFlip ? 32 + weightIdx : 32 - weightIdx$$

$$wValue = ( Clip 3 ( 0 , 8 , ( weightIdxL + 4 ) >> 3 )$$

where blendingCoeff is the weight gradient parameter.

The exemplary process of determining the weight of the first point in the neighboring block based on the i-th candidate weight derivation mode and the attribute information of the current block is introduced in the step 21-A in the above embodiments. Then, the weight of the first point is determined as the weight of the neighboring block with respect to the j-th prediction mode.

In the above Manner 2, at the decoding side, after the weight of each neighboring block of the current block with respect to the j-th prediction mode is determined through the above step, the step 22 is performed; that is, based on the weights of the neighboring blocks with respect to the j-th prediction mode, a candidate prediction mode list of the j-th prediction mode is determined.

The implementation process of the above step 22 includes but is not limited to the following manners.

Manner 1, the step 22 includes the following steps:
Step 22-A1, in response to that the weights of the neighboring blocks with respect to the j-th prediction mode are greater than or equal to a preset threshold, obtaining prediction modes of the neighboring blocks; and
Step 22-A2, determining the candidate prediction mode list of the j-th prediction mode based on the prediction modes of the neighboring blocks.

In this Manner 1, at the decoding side, based on the above steps, the weight of each neighboring block of the current block with respect to the j-th prediction mode in the i-th candidate weight derivation mode is determined. Then, the weight corresponding to each neighboring block is compared with the preset threshold, if the weight corresponding to the neighboring block is greater than or equal to the preset threshold, it means that the neighboring block has a strong correlation with the j-th prediction mode. Then, the candidate prediction mode list of the j-th prediction mode may be determined based on the prediction mode of the neighboring block. For example, the prediction mode of the neighboring block may be added to the candidate prediction mode list of the j-th prediction mode. In some embodiments, in response to that a value of the weight is in a range from 0 to n, the preset threshold is n/2, where n is a positive number.

In some embodiments, in response to that the value of the weight is a first value or a second value, for example, the value of the weight is set to 0 or 1, the step 22 includes the following steps:
Step 22-B1, in response to that the weights of the neighboring blocks with respect to the j-th prediction mode are equal to the first value, obtaining the prediction modes of the neighboring blocks, the first value being greater than the second value; and
Step 22-B2, determining the candidate prediction mode list of the j-th prediction mode based on the prediction modes of the neighboring blocks.

In this embodiment, in a case where the weight of the neighboring block with respect to the j-th prediction mode is either the first value or the second value, if it is determined that the weight of the neighboring block with respect to the j-th prediction mode is equal to the first value, it means that the neighboring block has a strong correlation with the j-th prediction mode, and then the candidate prediction mode list of the j-th prediction mode may be determined based on the prediction mode of the neighboring block.

The values of the first value and the second value are not limited in the embodiments of the present application.

Optionally, the first value is 1.

Optionally, the second value is 0.

In some embodiments, in response to that the weight corresponding to the neighboring block is less than the preset threshold, or the weight corresponding to the neighboring block is equal to the second value, it means that there is a weak correlation between the neighboring block and the j-th prediction mode, and thus the candidate prediction mode list of the j-th prediction mode is not determined based on the prediction mode of the neighboring block. For example, obtaining the prediction mode of the neighboring block is skipped, thereby improving the accuracy of determining the candidate prediction mode list.

In the embodiments of the present application, there is no limitation on the number of neighboring blocks included in the current block and the positions of the neighboring blocks.

In some embodiments, if the length of the candidate prediction mode list of the j-th prediction mode is not limited, the weight of each neighboring block of the current block with respect to the j-th prediction mode may be compared with the preset threshold or the first value in a random manner to obtain the prediction modes of the neighboring blocks whose weights are greater than or equal to the preset threshold or equal to the first value.

In some embodiments, if the length of the candidate prediction mode list of the j-th prediction mode is limited, obtaining the prediction modes of the neighboring blocks in the step 22-A1 includes: according to a preset checking order, sequentially obtaining the prediction modes of the neighboring blocks whose weights with respect to the j-th prediction mode are greater than or equal to the preset threshold or equal to the first value of the neighboring blocks of the current block.

The preset checking order is not limited in the embodiments of the present application.

In some embodiments, if the neighboring blocks included in the current block are as shown in FIG. 18, in response to that the neighboring blocks of the current block include a left neighboring block L, a top neighboring block A, a bottom-left neighboring block BL, a top-right neighboring block AR and a top-left neighboring block AL, then the preset checking order is the left neighboring block, the top neighboring block, the bottom-left neighboring block, the top-right neighboring block and the top-left neighboring block, i.e., L→A→BL→AR→AL. That is, the weight of the left neighboring block of the current block with respect to the j-th prediction mode is first compared with the preset threshold or the first value. If the weight corresponding to the left neighboring block is greater than or equal to the preset threshold or equal to the first value, the prediction mode of the left neighboring block is obtained. If the weight corresponding to the left neighboring block is less than the preset threshold or equal to the second value, obtaining the prediction mode of the left neighboring block is skipped. Then, the weight of the top neighboring block of the current block with respect to the j-th prediction mode is compared with the preset threshold or the first value. If the weight corresponding to the top neighboring block is greater than or equal to the preset threshold or equal to the first value, the prediction mode of the top neighboring block is obtained. If the weight corresponding to the top neighboring block is less than the preset threshold or equal to the second value, obtaining the prediction mode of the top neighboring block is skipped. Then, the weight of the bottom-left neighboring block of the current block with respect to the j-th prediction mode is compared with the preset threshold or the first value. If the weight corresponding to the bottom-left neighboring block is greater than or equal to the preset threshold or equal to the first value, the prediction mode of the bottom-left neighboring block is obtained. If the weight corresponding to the bottom-left neighboring block is less than the preset threshold or equal to the second value, obtaining the prediction mode of the bottom-left neighboring block is skipped. Then, the weight of the top-right neighboring block of the current block with respect to the j-th prediction mode is compared with the preset threshold or the first value. If the weight corresponding to the top-right neighboring block is greater than or equal to the preset threshold or equal to the first value, the prediction mode of the top-right neighboring block is obtained; if the weight corresponding to the top-right neighboring block is less than the preset threshold or equal to the second value, obtaining the prediction mode of the top-right neighboring block is skipped. Finally, the weight of the top-left neighboring block of the current block with respect to the j-th prediction mode is compared with the preset threshold or the first value. If the weight corresponding to the top-left neighboring block is greater than or equal to the preset threshold or equal to the first value, the prediction mode of the top-left neighboring block is obtained; if the weight corresponding to the top-left neighboring block is less than the preset threshold or equal to the second value, obtaining the prediction mode of the top-left neighboring block is skipped. According to the above checking order, the above checking is performed on the neighboring blocks L→A→BL→AR→AL in sequence until the length of the candidate prediction mode list corresponding to the j-th prediction mode reaches an upper limit or all the above neighboring blocks are checked.

In some embodiments, at the decoding side, it does not limit the order in which the prediction modes of neighboring blocks are added into the candidate prediction mode list corresponding to the j-th prediction mode.

In some embodiments, at the decoding side, the obtained prediction modes of the neighboring blocks are sequentially added to the candidate prediction mode list of the j-th prediction mode according to the checking order. For example, at the decoding side, it is first determined that whether the weight of the neighboring block L with respect to the j-th prediction mode is less than or equal to the preset threshold, or is equal to the first value, in response to that the weight of the neighboring block L with respect to the j-th prediction mode is less than or equal to the preset threshold or is equal to the first value, the prediction mode of the neighboring block L is added to the candidate prediction mode list corresponding to the j-th prediction mode. Then, it is determined that whether the weight of the neighboring block A with respect to the j-th prediction mode is less than or equal to the preset threshold or is equal to the first value, in response to that the weight of the neighboring block A with respect to the j-th prediction mode is less than or equal to the preset threshold or is equal to the first value, the prediction mode of the neighboring block A is added to the candidate prediction mode list corresponding to the j-th prediction mode, and so on, until the length of the candidate prediction mode list corresponding to the j-th prediction mode reaches an upper limit or all the above neighboring blocks are checked.

In some embodiments, in a case where the candidate prediction mode list does not include duplicate candidate prediction modes, before the prediction mode of an neighboring block whose weight is greater than or equal to the preset threshold or equal is added to the first value to the candidate prediction mode list, it is first determined whether the candidate prediction mode list of the j-th prediction mode includes the prediction mode of the neighboring block, in response to that the prediction mode of the neighboring block is not included in the candidate prediction mode list of the j-th prediction mode, the prediction mode of the neighboring block is added to the candidate prediction mode list of the j-th prediction mode; in response to that the prediction mode of the neighboring block is already included in the candidate prediction mode list of the j-th prediction mode, adding the prediction mode of the neighboring block to the candidate prediction mode list of the j-th prediction mode is skipped.

In this Manner 1, the prediction modes of the neighboring blocks whose weights with respect to the j-th prediction mode are greater than or equal to the preset threshold or equal to the first value in all the neighboring blocks are added to the candidate prediction mode list of the j-th prediction mode, thereby improving the accuracy of determining the candidate prediction mode list.

In some embodiments, at the decoding side, it may also be determined that the candidate prediction mode list of the j-th prediction mode by the following Manner 2.

Manner 2: in response to that M neighboring blocks are included for the current block, where M is a positive integer, then the above step 22 includes the following step 22-C1:
Step 22-C1, determining the candidate prediction mode list of the j-th prediction mode, based on the weights of the M neighboring blocks with respect to the j-th prediction mode and the prediction modes of the M neighboring blocks.

For example, several neighboring blocks whose weights are within a preset range are selected from the M neighboring blocks based on the weights of the M neighboring blocks with respect to the j-th prediction mode, and the prediction modes of these neighboring blocks are added to the candidate prediction mode list of the j-th prediction mode.

For another example, based on the weights of the M neighboring blocks with respect to the j-th prediction mode, the prediction modes of the M neighboring blocks are added to the candidate prediction mode list, until the length of the candidate prediction mode list reaches a preset length. For example, the neighboring block with a larger weight has a great probability of being added to the candidate prediction mode list, but the neighboring block with a smaller weight also has a chance to be added to the candidate prediction mode list, but the probability is small.

The number and positions of the M neighboring blocks are not limited in the embodiments of the present application.

In some embodiments, the M neighboring blocks include at least one of a left neighboring block, a top neighboring block, a bottom-left neighboring block, a top-right neighboring block, or a top-left neighboring block of the current block.

From the above, it may be seen that in a case of determining the candidate prediction mode list of the j-th prediction mode in the i-th candidate weight derivation mode, the candidate prediction mode list of the j-th prediction mode is determined based on the i-th candidate weight derivation mode and the attribute information of the current block in the above steps. For example, by determining the weights of the neighboring blocks of the current block with respect to the j-th prediction mode, and based on the weights, it is determined that whether to add the prediction modes of the neighboring blocks to the candidate prediction mode list of the j-th prediction mode.

Based on this, in the embodiments of the present application, at the decoding side, before determining the candidate prediction mode list of the j-th prediction mode based on the i-th candidate weight derivation mode and the attribute information of the current block, it is first necessary to determine whether the candidate prediction mode list of the j-th prediction mode includes the prediction modes of the neighboring blocks, if it is determined that the candidate prediction mode list of the j-th prediction mode includes the prediction modes of the neighboring blocks, the candidate prediction mode list of the j-th prediction mode is determined based on the i-th candidate weight derivation mode and the attribute information of the current block.

The exemplary manner in which it is determined whether the candidate prediction mode list of the j-th prediction mode includes the prediction modes of the neighboring blocks at the decoding side is not limited in the embodiments of the present application.

In a first example, at the encoding side and the decoding side, it is assumed that the prediction modes of the neighboring blocks are included in the candidate prediction mode list corresponding to the current block. Based on this, at the decoding side, it may be determined that the candidate prediction mode list of the j-th prediction mode includes the prediction modes of the neighboring blocks. Alternatively, at the encoding side and the decoding side, it is assumed that the candidate prediction mode list corresponding to the current block does not includes the prediction modes of the neighboring blocks. Based on this, at the decoding side, it may be determined that the prediction modes of the neighboring blocks are not included in the candidate prediction mode list of the j-th prediction mode.

In a second example, at the decoding side, a bitstream is decoded to obtain first information, the first information being used for indicating whether the candidate prediction mode list includes prediction modes of neighboring blocks; whether the candidate prediction mode list of the j-th prediction mode includes the prediction modes of the neighboring blocks is determined based on the first information.

Optionally, the first information may be frame-level information, i.e., indicating whether the candidate prediction mode list corresponding to the current frame includes the prediction mode of the neighboring blocks.

Optionally, the first information may be block-level information, i.e., indicating whether the candidate prediction mode list corresponding to the current block includes the prediction mode of the neighboring blocks.

Optionally, the first information may also be indication information of other levels, which is not limited in the embodiments of the present application, as long as at the decoding side, whether the candidate prediction mode list of the j-th prediction mode corresponding to the current block includes the prediction mode of the neighboring blocks is determined via the first information.

In a third example, at the decoding side, after adding the prediction modes located before, in the preset order, the prediction modes of the neighboring blocks to the candidate prediction mode list in a preset order, in a case where the length of the candidate prediction mode list does not reach the preset length, at the decoding side, it is determined that the candidate prediction mode list of the j-th prediction mode includes the prediction modes of the neighboring blocks.

In this example, the candidate prediction mode list of the j-th prediction mode also includes other prediction modes. In a case of determining the candidate prediction mode list of the j-th prediction mode, at the decoding side, prediction modes are first added to the candidate prediction mode list of the j-th prediction mode in sequence in a preset order, and it is determined that whether the length of the candidate prediction mode list reaches the preset length after adding the prediction modes located before the prediction modes of the neighboring blocks in the preset order to the candidate prediction mode list. If the length of the candidate prediction mode list does not reach the preset length after the prediction modes located before the prediction modes of the neighboring blocks in the preset order are added to the candidate prediction mode list, it is determined that the candidate prediction mode list of the j-th prediction mode includes the prediction modes of the neighboring blocks. If the length of the candidate prediction mode list reaches the preset length after the prediction modes located before the prediction mode of the neighboring blocks in the preset order are added to the candidate prediction mode list, it is determined that the candidate prediction mode list of the j-th prediction mode does not include the prediction modes of the neighboring blocks.

In some embodiments, at the decoding side, in a preset order, a prediction mode whose prediction angle is parallel to the partition line of the i-th candidate weight derivation mode, a candidate prediction mode derived based on a template of the current block, a candidate prediction mode derived based on reconstructed samples neighboring to the current block, a prediction mode of a neighboring block, a prediction mode whose prediction angle is perpendicular to the partition line of the i-th candidate weight derivation mode, and a preset mode are added to the candidate prediction mode list of the j-th prediction mode until the length of the list reaches a preset length.

The preset order is not limited in the embodiments of the present application.

In an example, the preset order includes: a prediction mode whose prediction angle is parallel to the partition line of the i-th candidate weight derivation mode, a candidate prediction mode derived based on a template of the current block, a candidate prediction mode derived based on reconstructed samples neighboring to the current block, a prediction mode of a neighboring block, a prediction mode whose prediction angle is perpendicular to the partition line of the i-th candidate weight derivation mode, and a preset mode.

In some embodiments, the candidate prediction mode derived based on the template of the current block may be understood as a prediction mode derived through TIMD.

In some embodiments, the candidate prediction mode derived based on reconstructed samples neighboring to the current block may be understood as a prediction mode derived through DIMD.

In some embodiments, the preset mode includes a PLANAR mode.

In an example, in a case of constructing a candidate prediction mode list of the j-th prediction mode, the following types of prediction modes are added to the candidate prediction mode list until the list length reaches a preset length (e.g., 3):
1. A prediction mode whose prediction angle is parallel to the partition line of the i-th candidate weight derivation mode;
2. Prediction model derived through TIMD;
3. Prediction model derived through DIMD;
4. Prediction modes of neighboring blocks of the current block;
5. A prediction mode whose prediction angle is perpendicular to the partition line of the i-th candidate weight derivation mode; and
6. PLANAR mode.

The exemplary process of determining the candidate prediction mode list at the decoding side is introduced in the above embodiments.

At the decoding side, after the candidate prediction mode list is determined according to the above steps, the following step S103 will be performed.

S103, a first weight derivation mode and K first prediction modes corresponding to the current block are determined based on the N candidate weight derivation modes and the at least one candidate prediction mode.

At the decoding side, the N candidate weight derivation modes are determined based on the step S101, at least one candidate prediction mode is determined based on the step S102, and then one candidate weight derivation mode is selected from the N candidate weight derivation modes as the first weight derivation mode corresponding to the current block, and at least one first prediction mode of K first prediction modes is determined from at least one candidate prediction mode included in the at least one candidate prediction mode. Finally, the current block is predicted using the determined first weight derivation mode and the K first prediction modes to obtain a prediction value of the current block.

It will be noted that the above first weight derivation mode and the K first prediction modes are used together to determine the prediction value of the current block. In some embodiments, the above first weight derivation mode is also referred to as the weight derivation mode of the current block or the weight derivation mode corresponding to the current block. In some embodiments, the K first prediction modes are also referred to as K prediction modes of the current block or K prediction modes corresponding to the current block. In an example, in response to that K=2, the K first prediction modes include a first one prediction mode and a second one prediction mode corresponding to the current block. In some embodiments, the first one prediction mode is referred to as the first prediction mode, and the second one prediction mode is referred to as the second prediction mode.

The exemplary manner in which the first weight derivation mode and K first prediction modes are determined at the decoding side based on the N candidate weight derivation modes and the at least one candidate prediction mode is not limited in the embodiments of the present application.

In some embodiments, in intra and inter prediction of the GPM, as shown in FIG. 17A, N=1, i.e., the N candidate weight derivation modes are the first weight derivation mode, assuming that the first prediction mode is the inter prediction mode and the second prediction mode is the intra prediction mode. As shown in S102 above, at the decoding side, a candidate prediction mode list of the second prediction mode is determined based on the first weight derivation mode and the attribute information of the current block, and then a candidate prediction mode is selected from the candidate prediction mode list of the second prediction mode as the second prediction mode. For example, the candidate prediction mode with the smallest cost in the candidate prediction mode list is determined as the second prediction mode. Then, the current block is predicted based on the first weight derivation mode, the first prediction mode and the second prediction mode to obtain a prediction value of the current block.

In some embodiments, the at least one candidate prediction mode is a candidate prediction mode list corresponding to the K first prediction modes; that is, the K first prediction modes are all selected from the candidate prediction mode list. In this case, at the decoding side, the N candidate weight derivation modes and the candidate prediction modes included in the candidate prediction mode list are combined. For example, each candidate weight derivation mode of the N candidate weight derivation modes is combined with any K candidate prediction modes in the candidate prediction mode list to obtain multiple combinations, each of which includes one candidate weight derivation mode and K candidate prediction modes. Then, the template of the current block is predicted using the candidate weight derivation modes and K candidate prediction modes included in each combination to determine the cost of each combination, and then, a combination is determined from the multiple combinations based on the costs; for example, a combination with the smallest cost is selected from the multiple combinations, the candidate weight derivation mode included in the combination with the smallest cost is determined as the first weight derivation mode, and the K prediction modes included in the combination with the smallest cost are determined as the K first prediction modes.

In some embodiments, at least one candidate prediction mode is a candidate prediction mode list of a certain first prediction mode among the K first prediction modes, for example, K=2, the above candidate prediction mode is a candidate prediction mode list of the first prediction mode. In this case, at the decoding side, the optional prediction mode set corresponding to the second prediction mode is determined. Then, at the decoding side, for each candidate weight derivation mode of the N candidate weight derivation modes, a candidate prediction mode is selected from the candidate prediction mode list of the first prediction mode as a possibility of the first prediction mode, and a prediction mode is selected from the optional prediction mode set corresponding to the second prediction mode as a possibility of the second prediction mode, so as to obtain a combination composed of the candidate weight derivation mode, the possibility of the first prediction mode and the possibility of the second prediction mode. Thus, multiple combinations may be obtained, and each combination includes one candidate weight derivation mode and two candidate prediction modes. Then, the template of the current block is predicted using the candidate weight derivation mode and two candidate prediction modes included in each combination to determine the cost of each combination, and then based on the cost, a combination is determined from the multiple combinations; for example, a combination with the smallest cost is selected from the multiple combinations, the candidate weight derivation mode included in the combination with the smallest cost is determined as the first weight derivation mode, and the K prediction modes included in the combination with the smallest cost are determined as the K first prediction modes.

In some embodiments, the at least one candidate prediction mode includes a candidate prediction mode list corresponding to each first prediction mode of the K first prediction modes; that is, at the decoding side, K candidate prediction modes are determined based on the step S102. For example, assuming that K=2, at the decoding side, a candidate prediction mode list of the first prediction mode and a candidate prediction mode list of the second prediction mode are determined. In this way, at the decoding side, a candidate weight derivation mode is selected from N candidate weight derivation modes, a candidate prediction mode is selected from the candidate prediction mode list of the first prediction mode, and a candidate prediction mode is selected from the candidate prediction mode list of the second prediction mode. In this case, the selected candidate weight derivation mode and 2 candidate prediction modes constitute a combination. Referring to the above method, multiple combinations may be obtained. Each combination includes one candidate weight derivation mode and two candidate prediction modes. Then, the template of the current block is predicted using the candidate weight derivation mode and two candidate prediction modes included in each combination to determine the cost of each combination, and then based on the costs, a combination is determined from the multiple combinations; for example, a combination with the smallest cost is selected from the multiple combinations, the candidate weight derivation mode included in the combination with the smallest cost is determined as the first weight derivation mode, and K prediction modes included in the combination with the smallest cost are determined as the K first prediction modes.

Based on the above description, one weight derivation mode and K prediction modes may act together on the current block as a combination. In order to save codewords and reduce encoding costs, in some embodiments, the weight derivation mode and K prediction modes corresponding to the current block are used as a combination, i.e., a first combination. A first index is used to indicate the first combination. Compared with indicating the weight derivation mode and K prediction modes separately, fewer codewords are used in the embodiments of the present application, thereby reducing the encoding cost.

Based on this, the S103 includes the following steps S103-A to S103-C:
S103-A, decoding a bitstream to obtain a first index, where the first index is used to indicate a first combination, the first combination including the first weight derivation mode and the K first prediction modes;
S103-B, determining a candidate combination list based on the N candidate weight derivation modes and the at least one candidate prediction mode, where the candidate combination list include at least one candidate combination, the candidate combination including one weight derivation mode and K prediction modes; and
S103-C, determining the first combination from the candidate combination list based on the first index.

The form of syntax element of the first index is not limited in the embodiments of the present application.

In a possible implementation, in response to that the current block is predicted using the GPM technology, gpm_cand_idx is used to indicate the first index.

Since the first index is used to indicate the first combination, in some embodiments, the first index may also be referred to as a first combination index or an index of the first combination.

In an example, the syntax after adding the first index in the bitstream is shown in Table 11.

TABLE 11

| | |
|---|---|
| if (conditions for deriving for using GPM for current block){ | |
| gpm_cand_idx[ x0 ][ y0 ] | ae(v) |
| } | |
| } | |

Here, gpm_cand_idx is the first index.

Exemplarily, the candidate combination list is shown in Table 12.

TABLE 12

| Index | Candidate combination |
|---|---|
| 0 | Candidate combination 1 (including one weight derivation mode |
| | and K prediction modes) |
| 1 | Candidate combination 2 (including one weight derivation mode |
| | and K prediction modes) |
| . . . | . . . |
| i-1 | Candidate combination i (including one weight derivation mode |
| | and K prediction modes) |
| . . . | . . . |

As shown in Table 12, the candidate combination list includes multiple candidate combinations, and any two candidate combinations of the multiple candidate combinations are not completely the same; that is, for the weight derivation modes and at least one of the K prediction modes included in any two candidate combinations, there is a difference in at least one mode. For example, there is a difference in the weight derivation mode in candidate combination 1 and candidate combination 2; alternatively, the weight derivation modes in candidate combination 1 and candidate combination 2 are the same, and there is a difference in at least one of the K prediction modes in candidate combination 1 and candidate combination 2; alternatively, there is a difference in the weight derivation mode in candidate combination 1 and candidate combination 2, and there is a difference in at least one of the K prediction modes in candidate combination 1 and candidate combination 2.

Exemplarily, in the above Table 12, the ranking of the candidate combinations in the candidate combination list is used as the index. Optionally, the index of the candidate combinations in the candidate combination list may also be reflected in other ways, which is not limited in the embodiments of the present application.

In this embodiment, at the decoding side, the bitstream is decoded to obtain the first index, and the candidate combination list as shown in Table 12 above is determined, and a look-up is performed in candidate combination list according to the first index to obtain the first weight derivation mode and K prediction modes included in the first combination indicated by the first index.

For example, the first index is Index 1. In the candidate combination list shown in Table 12, the candidate combination corresponding to Index 1 is Vandidate combination 2. That is, the first combination indicated by the first index is Candidate combination 2. In this way, at the decoding side, the weight derivation mode and K prediction modes included in the candidate combination 2 are determined as the first weight derivation mode and K first prediction modes included in the first combination, and the current block is predicted using the first weight derivation mode and K first prediction modes to obtain the prediction value of the current block.

In this Manner 2, the same candidate combination list may be determined at the encoding side and the decoding side. For example, a list including X candidate combinations is determined at both the encoding side and the decoding side, each candidate combination including one weight derivation mode and K prediction modes. In the bitstream, at the encoding side, only a candidate combination that is finally selected, such as the first combination, is needed to be encoded. At the decoding side, the first combination finally selected at the decoding side is parsed. In some implementation, the bitstream is decoded at the decoding side to obtain the first index, and the first combination is determined from the candidate combination list determined via the first index at the decoding side.

The exemplary process of determining the candidate combination list based on the N candidate weight derivation modes and the at least one candidate prediction mode in the above S103-B will be introduced below.

The specific manner of determining the candidate combination list based on the N candidate weight derivation modes and the at least one candidate prediction mode in the S103-B is not limited in the embodiments of the present application.

In some embodiments, the N candidate weight derivation modes are arbitrarily combined with multiple candidate prediction modes included in the at least one candidate prediction mode, and each combination includes one weight derivation mode and two prediction modes. In this way, multiple combinations may be obtained, and the information related to the current block may be used to analyze the probability of different combinations occurring, and a candidate combination list may be constructed according to the probability of each combination occurring. Optionally, the information related to the current block includes pattern information of neighboring blocks of the current block, reconstructed samples of the current block, etc.

In some embodiments, the S103-B includes the following steps S103-B1 and S103-B2:
S103-B1, obtaining T second combinations based on the N candidate weight derivation modes and the at least one candidate prediction mode; and
S103-B2, obtaining the candidate combination list based on the T second combinations.

Here, any second combination of the T second combinations includes one weight derivation mode and K prediction modes, and the weight derivation mode and the K prediction modes included in any two combinations of the T second combinations are not exactly the same, T being a positive integer greater than 1.

In these embodiments, at the decoding side, T second combinations are determined based on the N candidate weight derivation modes and the at least one candidate prediction mode. The value of the T second combinations is not limited in the present application, such as 8, 16, 32. Each second combination of the T second combinations includes one weight derivation mode and K prediction modes, and the weight derivation mode and K prediction modes included in any two of the T second combinations are not exactly the same.

The exemplary manner of obtaining the T second combinations based on the N candidate weight derivation modes and the at least one candidate prediction mode in the S103-B1 is not limited in the embodiments of the present application.

In some embodiments, the at least one candidate prediction mode is a candidate prediction mode list corresponding to the K first prediction modes; that is, the K first prediction modes are all selected from the candidate prediction mode list. In this case, at the decoding side, the N candidate weight derivation modes are combined with the candidate prediction modes included in the candidate prediction mode list. For example, each candidate weight derivation mode of the N candidate weight derivation modes is combined with any K candidate prediction modes in the candidate prediction mode list to obtain T second combinations, each of which includes a candidate weight derivation mode and K candidate prediction modes.

In some embodiments, the at least one candidate prediction mode is a candidate prediction mode list of a certain first prediction mode among K first prediction modes, for example, in a case where K=2, the above candidate prediction mode is a candidate prediction mode list of the first prediction mode. In this case, at the decoding side, the optional prediction mode set corresponding to the second prediction mode is determined. Then, at the decoding side, for each candidate weight derivation mode of the N candidate weight derivation modes, a candidate prediction mode is selected from the candidate prediction mode list of the first prediction mode as a possibility of the first prediction mode, and a prediction mode is selected from the optional prediction mode set corresponding to the second prediction mode as a possibility of the second prediction mode, and a second combination composed of the candidate weight derivation mode, the possibility of the first prediction mode and the possibility of the second prediction mode is obtained. Thus, T second combinations may be obtained, and each second combination includes one candidate weight derivation mode and 2 candidate prediction modes.

In some embodiments, the at least one candidate prediction mode includes a candidate prediction mode list corresponding to each first prediction mode of the K first prediction modes, i.e., at the decoding side, K candidate prediction modes are determined based on the step S102. For example, assuming that K=2, at the decoding side, a candidate prediction mode list of the first prediction mode and a candidate prediction mode list of the second prediction mode are determined. In this way, at the decoding side, a candidate weight derivation mode is selected from N candidate weight derivation modes, a candidate prediction mode is selected from the candidate prediction mode list of the first prediction mode, and a candidate prediction mode is selected from the candidate prediction mode list of the second prediction mode. In this case, the selected candidate weight derivation mode and 2 candidate prediction modes constitute a second combination. By referring to the above method, T second combinations may be obtained, each second combination includes one candidate weight derivation mode and 2 candidate prediction modes.

The implementations of obtaining the candidate combination list based on the T second combinations in the S103-B2 include but are not limited to the following implementations.
Implementation 1: the T second combinations are sorted according to a preset rule to obtain the candidate combination list.
Implementation 2, the S103-B2 includes the following steps:
S103-B21, for any second combination of the T second combinations, determining a cost corresponding to the second combination in a case where the template of the current block is predicted based on the weight derivation mode and the K prediction modes in the second combination; and
S103-B22, determining the candidate combination list according to the cost corresponding to each second combination in the T second combinations.

In the Implementation 2, for each of the T second combinations, the template of the current block is predicted by using the weight derivation mode and the K prediction modes included in the second combination, so as to obtain a prediction value of the template corresponding to the second combination.

In some implementation, for each of the T second combinations, the template of the current block is predicted using the K prediction modes in the second combination to obtain K prediction values.

Then, the weight of the template corresponding to the second combination is determined based on the weight derivation mode in the second combination.

In some embodiments, determining the weight of the template according to the weight derivation mode includes the following steps: determining an angle index, a distance index and a blending parameter according to the weight derivation mode; and determining the weight of the template according to the angle index, the distance index, the blending parameter and the size of template.

The weight of the template may be derived in the same manner as deriving prediction value weight in the present application. For example, firstly, the angle index and the distance index are determined according to the weight derivation mode.

The manners of determining the weight of the template according to the angle index, the distance index and the size of the template include but are not limited to the following manners.
Manner 1: the first parameter of the sample in the template is determined according to the angle index, distance index and the size of the template. In some embodiments, the first parameter is also referred to as the weight index weightIdx; the weight of the sample in the template is determined according to the first parameter of the sample in the template; the template weight is determined according to the weight of the sample in the template. The exemplary process may refer to the process of determining the template weight in the S102, which will not be repeated here.
Manner 2: the weights of the current block and the template are determined according to the weight derivation mode. That is, in the Manner 2, the merged area composed of the current block and the template is taken as a whole, and the weights of the samples in the merged area are derived according to the weight derivation mode.

Exemplarily, at the decoding side, the weights of the samples in the merged area composed of the current block and the template are determined according to the angle index, the distance index, the size of the template and the size of the current block; and the template weight is determined according to the size of the template and the weights of the samples in the merged area, the exemplary process of which may refer to the process of determining the template weight in the S102, which will not be repeated here.

The above method is used to determine the weight of the template and the K template prediction values corresponding to a certain second combination, and the K template prediction values are weighted using the weight of the template to obtain the template prediction value under the second combination.

Since the template of the current block is a reconstructed area, a reconstructed value of the template may be obtained at the decoding side. In this way, for each of the T second combinations, the cost corresponding to the second combination may be determined according to the prediction value of the template and the reconstructed value of the template under the second combination. The manner of determining the cost corresponding to the second combination includes but is not limited to SAD, SATD, SEE or the like. Then, a candidate combination list is constructed according to the cost corresponding to each second combination in the T second combinations.

In the embodiments of the present application, the manner of determining the template prediction value corresponding to the second combination includes at least the following manners.

The first manner is that the template prediction value corresponding to the second combination is a value, that is, at the decoding side, the K prediction modes included in the second combination are used to predict the template to obtain K prediction values, the weight of the template is determined according to the weight derivation mode included in the second combination, the K prediction values are weighted through the template weight to obtain the weighted prediction value, and the weighted prediction value is determined as the template prediction value corresponding to the second combination.

The second manner is that in some embodiments, some hierarchical selection ideas may also be used. For example, if a relatively small cost may be obtained in a weight derivation mode, a weight derivation pattern similar thereto is continued to be tried. Conversely, if a relatively small cost cannot be obtained in a weight derivation mode, a weight derivation mode similar thereto is not continued to be tried. For example, if a relatively small cost may be obtained in an intra prediction mode, an intra mode similar thereto is continued to be tried. Conversely, if a relatively small cost cannot be obtained in an intra prediction mode, an intra prediction mode similar thereto is not continued to be tried. Certainly, these selection methods may also be limited to the case where they are used in combination with other two elements. For example, if a relatively small cost cannot be obtained when a certain intra prediction mode is used as the first prediction mode in a certain weight derivation mode, then intra prediction modes similar to the intra prediction mode in the weight derivation mode will no longer be tried as the first prediction mode.

The third manner is that the cost corresponding to each second combination is determined using a fast cost calculation method. It may be seen from the above that the template prediction value corresponding to the second combination includes the template prediction values corresponding to the K prediction modes included in the second combination. In this case, the costs corresponding to the K prediction modes in the second combination may be determined according to the template prediction values and template reconstructed values corresponding to the K prediction modes in the second combination; the cost corresponding to the second combination may be determined according to the costs corresponding to the K prediction modes in the second combination. For example, a sum of the costs corresponding to the K prediction modes in the second combination is determined as the cost corresponding to the second combination.

In the embodiments of the present application, K=2 is taken as an example, the weight of the template may be simplified to be only two possibilities, 0 and 1. Then, for each sample position, its sample value only comes from the prediction block of the first prediction mode or the prediction block of the second prediction mode. Therefore, for a prediction mode, the cost of the prediction mode on the template in a case where the prediction mode is used as the first prediction mode of a certain weighted derivation mode may be calculated; that is, in a case where the prediction mode is used as the first prediction mode in the weighted derivation mode, only the cost generated on the template of some samples with a weight of 1 is calculated. In an example, the cost is denoted as cost [pred_mode_idx] [gpm_idx] [0], where pred_mode_idx represents the index of the prediction mode, gpm_idx represents the index of the weight derivation mode, and 0 represents that the prediction mode is used as the first prediction mode.

Moreover, in a case where the prediction mode is used as the second prediction mode of a certain weighted derivation mode, the cost of the prediction mode of the template is calculated; that is, in a case where the prediction mode is used as the second prediction mode under the weighted derivation mode, only the cost generated on the template by some samples with a weight of 1 calculated. as is In an example, the cost is denoted cost [pred_mode_idx] [gpm_idx] [1], where pred_mode_idx represents the index of the prediction mode, gpm_idx represents the index of the weight derivation mode, and 1 represents the prediction mode is used as the second prediction mode.

Then, in a case of calculating the cost of a combination, the corresponding two costs mentioned above may be directly added. For example, a cost of prediction modes pred_mode_idx0 and pred_mode_idx1 in the weighted derivation mode gpm_idx is required to be calculated, where pred_mode_idx0 is used as the first prediction mode and pred_mode_idx1 is used as the second prediction mode. The cost is denoted as costTemp, then costTemp=cost [pred_mode_idx0][gpm_idx][0]+cost [pred_mode_idx1][gpm_idx][1]. If a cost of prediction modes pred_mode_idx0 and pred_mode_idx1 in the weighted derived mode gpm_idx is required to be calculated, where pred_mode_idx1 is used as the first prediction mode and pred_mode_idx0 is used as the second prediction mode. The cost is denoted as costTemp, then costTemp=cost [pred_mode_idx1] [gpm_idx] [0]+cost [pred_mode_idx0] [gpm_idx] [1].

In this way, one advantage is that the prediction blocks are first weighted and combined into a prediction block and then the cost is calculated, which is simplified to directly calculating the cost of the two parts, and then adding the costs to get the cost of the combination. Since a prediction mode may be combined with multiple other prediction modes, and for the same weight derivation mode, the costs of the parts of which the prediction mode is used as the first prediction mode and the second prediction mode are fixed, these costs, i.e., cost [pred_mode_idx] [gpm_idx] [0] and cost [pred_mode_idx] [gpm_idx] [1] in the above examples, may be retained and reused to reduce the amount of calculation.

According to the above method, the cost corresponding to each second combination in the T second combinations may be determined, and then a candidate combination list is constructed according to the cost corresponding to each second combination in the T second combinations.

In the embodiments of the present application, the method of determining the candidate combination list according to the cost corresponding to each second combination in the T second combinations in S103-B22 includes but is not limited to the following examples.

Example 1: the T second combinations are sorted according to costs corresponding to all the second combinations in the T second combinations; and the sorted T second combinations are determined as a candidate combination list.

The candidate combination list generated in the Example 1 includes T first candidate combinations.

Optionally, the T first candidate combinations in the candidate combination list are sorted according to the magnitude of the cost from small to large; that is, the cost corresponding to the T first candidate combinations in the candidate combination list increases in order.

The T second combinations being sorted according to the cost corresponding to each second combination in the T second combinations may be that the T second combinations are sorted in an order of the cost from small to large.

Example 2: C second combinations are selected from the T second combinations according to the costs corresponding to the second combinations, and the list composed of the C second combinations is determined as a candidate combination list.

Optionally, the C second combinations are the first C second combinations with the smallest costs of the T second combinations. For example, according to the cost corresponding to each second combination in the T second combinations, C second combinations with the smallest costs are selected from the T second combinations to constitute a candidate combination list. In this case, the candidate combination list includes C candidate combinations.

Optionally, the C candidate combinations in the candidate combination list are sorted according to the magnitude of the cost from small to large, that is, the costs corresponding to the C candidate combinations in the candidate combination list increase in order.

Based on the above steps, at the decoding side, for a candidate combination list, a first combination corresponding to the first index is selected from the candidate combination list, and a weight derivation mode included in the first combination is determined as the first weight derivation mode, and the K prediction modes included in the first combination is determined as K first prediction modes.

Based on the above steps, at the decoding side, the first weight derivation mode and the K first prediction modes are determined, and then the following step S104 is performed.

S104, the current block is predicted based on the first weight derivation mode and the K first prediction modes to obtain a prediction value of the current block.

In the embodiments of the present application, when the current block is decoded at the decoding side, N candidate weight derivation modes are determined, and then at least one candidate prediction mode is determined based on the N candidate weight derivation modes and the attribute information of the current block, and then a first weight derivation mode and K first prediction modes corresponding to the current block are determined based on the N candidate weight derivation modes and the at least one candidate prediction mode, and then, the current block are predicted based on the first weight derivation mode and the K first prediction modes to obtain a prediction value of the current block. That is, in the embodiments of the present application, the weight derivation mode and the attribute information of the current block are taken into account when determining the candidate prediction mode list, thereby improving the accuracy of determining the candidate prediction mode list. When the current block is predicted based on the accurately determined candidate prediction mode list, the prediction accuracy of the current block may be improved, thereby improving the decoding performance.

The exemplary process of predicting the current block based on the first weight derivation mode and the K first prediction modes to obtain the prediction value of the current block in the S104 is not limited in the embodiments of the present application.

In case 1, when a weight of the prediction value is determined without considering the weight gradient parameter (also referred to as a blending parameter), the prediction value weight of the current block is determined based on the first weight derivation mode, and the current block is predicted based on the K first prediction modes to obtain K prediction values of the current block; then, the K prediction values of the current block are weighted based on the prediction value weight of the current block to obtain the prediction value of the current block. The process of deriving the prediction value weight of the current block based on the first weight derivation mode may refer to the process of deriving the prediction value weight of the current block in the above embodiments, which will not be repeated here.

In case 2, when the prediction value weight is determined, the weight gradient parameter is considered. In this case, the S104 includes the following steps:
S104-A1, determining a weight gradient parameter; and
S104-A2, predicting the current block based on the weight gradient parameter, the first weight derivation mode and the K first prediction modes to obtain the prediction value of the current block.

Here, the process of determining the weight gradient parameter in S104-A1 is basically the same as the process of determining the weight gradient parameter in the above S102, and may be refer to the description of the S102, which will not be repeated here.

The exemplary implementation process of the S104-A2 is not limited in the embodiments of the present application. For example, the current block is predicted based on the first weight derivation mode and the K first prediction modes to obtain a prediction value, and then the prediction value of the current block is determined based on the weight gradient parameter and the prediction value.

In some embodiments, the S104-A2 includes the following steps:
S104-A21, determining a weight of the prediction value based on the weight gradient parameter and the first weight derivation mode;
S104-A22, predicting the current block based on the K first prediction modes to obtain K prediction values; and
S104-A23, weighting the K prediction values based on the weight of the prediction value to obtain the prediction value of the current block.

There is no order of performance between S104-A22 and S104-A21, that is, S104-A22 may be performed before S104-A21, or after S104-A21, or in parallel with S104-A21.

In the case 2, at the decoding side, the weight gradient parameter is determined, and the weight of the prediction value is determined based on the weight gradient parameter and the first weight derivation mode. Then, the current block is predicted based on the K first prediction modes to obtain K prediction values of the current block. Then, the K prediction values of the current block are weighted using the weight of the prediction value to obtain the prediction value of the current block.

In the embodiment of the present application, the method of determining the weight of the prediction value based on the weight gradient parameter and the first weight derivation mode includes at least the following methods as shown in the examples.
Example 1: in a case where the weight of the prediction value is derived using the first weight derivation mode, multiple intermediate variables need to be determined. The weight gradient parameter may be used to adjust one or several of the multiple intermediate variables, and then the adjusted variables are used to derive the weight of the prediction value.
Example 2, the weight index weightIdx corresponding to the current block is determined based on the first weight derivation mode and the current block; the weight gradient parameter is used to process the weight index weightIdx to obtain the processed weight index weightIdx; the weight wVemplateValue of the prediction value is determined based on the processed weightIdx.

In an example, the weight wVemplate Value of the prediction value may be determined based on the weight gradient parameter in the following manner:

$$weightIdx = ( ( ( xL = offsetX ) << 1 ) + 1 ) ⋆ disLut [ displacementX ] + ( ( ( yL + offsetY ) << 1 ) + 1 ) ⋆ disLut [ displacementY ]$$

$$weightIdx = weightIdx ⋆ blendingCoeff$$

$$weightIdxL = partFlip ? 32 + weightIdx : 32 - weightIdx$$

$$wValue = ( Clip 3 ( 0 , 8 , ( weightIdxL + 4 ) >> 3 )$$

where blendingCoeff is the weight gradient parameter.

Then, the current block is predicted based on the K first prediction modes to obtain K prediction values; the K prediction values are weighted according to the weight of the prediction value to obtain the prediction value of the current block.

From the above embodiments, it may be understood that obtaining the weight of the template and the weight of the prediction value are two independent processes that do not interfere with each other. The weight of the prediction value may be individually determined through the above method.

In some embodiments, when the weight of the template is determined as described above, the weight of the template is determined by determining the weight of a merged area formed by combining the template area and the current block. Since the merged area includes the current block, the weight corresponding to the current block in the weight of the merged area is determined as the weight of the prediction value. It will be noted that when the weight of the merged area is determined, the influence of the weight gradient parameter on the weight is also taken into account, with reference to the description of the above embodiments, which will not be repeated here.

In some embodiments, the above prediction process is performed in units of samples, and the corresponding weights of the above prediction values are also the weights corresponding to the samples. In this case, when the current block is predicted, each prediction mode of the K first prediction modes is used to predict a certain sample A in the current block, and K prediction values of the K first prediction modes with respect to the sample A are obtained. The weight of the prediction value of the sample A is determined according to the first weight derivation mode and the weight gradient parameter. Then, the K prediction values are weighted based on the weight of the prediction value of sample A to obtain the prediction value of the sample A. By performing the above steps on each sample in the current block, a prediction value of each sample in the current block may be obtained, and the prediction value of each sample in the current block is used to obtain the prediction value of the current block. Considering K=2 as an example, the first prediction mode is used to predict a sample A in the current block to obtain the first prediction value of the sample A, and the second prediction mode is used to predict the sample A to obtain the second prediction value of the sample A; based on the prediction value weight corresponding to the sample A, the first prediction value and the second prediction value are weighted to obtain the prediction value of the sample A.

In an example, considering K=2 as an example, in response to that the first prediction mode and the second prediction mode are both intra prediction modes, the first intra prediction mode is used for prediction to obtain a first prediction value, and the second intra prediction mode is used for prediction to obtain a second prediction value. The first prediction value and the second prediction value are weighted according to the weight of the prediction value to obtain the prediction value of the current block. For example, the first intra prediction mode is used to predict the sample A to obtain the first prediction value of sample A, and the second intra prediction mode is used to predict the sample A to obtain the second prediction value of the sample A. According to the weight of the prediction value corresponding to the sample A, the first prediction value and the second prediction value are weighted to obtain the prediction value of the sample A.

In some embodiments, in response to that K is greater than 2, the weights of the prediction values corresponding to two prediction modes of the K first prediction modes may be determined according to the first weight derivation mode, and the weights of the prediction values corresponding to other prediction modes of the K first prediction modes may be preset values. For example, K=3, the first weight of the prediction values corresponding to the first prediction mode and the second prediction mode is derived according to the weight derivation mode, and the weight of the prediction value corresponding to the third prediction mode is a preset value. In some embodiments, if the weight of the total prediction value corresponding to the K first prediction modes is a fixed value, e.g., 8, the weight of the respective prediction value corresponding to each of the K first prediction modes may be determined according to a preset weight ratio. Assuming that the weight of the prediction value corresponding to the third prediction mode accounts for ¼ of the weight of the total prediction value, the weight of the prediction value of the third prediction mode may be determined to be 2, and the remaining ¾ of the weight of the total prediction value is allocated to the first prediction mode and the second prediction mode. Exemplarily, if the weight of the prediction value corresponding to the first prediction mode derived according to the first weight derivation mode is 3, then the weight of the prediction value corresponding to the first prediction mode is determined to be (¾)*3, and the weight of the prediction value corresponding to the second prediction mode is determined to be (¾)*5.

According to the above method, the prediction value of the current block is determined. In this case, the bitstream is decoded to obtain the quantization coefficient of the current block, inverse quantization and inverse transform are performed on the quantization coefficient of the current block to obtain a residual value of the current block, and the prediction value and residual value of the current block are added to obtain the reconstructed value of the current block.

In the video decoding method provided by the embodiments of the present application, at the decoding side, when the current block is decoded, N candidate weight derivation modes are determined, and then, at least one candidate prediction mode is determined based on the N candidate weight derivation modes and the attribute information of the current block, and then, a first weight derivation mode and K first prediction modes corresponding to the current block are determined based on the N candidate weight derivation modes and the at least one candidate prediction mode, and then, the current block are predicted based on the first weight derivation mode and the K first prediction modes to obtain a prediction value of the current block. That is, in the embodiments of the present application, at the decoding side, the weight derivation mode and the attribute information of the current block are taken into account when determining the at least one candidate prediction mode, thereby improving the accuracy of determining the candidate prediction mode. When predicting the current block based on the accurately determined candidate prediction mode, the prediction accuracy of the current block may be improved, thereby improving decoding performance.

The video decoding method of the present application is described above by taking the decoding side as an example, and the following description will be made by taking the encoding side as an example.

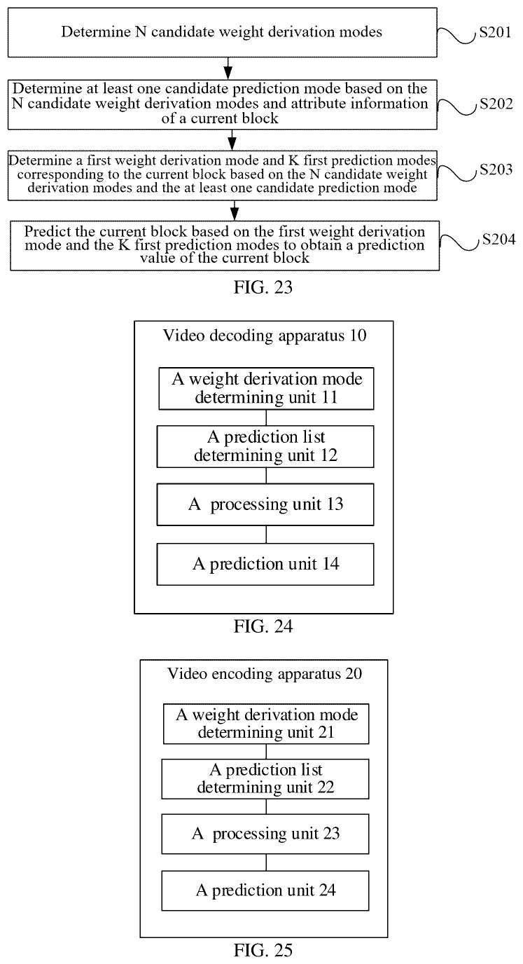

FIG. 23 is a schematic flowchart of a video encoding method provided by an embodiment of the present application. The embodiments of the present application are applied to the video encoders shown in FIGS. 1 and 2. As shown in FIG. 24, the method of the embodiments of the present application include following steps.

S201, N candidate weight derivation modes are determined.

Here, N is a positive integer. Optionally, N is a preset value or a default value. Optionally, N may also be determined at the encoding side in other manners, which is not limited in the embodiments of the present application.

From the above, it may be seen that in the embodiments of the present application, one weight derivation mode and K prediction modes jointly generate a prediction block, and the prediction block acts on a current block, that is, a weight is determined according to the weight derivation mode, and the current block is predicted based on the K prediction modes to obtain K prediction values, and the K prediction values are weighted according to the weight to obtain a prediction value of the current block.

That is, when encoding the current block at the encoding side, N candidate weight derivation modes and multiple candidate prediction modes are needed to be determined, and then, a weight derivation mode is selected from the N candidate weight derivation modes, and K prediction modes are selected from the multiple candidate prediction modes, and then, the selected weight derivation mode and the K prediction modes are used to predict the current block to obtain the prediction value of the current block.

The exemplary method of determining the N candidate weight derivation modes at the encoding side is not limited in the embodiments of the present application.

In a possible implementation, there are 56 weight derivation modes in the AWP and 64 weight derivation modes in the GPM. The N candidate weight derivation modes include at least one weight derivation mode of the 56 weight derivation modes in the AWP, or include at least one weight derivation mode of the 64 weight derivation modes in the GPM.

In a possible implementation, some weight derivation modes in the AWP or GPM may be selected as the N candidate weight derivation modes. That is, the N candidate weight derivation modes in the embodiments of the present application are a subset of all weight derivation modes of the AWP or the GPM. For example, the same “partition” angle in the weight derivation mode may correspond to multiple offsets; For example, for the modes 10, 11, 12 and 13 in FIG. 4 or 5, “partition” angles are the same, but the offsets are different. Modes corresponding to some offsets may be removed in the embodiments of the present application. Certainly, modes corresponding to some “partition” angles may also be removed. In this way, the total number of possible combinations may be reduced, and the difference between possible combinations is made obvious. Certainly, different selection methods may be set for the blocks with different sizes. For example, fewer weight derivation modes are used for smaller blocks and more weight derivation modes are used for larger blocks. In addition, different selection methods may also be set for blocks with different shapes, one explanation of which is that the shape of the block refers to a ratio of width to height.

In this implementation, N candidate weight derivation modes are selected in a same manner at the encoding side and the decoding side. In an example, the manner in which the N candidate weight derivation modes are selected is default at both encoding side and decoding side. In another example, the encoding side may indicate the manner in which the N candidate weight derivation modes are selected to the decoding side, so that at the decoding side, the same manner is used to select the same N candidate weight derivation modes as that selected at the encoding side.

In some embodiments, weight derivation modes corresponding to preset partition angles and/or preset offsets are removed from preset M weight derivation modes to obtain N weight derivation modes. Since the same partition angle in the weight derivation mode may correspond to multiple offsets, as shown in FIG. 4, the weight derivation modes 10, 11, 12 and 13 have the same partition angle but different offsets; in this case, weight derivation modes corresponding to some preset offsets may be removed, and/or weight derivation modes corresponding to some preset partition angles may also be removed.

In some embodiments, selection conditions corresponding to different blocks may be different. Therefore, in a case of determining the N weight derivation modes corresponding to the current block, a selection condition corresponding to the current block is first determined, and the N weight derivation modes are selected from the preset M weight derivation modes according to the selection condition corresponding to the current block.

In some embodiments, the selection conditions corresponding to the current block include a selection condition corresponding to a size of the current block and/or a selection condition corresponding to a shape of the current block. When predicting, for smaller blocks, similar weight derivation modes have little effect on the prediction results, while for larger blocks, similar weight derivation modes have a more obvious effect on the prediction results. Based on this, in the embodiments of the present application, different N values are set for blocks of different sizes; that is, a larger N value is set for a larger block, and a smaller N value is set for a smaller block.

In a possible implementation, the encoding side indicated N candidate weight derivation modes to the decoding side.

In some embodiments, the above selection conditions include an array, the array includes N elements, the N elements are in one-to-one correspondence with N weight derivation modes, the element corresponding to each weight derivation mode is used to indicate whether the weight derivation mode is available.

The above array may be a single-digit value or a two-digit value.

For example, considering GPM as an example, there are a total of 64 possible weight derivation modes. At the encoding side, a look-up table containing 64 elements is provided, and a value of each element represents whether to use the corresponding weight derivation mode.

In an example, considering a single-digit value as an example, an exemplary example is as follows, an array of g_sgpm_splitDir is set:
g_sgpm_splitDir [64]={
1,1,1,0,1,0,1,0,
1,0,1,0,1,0,1,0,
1,0,1,1,1,0,1,0,
1,0,1,0,1,0,1,0,
0,0,0,0,1,1,0,1,
0,0,1,0,0,1,0,0,
1,0,1,1,0,1,0,0,
1,0,0,1,0,0,1,0
};

where a value of g_sgpm_splitDir [x] is 1, which represents that the weight derivation mode with index x may be used, otherwise represents that the weight derivation mode with index x cannot be used. In this example, at the encoding side, 26 candidate weight derivation modes are determined via the array.

In another example, an array may be used to indicate N candidate weight derivation modes, and the array only contains indexes of the available weight derivation modes. For example, an array with a length of 26 g_sgpm_splitDir [26]={0,1,6,8,10,12,14, 16,18, 19,20,22,24,26,28,30,36,37,42,45,48,50,51,53,56, 59} is used to indicate 26 candidate weight derivation modes. At the encoding side, based on the indexs of the weight derivation modes included in the array, the weight derivation modes corresponding to the indexs are determined as candidate weight derivation modes, so as to obtain 26 candidate weight derivation modes.

In some embodiments, in a case where the selection conditions corresponding to the current block include selection condition corresponding to the size of the current block and selection condition corresponding to the shape of the current block; for the same weight derivation mode, if the selection condition corresponding to the size of the current block and the selection condition corresponding to the shape of the current block represent that the weight derivation mode is available, then the weight derivation mode is determined to be one of the N weight derivation modes; if at least one of the selection condition corresponding to the size of the current block and the selection condition corresponding to the shape of the current block represents that the weight derivation mode is unavailable, then the weight derivation mode is determined not to be used to constitute the N weight derivation modes.

In some embodiments, the selection condition corresponding to blocks with different size and the selection condition corresponding to blocks with different shapes may each be implemented using multiple arrays.

In some embodiments, the selection condition corresponding to blocks with different sizes and the selection condition corresponding to blocks with different shapes may be implemented using a two-bit array; that is, a two-bit array includes both selection condition corresponding to the size of the block and selection condition corresponding to the shape of the block.

Exemplarily, the selection conditions corresponding to a block with a size of A and a shape of B are as follows, and the selection conditions are represented by a two-bit array:
g_sgpm_splitDir [64]={
(1,1), (1,1), (1,1), (1,0), (1,0), (0,0), (1,0), (1,1),
(1,1), (0,0), (1,1), (1,0), (1,0), (0,0), (1,0), (1,1),
(0,1), (0,0), (1,1), (0,0), (1,0), (0,0), (1,0), (0,0),
(1,1), (0,0), (0,1), (1,0), (1,0), (1,0), (1,0), (0,0),
(0,0), (0,0), (1,1), (0,0), (1,1), (1,1), (1,0), (0,1),
(0,0), (0,0), (1,1), (0,0), (1,0), (0,0), (1,0), (0,0),
(1,0), (0,0), (1,1), (1,0), (1,0), (1,0), (0,0), (0,0),
(1,1), (0,0), (1,1), (0,0), (0,0), (1,0), (1,1), (0,0)
};

where values of g_sgpm_splitDir [x] are all 1, indicating that the weight derivation mode with index x is available; one of the values of g_sgpm_splitDir [x] is 0, indicating that the weight derivation mode with index x is not available. For example, g_sgpm_splitDir [4]=(1,0), which indicates that weight derivation mode 4 is available for blocks with the size of A, but not for blocks with the shape of B. Therefore, if the size of the block is A and the shape of the block is B, the weight derivation mode is not available.

It will be noted that the above description is made by taking an example in which there are 64 weight derivation modes in GPM, but the weight derivation modes in the embodiments of the present application include but are not limited to the 64 weight derivation modes included in GPM and the 56 weight derivation modes included in AMP.

In some embodiments, at the encoding side, before determining the N candidate weight derivation modes, it is necessary to first determine whether K different prediction modes are used for performing weighted prediction processing on the current block. In response to that, at the decoding side, if it is determined that K different prediction modes are used for performing weighted prediction processing on the current block, then the S201 is performed to determine the N candidate weight derivation modes. At the encoding side, if it is determined that K different prediction modes are not used for performing weighted prediction processing on the current block, the S201 is skipped.

In a possible implementation, at the encoding side, it may be determined that whether K different prediction modes are used for performing weighted prediction processing on the current block by determining the prediction mode parameter of the current block.

Optionally, in the implementations of the present application, the prediction mode parameter may indicate whether the GPM or the AWP mode are used for the current block, i.e., indicate whether K different prediction modes are used for performing prediction processing on the current block.

It may be understood that, in the embodiments of the present application, the prediction mode parameter may be understood as a flag indicating whether the GPM or the AWP mode is used. In some implementation, the encoder may use a variable as a prediction mode parameter, so that the prediction mode parameter may be set by setting a value of the variable. Exemplarily, in the present application, if the GPM or the AWP mode is used for the current block, the encoder may set the value of the prediction mode parameter to indicate that the GPM mode or the AWP mode are used for the current block. In some implementation, the encoder may set the value of the variable to 1. Exemplarily, in the present application, if the GPM or the AWP mode is not used for the current block, the encoder may set the value of the prediction mode parameter to indicate that the GPM or the AWP mode is not used for the current block. In some implementation, the encoder may set the variable value to 0. Furthermore, in the embodiments of the present application, after completing the setting of the prediction mode parameter, the encoder may encode the prediction mode parameter into a bitstream and transmit the prediction mode parameter to the decoder, so that the decoder may obtain the prediction mode parameter after parsing the bitstream.

In some embodiments, the conditions for the use of GPM or AWP mode for the current block will be limited in the embodiments of the present application; that is, when it is determined that the current block meets a preset condition, it is determined that K prediction modes are used for performing the weighted prediction on the current block; and then, N candidate weight derivation modes corresponding to the current block are determined.

Exemplarily, in a case where the GPM or the AWP mode is applied, the size of the current block may be limited.

It may be understood that since the video encoding method proposed in the embodiments of the present application needs to use K different prediction modes to generate K prediction values respectively, and then perform weighting according to the weights to obtain the prediction value of the current block. In order to reduce the complexity and consider the trade-off between compression performance and complexity, in the embodiments of the present application, it is possible to limit the use of the GPM or AWP mode to not be used for some blocks with certain sizes. Therefore, in the present application, the encoder may first determine a size parameter of the current block, and then determine whether the GPM or the AWP mode is used for the current block according to the size parameter.

In the embodiments of the present application, the size parameter of the current block may include a height and width of the current block. Therefore, the encoder may determine whether the GPM or the AWP mode is used for the current block according to the height and width of the current block.

Exemplarily, in the present application, if the width is greater than threshold 1 and the height is greater than threshold 2, it is determined that the GPM or the AWP mode is used for the current block. It may be seen that a possible limitation is that the GPM or the AWP mode is only used in a case where the width of the block is greater than (or greater than or equal to) threshold 1 and the height of the block is greater than (or greater than or equal to) threshold 2. The values of threshold 1 and threshold 2 may be 4, 8, 16, 32, 128, 256, etc., and threshold 1 may be equal to threshold 2.

Exemplarily, in the present application, if the width is less than threshold 3 and the height is greater than threshold 4, it is determined that the GPM or the AWP mode may be used for the current block. It may be seen that a possible limitation is that the GPM or the AWP mode is only used in a case where the width of the block is less than (or less than or equal to) the threshold 3 and the height of the block is greater than (or greater than or equal to) the threshold 4. The values of threshold 3 and threshold 4 may be 4, 8, 16, 32, 128, 256, etc., and threshold 3 may be equal to threshold 4.

Furthermore, in the embodiments of the present application, it is possible to limit the sample parameters to achieve a limitation on the size of the block that the GPM or the AWP mode may be used.

Exemplarily, in the present application, the encoder may first determine the sample parameters of the current block, and then further determine whether the GPM or the AWP mode may be used for the current block according to the sample parameters and threshold 5. It may be seen that a possible limitation is that the GPM or the AWP mode is only used in a case where a number of samples of the block is greater than (or greater than or equal to) the threshold 5. Here, a value of threshold 5 may be 4, 8, 16, 32, 128, 256, 1024, etc.

That is, in the present application, the GPM or the AWP mode may be used for the current block only in a case where the size parameter of the current block meets a size requirement.

Exemplarily, in the present application, there may be a frame-level flag to determine whether the present application is used for a current frame to be encoded. For example, it may be configured that the present application is used for intra frame (such as I-frame) and the present application is not used for inter frame (such as B-frame or P-frame). Alternatively, it may be configured that the present application is not used for the intra frame and the present application is used for the inter frame. Alternatively, it may be configured that the present application is used for certain inter frames and the present application is not used for another certain inter frames. Intra prediction may also be used for inter frame, so the present application may also be used for inter frame.

In some embodiments, there may also be a flag below the frame-level to determine whether the present application is used for the current block.

S202, at least one candidate prediction mode is determined based on the N candidate weight derivation modes and attribute information of the current block.

In the embodiments of the present application, when determining at least one candidate prediction mode not only the impact of the candidate weight derivation mode on the candidate prediction mode is considered, but also the impact of the attribute information of the current block on the candidate prediction mode is considered, thereby improving an accuracy of determining the candidate prediction mode.

The content of the attribute information of the current block is not limited in the embodiments of the present application.

In some embodiments, the attribute information of the current block includes size information of the current block. The size information of the current block includes the length and width of the current block, the aspect ratio of the current block, or a number of samples included in the current block.

In some embodiments, the attribute information of the current block further includes shape information of the current block. For example, the shape of the current block is a square, or the shape of the current block is a rectangle, or the shape of the current block is a preset shape such as a polygon or a circle.

In the embodiments of the present application, determining the at least one candidate prediction mode based on the N candidate weight derivation modes and the attribute information of the current block may be understood as determining prediction modes of which neighboring blocks of the current block may be used to determine the candidate prediction mode based on the N candidate weight derivation modes and the attribute information of the current block. For example, the weights of the neighboring blocks are determined based on the candidate weight derivation modes and the attribute information of the current block, and based on the weights of the neighboring blocks, it is determined prediction modes of which neighboring blocks are selected for determining the candidate prediction mode.

Exemplarily, if in a certain GPM weight derivation mode, for a certain prediction mode (the first prediction mode or the second prediction mode), the weight of the neighboring block is greater than (or greater than or equal to) a certain threshold, then it represents that the neighboring block has a strong correlation with the area occupied in the current prediction mode; otherwise, it represents that the neighboring block has a weak correlation with the area occupied in the current prediction mode.

In some embodiments, at the encoding side, a candidate prediction mode may be determined based on the N candidate weight derivation modes and the attribute information of the current block. That is, in these embodiments, the N candidate weight derivation modes correspond to a candidate prediction mode list. For example, if the partition line angles and offsets of the N candidate weight derivation modes are each not significantly different, in order to reduce the amount of calculation and improve decoding efficiency, at the encoding side, a candidate weight derivation mode A is determined from the N candidate weight derivation modes, and a candidate prediction mode list is determined based on the candidate weight derivation mode and the attribute information of the current block. In an example, the candidate weight derivation mode A may be a default candidate weight derivation mode of the N candidate weight derivation modes. Exemplarily, the encoding side may indicate the index of the candidate weight derivation mode A to the decoding side, so that the bitstream is decoded at the decoding side to obtain the index of the candidate weight derivation mode A.

In some embodiments, at least one candidate weight derivation mode of the N candidate weight derivation modes each corresponds to a respective candidate prediction mode list. That is, at the encoding side, a candidate prediction mode list for each of the N candidate weight derivation modes is determined. In this case, the S202 includes the following step S202-A.

S202-A, for an i-th candidate weight derivation mode of the N candidate weight derivation modes, a candidate prediction mode list corresponding to the i-th candidate weight derivation mode is determined based on the i-th candidate weight derivation mode and the attribute information of the current block.

In these embodiments, the method of determining the candidate prediction mode list corresponding to each candidate weight derivation mode of the N candidate weight derivation modes is the same. For the sake of ease of description, the i-th candidate weight derivation mode of the N candidate weight derivation modes is taken as an example for explanation. The i-th candidate weight derivation mode may be understood as any candidate weight derivation mode of the N candidate weight derivation modes.

The exemplary method of determining the candidate prediction mode list corresponding to the i-th candidate weight derivation mode based on the i-th candidate weight derivation mode and the attribute information of the current block is not limited in the embodiments of the present application.

In some embodiments, the i-th candidate weight derivation mode corresponds to a candidate prediction mode list, that is, a candidate prediction mode list corresponding to the i-th candidate prediction mode is determined based on the i-th candidate weight derivation mode and the attribute information of the current block. In this way, when the current block is predicted, K prediction modes are determined from the candidate prediction mode list corresponding to the i-th candidate weight derivation mode, and then, the i-th candidate weight derivation mode and the K prediction modes are used to predict the current block to obtain a prediction value of the current block. For example, the weight is determined based on the i-th candidate weight derivation mode, K prediction modes are used to predict the current block to obtain K prediction values, and the K prediction values are weighted using weights to obtain the prediction value of the current block in the i-th candidate weight derivation mode.

In an example of these embodiments, the method of determining the candidate prediction mode list corresponding to the i-th candidate weight derivation mode based on the i-th candidate weight derivation mode and the attribute information of the current block may be: determining a partition line corresponding to the i-th candidate weight derivation mode based on the i-th candidate weight derivation mode, and determining the partition line to partition the current block to obtain a first part and a second part based on the attribute information of the current block, where the first part may be understood as a part corresponding to the first prediction mode, and the second part may be understood as a part corresponding to the second prediction mode, and thus, the candidate prediction mode list corresponding to the i-th candidate weight derivation mode may be determined based on the prediction modes of the neighboring blocks neighboring to the first part of the current block of the neighboring blocks of the current block.

In another example of these embodiments, the method of determining the candidate prediction mode list corresponding to the i-th candidate weight derivation mode based on the i-th candidate weight derivation mode and the attribute information of the current block may be: determining weight of each neighboring block of the current block based on the i-th candidate weight derivation mode and the attribute information of the current block, and then determining a candidate prediction mode list corresponding to the i-th candidate weight derivation mode based on the weights of the neighboring blocks. For example, a candidate prediction mode list corresponding to the i-th candidate weight derivation mode is determined based on the prediction modes of the neighboring blocks with larger weights.

In some embodiments, for the K prediction modes corresponding to the i-th candidate weight derivation mode, the S202-A includes the following S202-A1.

S202-A1, a candidate prediction mode list of at least one prediction mode of K prediction modes corresponding to the i-th candidate weight derivation mode is determined based on the i-th candidate weight derivation mode and the attribute information of the current block.

In these embodiments, at the encoding side, the candidate prediction mode list of the at least one prediction mode of K prediction modes corresponding to the i-th candidate derivation mode is determined.

For example, if K=2, at the encoding side, based on the i-th candidate weight derivation mode and the attribute information of the current block, a candidate prediction mode list may be determined for the first prediction mode but a candidate prediction mode list may not be determined for the second candidate prediction mode. Optionally, a candidate prediction mode list may be determined for the second prediction mode, but a candidate prediction mode list may not be determined for the first candidate prediction mode. Optionally, a candidate prediction mode list may be determined for the first prediction mode, and a candidate prediction mode list may be determined for the second candidate prediction mode. Optionally, a common candidate prediction mode list may be determined for the first prediction mode and the second prediction mode.

In the embodiments of the present application, a candidate prediction mode list is determined for at least one prediction mode corresponding to the i-th candidate weight derivation mode, and then at least one prediction mode corresponding to the i-th candidate weight derivation mode is accurately determined from the constructed candidate prediction mode list.

In some embodiments, if the at least one prediction mode corresponds to one candidate prediction mode list, the S202-A1 includes the following steps S202-A1-11 and S202-A1-12: S202-A1-11, for a j-th prediction mode of the at least one prediction mode, a candidate prediction mode list of the j-th prediction mode is determined based on the i-th candidate weight derivation mode and the attribute information of the current block, where j is a positive integer; and

S202-A1-12, the candidate prediction mode list of the at least one prediction mode is determined based on the candidate prediction mode list of the j-th prediction mode.

In these embodiments, at least one prediction mode corresponding to the i-th candidate weight derivation mode corresponds to a candidate prediction mode list; that is, the candidate prediction mode lists corresponding to the at least one prediction mode are the same, which is a same candidate prediction mode list. Thus, it may be possible to reduce the complexity of determining the candidate prediction mode list to improve encoding efficiency. In this case, at the encoding side, one candidate prediction mode list is determined for the at least one prediction mode.

In some implementation, the candidate prediction mode list of the j-th prediction mode of the at least one prediction mode is determined based on the i-th candidate weight derivation mode and the attribute information of the current block. Optionally, the j-th prediction mode is any prediction mode of the at least one prediction mode. Then, the candidate prediction mode list of the at least one prediction mode is determined based on the candidate prediction mode list of the j-th prediction mode.

Determining the candidate prediction mode list of the at least one prediction mode based on the candidate prediction mode list of the j-th prediction mode in S202-A1-12 include but are not limited to the following manners.
Manner 1: directly determining the candidate prediction mode list of the j-th prediction mode as the candidate prediction mode list of the at least one prediction mode.
Manner 2: determining whether the candidate prediction mode list of the j-th prediction mode includes a preset prediction mode; in response to that the candidate prediction mode list of the j-th prediction mode includes the preset prediction mode, the candidate prediction mode list of the j-th prediction mode is determined as the candidate prediction mode list of the at least one prediction mode; in response to that the candidate prediction mode list of the j-th prediction mode does not include the preset prediction mode, adding the preset prediction mode to the candidate prediction mode list of the j-th prediction mode to obtain the candidate prediction mode list of the at least one prediction mode.

The preset prediction mode in the Manner 2 is not limited in the embodiments of the present application, and it is determined according to actual needs.

An exemplary process of determining the candidate prediction mode list of the at least one prediction mode in a case where the at least one prediction mode corresponds to one candidate prediction mode list has been introduced in these embodiments.

In some embodiments, if each prediction mode of the at least one prediction mode corresponds to one candidate prediction mode list, the S202-A1 includes the following step S202-A1-21.

S202-A1-21, for a j-th prediction mode of the at least one prediction mode mentioned above, a candidate prediction mode list of the j-th prediction mode is determined based on the i-th candidate weight derivation mode and the attribute information of the current block, where j is a positive integer.

In these embodiments, each prediction mode in the above at least one prediction mode corresponds to one candidate prediction mode list. Therefore, at the encoding side, a candidate prediction mode list is determined for each prediction mode in the at least one prediction mode corresponding to the i-th candidate weight derivation mode. For example, the at least one prediction mode includes a first prediction mode and a second prediction mode corresponding to the i-th candidate weight derivation mode; and then at the encoding side, a candidate prediction mode list is determined for the first prediction mode, and a candidate prediction mode is determined for the second prediction mode.

In these embodiments, the process of determining a candidate prediction mode list corresponding to each prediction mode of the above at least one prediction mode is the same. For the sake of ease of description, determining the candidate prediction mode list of the j-th prediction mode in the above at least one prediction mode is taken as an example for explanation in the embodiments of the present application.

The following is an introduction to the process of determining the candidate prediction mode list of the j-th prediction mode based on the i-th candidate weight derivation mode and the attribute information of the current block in the S202-A1-11 and the S202-A1-21.

In the embodiments of the present application, determining the candidate prediction mode list of the j-th prediction mode based on the i-th candidate weight derivation mode and the attribute information of the current block includes at least the following two implementations.

Implementation 1: at the encoding side, a candidate prediction mode list of the j-th prediction mode is determined via the following steps 31 to 33:
Step 31, determining a first look-up table, where the first look-up table includes neighboring blocks corresponding to different prediction modes under different block attribute information and different weight derivation modes;
Step 32, determining neighboring blocks corresponding to the j-th prediction mode in the first look-up table based on the attribute information of the current block and the i-th candidate weight derivation mode; and
Step 33, determining the candidate prediction mode list of the j-th prediction mode based on prediction modes of the neighboring blocks corresponding to the j-th prediction mode.

In Implementation 1, a first look-up table is determined based on different block attribute information. The first look-up table includes neighboring blocks corresponding to different prediction modes under different block attribute information and different weight derivation modes. In this way, the neighboring blocks corresponding to the j-th prediction mode may be obtained directly by searching the first look-up table, and then, the candidate prediction mode list of the j-th prediction mode may be determined based on the prediction modes of the neighboring blocks corresponding to the j-th prediction mode.

The form of the first look-up table is not limited in the embodiments of the present application.

In a possible implementation, the first look-up table includes P different sub look-up tables, where the P sub look-up tables are look-up tables corresponding to blocks with P pieces of attribute information, and the look-up table includes neighboring blocks corresponding to different prediction modes under different weight derivation modes. In this way, at the encoding side, a first sub look-up table corresponding to the current block may be determined in the P sub look-up tables based on the attribute information of the current block, where the first sub look-up table includes neighboring blocks corresponding to different prediction modes under different weight derivation modes; then, the neighboring blocks corresponding to the j-th prediction mode is determined in the first sub look-up table based on the i-th candidate weight derivation mode; and then, the candidate prediction mode list of the j-th prediction mode is determined based on the prediction modes of the neighboring blocks corresponding to the j-th prediction mode.

In the embodiments of the present application, different sub look-up tables are determined based on different block attribute information, where the look-up table includes the neighboring blocks corresponding to different prediction modes under different weight derivation modes.

In an example, it is assumed that the attribute information of the block includes the aspect ratio of the block. Assume that the P sub look-up tables include a look-up table corresponding to a block with an aspect ratio of 1:2, a look-up table corresponding to a block with an aspect ratio of 1:1, and a look-up table corresponding to a block with an aspect ratio of 2:1.

Exemplarily, the look-up table corresponding to the block with the aspect ratio of 1:2 is shown in Table 6 above.

In this way, when the current block is encoded, based on the size information of the current block, if it is determined that the aspect ratio of the current block is 1:2, the first sub look-up table shown in Table 6 is obtained from the P sub look-up tables. Then, based on the i-th candidate weight derivation mode, the neighboring blocks corresponding to the j-th prediction mode are determined in the first sub look-up table. In some implementation, based on the i-th candidate weight derivation mode, determining the neighboring blocks corresponding to the j-th prediction mode in the first sub look-up table is as follows. Assume that K=2, the j-th prediction mode is a first prediction mode, which corresponds to the first part in the Table 6. In this way, based on the i-th candidate weighted derivation mode, the neighboring blocks corresponding to the i-th prediction mode may be determined in the neighboring blocks corresponding to the first part. For example, the i-th candidate weight derivation mode is a4, and the neighboring blocks of the first part corresponding to a4 is A. Therefore, a top-left neighboring block, a top neighboring block and a top-right neighboring block of the current block may be determined as the neighboring blocks corresponding to the i-th prediction mode; and then, based on the prediction modes of the top-left neighboring block, the top neighboring block and the top-right neighboring block of the current block, the candidate prediction mode list of the j-th prediction mode is determined. For example, the prediction modes of the top-left neighboring block, the top neighboring block and the top-right neighboring block of the current block are added to the candidate prediction mode list of the j-th prediction mode in a preset order.

Exemplarily, the sub look-up table corresponding to the block with the aspect ratio of 1:1 is shown in Table 7.

In this way, when the current block is encoded, based on the size information of the current block, if it is determined that the aspect ratio of the current block is 1:1, the first sub look-up table shown in Table 7 is obtained from the P sub look-up tables. Then, based on the i-th candidate weight derivation mode, the neighboring blocks corresponding to the j-th prediction mode are determined in the first look-up table. In some implementation, based on the i-th candidate weight derivation mode, determining the neighboring blocks corresponding to the j-th prediction mode in the first sub look-up table is as follows. Assume that K=2, the j-th prediction mode is the first prediction mode, which corresponds to the first part in Table 7. In this way, based on the i-th candidate weighted derivation mode, the neighboring blocks corresponding to the i-th prediction mode may be determined in the neighboring blocks corresponding to the first part. For example, the i-th candidate weight derivation mode is a2, and the neighboring blocks of the first part corresponding to a2 is L+A. Therefore, a left neighboring block, a bottom-left neighboring block, a top-left neighboring block, a top neighboring block and a top-right neighboring block of the current block may be determined as the neighboring blocks corresponding to the i-th prediction mode; and then, based on the prediction modes of the left neighboring block, the bottom-left neighboring block, the top-left neighboring block, the top neighboring block and the top-right neighboring block of the current block, the candidate prediction mode list of the j-th prediction mode is determined. For example, the prediction modes of the left neighboring block, the bottom-left neighboring block, the top-left neighboring block, the top neighboring block and the top-right neighboring block of the current block are added to the candidate prediction mode list of the j-th prediction mode in the preset order.

Exemplarily, the sub look-up table corresponding to the block with the aspect ratio of 2:1 is shown in Table 8.

In this way, when the current block is encoded, based on the size information of the current block, if it is determined that the aspect ratio of the current block is 2:1, the first sub look-up table shown in Table 8 is obtained from the P sub look-up tables. Then, based on the i-th candidate weight derivation mode, the neighboring blocks corresponding to the j-th prediction mode are determined in the first sub look-up table. In some implementation, based on the i-th candidate weight derivation mode, determining the neighboring blocks corresponding to the j-th prediction mode in the first sub look-up table is as follows. Assume that K=2, the j-th prediction mode is the first prediction mode, which corresponds to the first portion of the Table 8. In this way, based on the i-th candidate weighted derivation mode, the neighboring blocks corresponding to the i-th prediction mode may be determined from the neighboring blocks corresponding to the first part. For example, the i-th candidate weight derivation mode is a1, and the neighboring block of the first part corresponding to a1 is L. Therefore, a left neighboring block, a bottom-left neighboring block and a top-left neighboring block of the current block may be determined as the neighboring blocks corresponding to the i-th prediction mode, and then, based on the prediction modes of the left neighboring block, the bottom-left neighboring block and the top-left neighboring block of the current block, the candidate prediction mode list of the j-th prediction mode is determined. For example, the prediction modes of the left neighboring block, the bottom-left neighboring block and the top-left neighboring block of the current block are added to the candidate prediction mode list of the j-th prediction mode in a preset order.

It will be noted that the Table 6, Table 7 and Table 8 are only examples and are not limitations on the embodiments of the present application. The contents included in the sub look-up table corresponding to the blocks with different attribute information in the embodiments of the present application are determined based on actual conditions.

Tables 7 and 8 show neighboring blocks corresponding to different prediction modes (i.e., different parts) under different candidate weight derivation modes. The candidate weight derivation mode may be understood as an index of the candidate weight derivation mode.

In some embodiments, an angle index may be used to replace the candidate weight derivation mode, that is, the look-up table includes neighboring blocks corresponding to different prediction modes under different angle indexes. In this way, when searching for neighboring blocks, the first sub look-up table is first determined from the P sub look-up tables based on the attribute information of the current block, then an angle index corresponding to the i-th candidate prediction mode is determined, and then the neighboring block corresponding to the j-th prediction mode is determined in the first sub look-up table based on the angle index.

In some embodiments, the aspect ratio of the current block may be replaced by a shape index of the current block. For example, a shape index of 0 represents that the aspect ratio is 1:1, a shape index of 1 represents that the aspect ratio is 2:1, a shape index of 2 represents that the aspect ratio is 1:2, and so on. In the embodiments of the present application, the index of each shape is used to construct a sub look-up table, and thus there are P sub look-up tables.

The exemplary method in which the P sub look-up tables are determined at the encoding side is not limited in the embodiments of the present application.

In another possible implementation, at the encoding side, P sub look-up tables are obtained from other storage devices.

In yet another possible implementation, P sub look-up tables are stored in the encoding side.

In still another possible implementation, at the encoding side, P sub look-up tables may be constructed. For example, for each candidate weight derivation pattern of the N candidate weight derivation patterns, based on the candidate weight derivation mode and the attribute information of the block, the first neighboring block that has a strong correlation with the first part of the block and the second neighboring block that has a strong correlation with the second part of the block are determined, and then, based on the first neighboring block and the second neighboring block, sub look-up tables as shown in Tables 6 to 8 are constructed.

In a possible implementation, the encoding side transmits P sub look-up tables to the decoding side. Since the P sub look-up tables do not include picture information, in an example, the encoding side may transmit the P sub look-up tables to the decoding side in a manner of transmitting other data. In another example, at the encoding side, the P sub look-up tables are encoded into a bitstream, and the P sub look-up tables are transmitted to the decoding side.

In some embodiments, the first look-up table is a table including neighboring blocks corresponding to different prediction modes under different block attribute information and different weight derivation modes. That is, the sub look-up tables shown in Table 6 to Table 7 are combined into one sub look-up table.

In this way, at the encoding side, the neighboring block corresponding to the j-th prediction mode may be determined in the first sub look-up table shown in Table 9 based on the attribute information of the current block and the i-th candidate weight derivation mode, and the candidate prediction mode list of the j-th prediction mode is determined based on the prediction mode of the neighboring block corresponding to the j-th prediction mode.

Implementation 1 described above shows that based on the i-th candidate weight derivation mode and the attribute information of the current block, the candidate prediction mode list of the j-th prediction mode is determined by searching for a sub look-up table.

In some embodiments, the candidate prediction mode list of the j-th prediction mode may also be determined by the following Implementation 2.

Implementation 2, at the encoding side, a candidate prediction mode list of the j-th prediction mode is determined via the following steps 41 and 42:
Step 41, determining weights of neighboring blocks of the current block with respect to the j-th prediction mode based on the i-th candidate weight derivation mode and the attribute information of the current block; and
Step 42, determining the candidate prediction mode list of the j-th prediction mode based on the weights of the neighboring blocks with respect to the j-th prediction mode.

In the Implementation 2, a weight of each of the neighboring blocks of the current block with respect to the j-th prediction mode is determined to select prediction modes of which specific neighboring blocks of the current block, and thus, a candidate prediction mode list of the j-th prediction mode is constructed.

An exemplary process of determining the weights of the neighboring blocks of the current block with respect to the j-th prediction mode based on the i-th candidate weight derivation mode and the attribute information of the current block will be introduced below.

In the step 41, determining the weights of the neighboring blocks of the current block with respect to the j-th prediction mode include but are not limited to the following manners.

Manner 1, for any neighboring block of the current block, a weight of each point in this neighboring block with respect to the j-th prediction mode are determined based on the i-th candidate weight derivation mode and the attribute information of the current block; the weight of the neighboring block with respect to the j-th prediction mode is determined based on the weights of all the points in the neighboring blocks with respect to the j-th prediction mode.

In an example, an average value of the weights of all the points in the neighboring block with respect to the j-th prediction mode is determined as the weight of the neighboring block with respect to the j-th prediction mode.

In another example, a weighted average of the weights of all the points in the neighboring block with respect to the j-th prediction mode is determined as the weight of the neighboring block with respect to the j-th prediction mode. Optionally, when the weighted average is determined, samples in the neighboring block that are neighboring to the current block are assigned a larger weight, and samples in the neighboring block that are farther from the current block are assigned a smaller weight.

In yet another example, a sum of the weights of all the points in the neighboring block with respect to the j-th prediction mode is determined as the weight of the neighboring block with respect to the j-th prediction mode.

In another example, a weighted sum of the weights of all the points in the neighboring block with respect to the j-th prediction mode is determined as the weight of the neighboring block with respect to the j-th prediction mode. Optionally, when the weighted sum value is determined, samples in the neighboring block that are neighboring to the current block are assigned a larger weight, and samples in the neighboring block that are farther from the current block are assigned a smaller weight.

In Manner 1, the weight of each point in the neighboring block with respect to the j-th prediction mode is determined based on the i-th candidate weight derivation mode and the attribute information of the current block in a same way. In some embodiments, since the neighboring blocks of the current block are located in a template of the current block, after a weight of the template of the current block is determined, the weight of each point in the neighboring block may be determined.

For example, a weight of a template of the current block is determined based on the i-th weight derivation mode, the attribute information of the current block and the template of the current block. For Point 1 in the neighboring block, the weight corresponding to Point 1 in the weight of the template of the current block is determined as the weight of Point 1 with respect to the j-th prediction mode. Referring to this manner, the weight of each point in the neighboring block with respect to the j-th prediction mode may be determined.

Manner 2: a weight of a certain point in the neighboring block is determined as the weight of the neighboring block with respect to the j-th prediction mode. In this case, the step 41 includes the following steps:
Step 41-A, determining a weight of a first point in the neighboring blocks based on the i-th candidate weight derivation mode and the attribute information of the current block; and
Step 41-B, determining the weight of the first point as the weight of the neighboring block with respect to the j-th prediction mode.

In the Manner 2, at the encoding side, the weight of the neighboring block with respect to the j-th prediction mode is determined by determining the weight of the first point in the neighboring block with respect to the j-th prediction mode, which may reduce the amount of calculation for determining the weight of the neighboring block, thereby improving the encoding efficiency.

The position of the first point in the neighboring block is not limited in the embodiments of the present application.

In a possible implementation, the first point is any point in the neighboring block.

In another possible implementation, the first point is a point in the neighboring block that is neighboring to the current block.

In the Manner 2, determining the weight of the first point in the neighboring block includes at least the following manners.

In a first manner, the weight of the first point in the neighboring block is directly determined. In this case, the above step 41-A includes the following step:
Step 41-A11, determining the weight of the first point based on the i-th candidate weight derivation mode, the attribute information of the current block and the template of the current block.

In the embodiments of the present application, since the neighboring block is located in the template area of the current block, the first point in the neighboring block is located in the template area of the current block. Thus, the weight of the first point may be determined by referring to the method of determining the weight of the template of the current block, which includes, for example, the following examples.

Example 1: if the weight of each point in the template is determined, a matrix composed of the weights of all the points is determined as the weight of the template, at the encoding side, the weight of the first point may be directly determined based on the i-th candidate weight derivation mode, the attribute information of the current block and the template of the current block, and the position information (x, y) of the first point in the template.

In some implementation, the angle index and distance index corresponding to the i-th candidate weight derivation mode are determined, and a first parameter of the first point in the template is determined according to the angle index, distance index, the size of the template and the position information (x, y) of the first point. In some embodiments, the first parameter is also referred to as the weight index weightIdx; the weight of the first point in the template is determined based on the first parameter of the first point in the template.

In the above Example 1, the weight of the first point in the neighboring block is determined by referring to the manner in which the weights of the samples in the template are determined. The whole process is simple, and the weight of the first point determined is accurate.

Example 2: from the above, it may be seen that the first point is a point in the template, so the weight of the entire template may be determined, and then, the weight of the first point may be determined based on the weight of the template. In this case, the above step 41-A11 includes: determining the weight of the template based on the i-th candidate weight derivation mode, the attribute information of the current block and the template of the current block; and determining the weight corresponding to the first point in the weight of the template as the weight of the first point.

In some implementation, the angle index and distance index corresponding to the i-th candidate weight derivation mode are determined, a size of the current block based on the attribute information of the current block is determined, and the first parameter of each sample in the template is determined according to the angle index, distance index, the size of the current block and the size of the template. In some embodiments, the first parameter is also referred to as the weight index weightIdx; the weight of the template is determined according to the first parameter of each sample in the template.

In the above implementation, the weight of each point in the template is determined via the weight derivation mode, and the weight matrix composed of the weights of all the points in the template is used as the template weight.

In another possible implementation, the merged area composed of the current block and the template is taken as a whole, the weights of the samples in the merged area are derived according to the weight derivation mode, and then, the weight of the template is determined based on the weight of the merged area.

Exemplarily, at the encoding side, the weights of the samples in the merged area composed of the current block and the template are determined based on the angle index, the distance index, the size of the template and the size of the current block; and then, the weight of the template is determined based on the size of the template and the weights of the samples in the merged area.

In this implementation, the current block and the template are taken as a whole, and the weights of the samples in the merged area composed of the current block and the template are determined based on the angle index, the distance index, the size of the template and the size of the current block. Then, the weight corresponding to the template of the merged area is determined as the weight of the template according to the size of the template. For example, as shown in FIGS. 21A and 21B, the weight corresponding to the L-shaped template area in the merged area is determined as the weight of the template.

In the Example 2, the weight of the template with respect to the j-th prediction mode is determined in the i-th candidate weight derivation mode, and then, the weight of the first point in the weight of the template with respect to the j-th prediction mode is determined as the weight of the first point in the neighboring block with respect to the j-th prediction mode.

In the above Manner 1, the weight of the first point in the neighboring block is directly determined by referring to the method of determining the weight of the template, so that the weight of the first point may be accurately determined. In this way, the weight of the neighboring block with respect to the j-th prediction mode may be accurately determined based on the weight of the first point.

Manner 2, the weight of the first point in the neighboring block is determined based on the weight of the second point in the current block; in this case, the step 41-A includes the following steps:
Step 41-A-21, determining a second point in the current block corresponding to the first point;
Step 41-A-22, determining a weight of the second point based on the i-th candidate weight derivation mode and the attribute information of the current block; and
Step 41-A-23, determining the weight of the first point based on the weight of the second point.

In the Manner 2, it may be seen from the above that when the weight of the first point in the neighboring block is directly determined, it is necessary to consider relevant information of the template, resulting in the increase of the complexity of determining the weight of the first point. In the Manner 2, the weight of the first point in the neighboring block is determined through the weight of the second point in the current block. When the weight of the second point is determined, there is no need to consider the relevant information of the template, thereby reducing the complexity of determining the weight of the first point.

The position of the second point in the current block corresponding to the first point is not limited in the embodiments of the present application.

In some embodiments, the second point is a point in the current block that is closest to the first point.

In an example, the second point is a point in the current block that is neighboring to the first point. For example, as shown in FIG. 18, the first point is a point at (x0-1, y0-1) in the neighboring block, and the second point may be a point at (x0, y0) in the current block. For another example, as shown in FIG. 18, the first point is a point at (x0-1, y0+height−1) in the neighboring block, and the second point may be a point at (x0, y0+height−1) in the current block.

In the Manner 2, an exemplary process of determining the weight of the second point based on the i-th candidate weight derivation mode and the attribute information of the current block may be as follows: determining a partition angle index variable angleIdx and a distance index variable distanceIdx corresponding to the i-th candidate weight derivation mode based on the i-th candidate weight derivation mode, and determining the size (nCbW) x (nCbH) of the current block based on the attribute information of the current block. Referring to the above method of determining the weight of the prediction value, the weight of the second point in the current block is determined. It will be noted that the above description is made by taking the j-th prediction mode is the first prediction mode as an example, i.e., what is determined above is the weight of the second point with respect to the first prediction mode. In a case where the j-th prediction mode is the second prediction mode, the weight of the second point with respect to the first prediction mode is 8-wVemplateValue [x] [y], where 8 is only an example and may be replaced with other values, which is not limited in the embodiments of the present application.

After the weight of the second point in the current block with respect to the j-th prediction mode is determined at the encoding side, the weight of the first point in the neighboring block is determined based on the weight of the second point. For example, in response to that the second point is neighboring to the first point, the weight of the second point may be directly determined as the weight of the first point. For another example, in response to that the second point is not neighboring to the first point, the weight of the second point may be corrected to obtain the weight of the first point, the correction method is not limited in the embodiments of the present application; for example, a preset value may be added or subtracted based on the weight of the second point to obtain the weight of the first point.

It will be noted that, for the process of determining the weight of the first point shown in the Manner 1 and determining the weight of the second point shown in the Manner 2, the influence of a weight gradient parameter is not considered.

In some embodiments, if the influence of the weight gradient parameter is considered in the process of determining the weight of the first point, at the encoding side, it also needs to determine the weight gradient parameter, and then determine the weight of the first point in the neighboring blocks based on the i-th candidate weight derivation mode, the attribute information of the current block and the weight gradient parameter.

The variable weight gradient may adjust a gradient of the weight change, so that blending areas with different widths may be obtained for the GPM in a case where the partition line angle and the partition line offset are the same.

Exemplarily, as shown in FIGS. 22A and 22B, FIG. 22A is a schematic diagram of a blending area for GPM in VVC, and FIG. 22B is an example of a variable weight gradient for GPM.

A value of blendingCoeff may be ¼, ½, 1, 2, 4, etc.

Exemplarily, the value of blendingCoeff may be derived from the weight gradient index gpm_blending_idx.

In some embodiments, the weight gradient index is also referred to as a blending gradient parameter or a blending parameter.

The manner in which the candidate blending parameter list is determined is not limited in the embodiments of the present application.

In an example, the candidate blending parameters in the candidate blending parameter list are preset.

In another example, at the encoding side, at least one blending parameter is selected from multiple preset blending parameters based on the feature information of the current block to constitute a candidate blending parameter list. For example, based on the picture information of the current block, blending parameters that match the picture information of the current block are selected from the multiple preset blending parameters to constitute a candidate blending parameter list.

For example, assuming that the picture information includes a clarity of picture edge, in response to that the clarity of the image edge of the current block is less than a preset value, at least one first-type weight gradient parameter, such as ¼, ½, is selected from the preset multiple weight gradient parameters, so as to constitute a candidate weight gradient parameter list; in response to that the clarity of the picture edge of the current block is greater than or equal to the preset value, at least one second-type weight gradient parameter, such as 2, 4, is selected from the preset multiple weight gradient parameters, so as to constitute a candidate weight gradient parameter list.

Exemplarily, the candidate weight gradient parameter list of the embodiments of the present application is shown in Table 10.

As shown in Table 10, the candidate weight gradient parameter list includes multiple candidate weight gradient parameters, and each candidate weight gradient parameter corresponds to an index.

Exemplarily, in the above Table 10, a ranking of the candidate weight gradient parameters in the candidate weight gradient parameter list is used as the index. Optionally, the indexes of the candidate weight gradient parameters in the candidate weight gradient parameter list may also be reflected in other ways, which is not limited in the embodiments of the present application.

In some embodiments, at the encoding side, after the weight gradient parameter is determined, a second index is encoded into a bitstream, the second index is used to indicate the weight gradient parameter. Thus, at the decoding side, the weight gradient parameter may be determined based on the second index.

In some embodiments, the second index is also referred to as a weight gradient index.

In some embodiments, at the encoding side, the weight gradient parameter may be determined in the following Manner 2.

In Manner 2, at the encoding side, multiple candidate weight gradient parameters are determined, where G is a positive integer; and the weight gradient parameter is determined from the multiple candidate weight gradient parameters.

In Manner 2, at the encoding side, multiple candidate weight gradient parameters are first determined, and then a candidate weight gradient parameter is determined from the multiple candidate weight gradient parameters as the weight gradient parameter.

The exemplary manner in which multiple candidate weight gradient parameters are determined at the encoding side is not limited in the embodiments of the present application.

In a possible implementation, the above multiple candidate weight gradient parameters are preset, that is, for the encoding side and the decoding side, it is agreed to determine several preset weight gradient parameters as G candidate weight gradient parameters.

In another possible implementation, multiple candidate weight gradient parameters may be determined based on the size of the current block.

In another possible implementation, picture information of the current block is determined; and multiple candidate weight gradient parameters are determined from multiple preset candidate weight gradient parameters based on the picture information of the current block.

After multiple candidate weight gradient parameters are determined at the encoding side, a weight gradient parameter is determined from the multiple candidate weight gradient parameters.

The exemplary manner in which the weight gradient parameter is determined from the multiple candidate weight gradient parameters is not limited in the embodiments of the present application.

In some embodiments, any candidate weight gradient parameter of the multiple candidate weight gradient parameters is determined as the weight gradient parameter.

In some embodiments, a cost corresponding to each candidate weight gradient parameter of multiple candidate weight gradient parameters is determined; and a weight gradient parameter is determined from the multiple candidate weight gradient parameters based on the costs. For example, a weight gradient parameter with the minimum cost is determined as the gradient parameter corresponding to the current block.

Manner 3: the weight gradient parameter is determined based on the size of the current block.

It may be seen from the above that there is a certain correlation between the weight gradient parameter and the size of the block. Therefore, the weight gradient parameter may also be determined based on the size of the current block in the embodiments of the present application.

In a possible implementation, a certain fixed weight gradient parameter is determined as the weight gradient parameter based on the size of the current block.

For example, in response to that the size of the current block is less than a first set threshold, the weight gradient parameter is determined to be a first value.

For another example, in response to that the size of the current block is greater than or equal to a first set threshold, the weight gradient parameter is determined to be a second value, the second value being less than a first value.

The values of the first value, the second value and the first set threshold are not limited in the embodiments of the present application

Exemplarily, the first value is 1 and the second value is ½.

Exemplarily, in response to that the size of the current block is indicated by a number of samples (or sampling points) of the current block, the first set threshold may be 256 or the like.

In another possible implementation, the value range of the weight gradient parameter is determined based on the size of the current block, and then the weight gradient parameter is determined to be a value within the value range.

For example, in response to that the size of the current block is less than the first set threshold, it is determined that the weight gradient parameter is within a value range of the weight gradient parameter. For example, the weight gradient parameter is any weight gradient parameter such as the minimum weight gradient parameter, the maximum weight gradient parameter, or the intermediate weight gradient parameter within the value range of the weight gradient parameter. For another example, the weight gradient parameter is the weight gradient parameter with the minimum cost within the value range of the weight gradient parameter. The method of determining the cost of the weight gradient parameter may refer to the description of other embodiments of the present application, which will not be repeated here.

For another example, in response to that the size of the current block is greater than or equal to the first set threshold, it is determined that the weight gradient parameter is within a second value range of the weight gradient parameter. For example, the weight gradient parameter is any weight gradient parameter such as the minimum weight gradient parameter, the maximum weight gradient parameter, or the intermediate weight gradient parameter within the second value range of the weight gradient parameter. For another example, the weight gradient parameter is the weight gradient parameter with the minimum cost within the second value range of the weight gradient parameter. The minimum value of the second value range of the weight gradient parameter is less than the minimum value of the value range of the weight gradient parameter, and the value range of the weight gradient parameter may or may not overlap with the second value range of the weight gradient parameter, which will not be repeated in the embodiments of the present application.

After the weight gradient parameter is determined at the decoding side according to the above steps, the weight of the first point in the neighboring block is determined based on the i-th candidate weight derivation mode, the attribute information of the current block and the weight gradient parameter.

In an example, at the encoding side, the weight index weightIdx, such as the weight index weightIdx corresponding to the first point in the above neighboring block or the weight index weightIdx corresponding to the second point in the current block, is determined based on the i-th candidate weight derivation mode and the attribute information of the current block. Then, the weight index weightIdx is processed using the weight gradient parameters determined above to obtain the processed weight index weightIdx; and the weight wVemplate Value of the first point or the second point is determined according to the processed weight index weightIdx.

The exemplary process of determining the weight of the first point in the neighboring block based on the i-th candidate weight derivation mode and the attribute information of the current block is introduced in the step 41-A of the above embodiments. Then, the weight of the first point is determined as the weight of the neighboring block with respect to the j-th prediction mode.

In the above Manner 2, after the weight of each neighboring block of the current block with respect to the j-th prediction mode is determined at the encoding side through the above step, the step 42 is performed; that is, based on the weights of the neighboring blocks with respect to the j-th prediction mode, a candidate prediction mode list of the j-th prediction mode is determined.

The implementation process of the above step 42 includes but is not limited to the following manners.

Manner 1, the step 42 includes the following steps 42-A1 and 42-A2:
Step 42-A1, in response to that the weight of the neighboring block with respect to the j-th prediction mode is greater than or equal to a preset threshold, obtaining the prediction mode of the neighboring block; and
Step 42-A2, determining the candidate prediction mode list of the j-th prediction mode based on the prediction modes of the neighboring blocks.

In this Manner 1, at the encoding side, based on the above steps, the weight of each neighboring block of the current block with respect to the j-th prediction mode in the i-th candidate weight derivation mode is determined. Then, the weight corresponding to each neighboring block is compared with the preset threshold, if the weight corresponding to the neighboring block is greater than or equal to the preset threshold, it means that the neighboring block has a strong correlation with the j-th prediction mode. Then, the candidate prediction mode list of the j-th prediction mode may be determined based on the prediction mode of the neighboring block. For example, the prediction mode of the neighboring block may be added to the candidate prediction mode list of the j-th prediction mode.

In some embodiments, in response to that a value of the weight is in a range from 0 to n, the preset threshold is n/2, where n is a positive number.

In some embodiments, in response to that the value of the weight is a first value or a second value, for example, the value of the weight is set to 0 or 1, the step 42 includes the following steps:
Step 42-B1, in response to that the weight of the neighboring block with respect to the j-th prediction mode is equal to the first value, obtaining the prediction mode of the neighboring block, the first value being greater than the second value; and
Step 42-B2, determining the candidate prediction mode list of the j-th prediction mode based on the prediction modes of the neighboring blocks.

In this embodiment, the weight of the neighboring block with respect to the j-th prediction mode is either the first value or the second value, if it is determined that the weight of the neighboring block with respect to the j-th prediction mode is equal to the first value, it means that the neighboring block has a strong correlation with the j-th prediction mode, and then the candidate prediction mode list of the j-th prediction mode may be determined based on the prediction mode of the neighboring block.

The values of the first value and the second value are not limited in the embodiments of the present application.

Optionally, the first value is 1.

Optionally, the second value is 0.

In some embodiments, in response to that the weight corresponding to the neighboring block is less than the preset threshold, or the weight corresponding to the neighboring block is equal to the second value, it means that there is a weak correlation between the neighboring block and the j-th prediction mode, and thus the candidate prediction mode list of the j-th prediction mode is not determined based on the prediction mode of the neighboring block. For example, obtaining the prediction mode of the neighboring block is skipped, thereby improving the accuracy of determining the candidate prediction mode list.

In the embodiments of the present application, there is no limitation on the number of neighboring blocks included in the current block and the positions of the neighboring blocks.

In some embodiments, if the length of the candidate prediction mode list of the j-th prediction mode is not limited, the weight of each neighboring block of the current block with respect to the j-th prediction mode may be compared with the preset threshold or the first value in a random manner to obtain the prediction modes of the neighboring blocks whose weights are greater than or equal to the preset threshold or equal to the first value.

In some embodiments, if the length of the candidate prediction mode list of the j-th prediction mode is limited, obtaining the prediction modes of the neighboring blocks in the step 42-A1 includes: according to a preset checking order, sequentially obtaining the prediction modes of the neighboring blocks whose weights with respect to the j-th prediction mode are greater than or equal to the preset threshold or equal to the first value of the neighboring blocks of the current block.

The preset checking order is not limited in the embodiments of the present application.

In some embodiments, if the neighboring blocks included in the current block are as shown in FIG. 18, in response to that the neighboring blocks of the current block include a left neighboring block L, a top neighboring block A, a bottom-left neighboring block BL, a top-right neighboring block AR and a top-left neighboring block AL, then the preset checking order is the left neighboring block, the top neighboring block, the bottom left neighboring block, the top-right neighboring block and the top-left neighboring block, that is, L→A→BL→AR→AL.

In some embodiments, at the encoding side, it does not limit the order in which the prediction modes of neighboring blocks are added into the candidate prediction mode list corresponding to the j-th prediction mode.

In some embodiments, at the encoding side, the obtained prediction modes of the neighboring blocks are sequentially added to the candidate prediction mode list of the j-th prediction mode according to the checking order. For example, at the encoding side, it is first determined that whether the weight of the neighboring block L with respect to the j-th prediction mode is less than or equal to the preset threshold, or is equal to the first value, in response to that the weight of the neighboring block L with respect to the j-th prediction mode is less than or equal to the preset threshold or is equal to the first value, the prediction mode of the neighboring block L is added to the candidate prediction mode list corresponding to the j-th prediction mode. Then, it is determined whether the weight of the neighboring block A with respect to the j-th prediction mode is less than or equal to the preset threshold or is equal to the first value, in response to that the weight of the neighboring block A with respect to the j-th prediction mode is less than or equal to the preset threshold or is equal to the first value, the prediction mode of the neighboring block A is added to the candidate prediction mode list corresponding to the j-th prediction mode, and so on, until the length of the candidate prediction mode list corresponding to the j-th prediction mode reaches an upper limit or all the above neighboring blocks are checked.

In some embodiments, in a case where the candidate prediction mode list do not includes duplicate candidate prediction modes, before the prediction mode of an neighboring block whose weight is greater than or equal to the preset threshold is added to the candidate prediction mode list, it is first determined whether the candidate prediction mode list of the j-th prediction mode includes the prediction mode of the neighboring block, in response to that the prediction mode of the neighboring block is not included in the candidate prediction mode list of the j-th prediction mode, the prediction mode of the neighboring block is added to the candidate prediction mode list of the j-th prediction mode; in response to that the prediction mode of the neighboring block is already included in the candidate prediction mode list of the j-th prediction mode, adding the prediction mode of the neighboring block to the candidate prediction mode list of the j-th prediction mode is skipped.

In this Manner 1, the prediction modes of the neighboring blocks whose weights with respect to the j-th prediction mode are greater than or equal to the preset threshold in all the neighboring blocks are added to the candidate prediction mode list of the j-th prediction mode, thereby improving the accuracy of determining the candidate prediction mode list.

In some embodiments, at the encoding side, the candidate prediction mode list of the j-th prediction mode may also be determined in the following Manner 2.

Manner 2: in response to that M neighboring blocks are included for the current block, where M is a positive integer, then the above step 42 includes the following step 42-C1:
Step 42-C1, determining the candidate prediction mode list of the j-th prediction mode based on the weights of the M neighboring blocks with respect to the j-th prediction mode and the prediction modes of the M neighboring blocks.

For example, several neighboring blocks whose weights are within a preset range are selected from the M neighboring blocks based on the weights of the M neighboring blocks with respect to the j-th prediction mode, and the prediction modes of these neighboring blocks are added to the candidate prediction mode list of the j-th prediction mode.

For another example, based on the weights of the M neighboring blocks respectively with respect to the j-th prediction mode, the prediction modes of the M neighboring blocks are added to the candidate prediction mode list, until the length of the candidate prediction mode list reaches a preset length. For example, the neighboring block with a larger weight has a greater probability of being added to the candidate prediction mode list, but the neighboring block with a smaller weight also has a chance to be added to the candidate prediction mode list, but the probability is small.

The number and positions of the M neighboring blocks are not limited in the embodiments of the present application.

In some embodiments, the M neighboring blocks include at least one of a left neighboring block, a top neighboring block, a bottom-left neighboring block, a top-right neighboring block, or a top-left neighboring block of the current block.

From the above, it may be seen that in a case of determining the candidate prediction mode list of the j-th prediction mode in the i-th candidate weight derivation mode, the candidate prediction mode list of the j-th prediction mode is determined based on the i-th candidate weight derivation mode and the attribute information of the current block in the above steps. For example, by determining the weights of the neighboring blocks of the current block with respect to the j-th prediction mode, and based on the weights, it is determined that whether to add the prediction modes of the neighboring blocks to the candidate prediction mode list of the j-th prediction mode.

Based on this, in the embodiments of the present application, at the encoding side, before the candidate prediction mode list of the j-th prediction mode is determined based on the i-th candidate weight derivation mode and the attribute information of the current block, it is first necessary to determine whether the candidate prediction mode list of the j-th prediction mode includes the prediction modes of the neighboring blocks, if it is determined that the candidate prediction mode list of the j-th prediction mode includes the prediction modes of the neighboring blocks, the candidate prediction mode list of the j-th prediction mode is determined based on the i-th candidate weight derivation mode and the attribute information of the current block.

The exemplary manner in which it is determined whether the candidate prediction mode list of the j-th prediction mode includes the prediction modes of the neighboring blocks at the encoding side is not limited in the embodiments of the present application.

In a first example, at the encoding side and the decoding side, it is assumed that the prediction modes of the neighboring blocks is included in the candidate prediction mode list corresponding to the current block. Based on this, at the encoding side, it may be determined that the candidate prediction mode list of the j-th prediction mode includes the prediction modes of the neighboring blocks. Alternatively, at the encoding side and the decoding side, it is assumed that the candidate prediction mode list corresponding to the current block does not includes the prediction modes of the neighboring blocks. Based on this, at the encoding side, it may be determined that the prediction modes of the neighboring blocks are not included in the candidate prediction mode list of the j-th prediction mode.

In a second example, at the encoding side, after all prediction modes located before the prediction modes of the neighboring blocks in the preset order are added to the candidate prediction mode list in a preset order, in response to that the length of the candidate prediction mode list does not reach the preset length, it is determined that the candidate prediction mode list of the j-th prediction mode includes the prediction modes of the neighboring blocks.

In this example, the candidate prediction mode list of the j-th prediction mode further includes other prediction modes; when the candidate prediction mode list of the j-th prediction mode is determined, at the encoding side, prediction modes are sequentially first added to the candidate prediction mode list of the j-th prediction mode according to a preset order, and then it is determined that whether the length of the candidate prediction mode list reaches the preset length after adding each prediction mode located before the prediction modes of the neighboring blocks in the preset order to the candidate prediction mode list; in response to that the length of the candidate prediction mode list does not reach the preset length after the prediction mode located before the prediction modes of the neighboring blocks in the preset order is added to the candidate prediction mode list, it is determined that the candidate prediction mode list of the j-th prediction mode includes the prediction modes of the neighboring blocks; in response to that the length of the candidate prediction mode list reaches the preset length after the prediction mode located before the prediction modes of the neighboring blocks in the preset order is added to the candidate prediction mode list, it is determined that the candidate prediction mode list of the j-th prediction mode does not include the prediction modes of the neighboring blocks.

In some embodiments, at the encoding side, in a preset order, a prediction mode whose prediction angle is parallel to the partition line of the i-th candidate weight derivation mode, a candidate prediction mode derived based on a template of the current block, a candidate prediction mode derived based on reconstructed samples neighboring to the current block, a prediction mode of a neighboring block, a prediction mode whose prediction angle is perpendicular to the partition line of the i-th candidate weight derivation mode, and a preset mode are added to the candidate prediction mode list of the j-th prediction mode until the length of the list reaches a preset length.

The preset order is not limited in the embodiments of the present application.

In an example, the preset order includes: a prediction mode whose prediction angle is parallel to the partition line of the i-th candidate weight derivation mode, a candidate prediction mode derived based on a template of the current block, a candidate prediction mode derived based on reconstructed samples neighboring to the current block, a prediction mode of a neighboring block, a prediction mode whose prediction angle is perpendicular to the partition line of the i-th candidate weight derivation mode, and a preset mode.

In some embodiments, the candidate prediction mode derived based on the template of the current block may be understood as a prediction mode derived through TIMD.

In some embodiments, the candidate prediction mode derived based on reconstructed samples neighboring to the current block may be understood as a prediction mode derived through DIMD.

In some embodiments, the preset mode includes a PLANAR mode.

In an example, in a case of constructing a candidate prediction mode list of the j-th prediction mode, the following types of prediction modes are added to the candidate prediction mode list until the list length reaches a preset length (e.g., 3):
1. A prediction mode whose prediction angle is parallel to the partition line of the i-th candidate weight derivation mode;
2. Prediction model derived through TIMD;
3. Prediction model derived through DIMD;
4. Prediction modes of neighboring blocks of the current block;
5. A prediction mode whose prediction angle is perpendicular to the partition line of the i-th candidate weight derivation mode; and
6. PLANAR mode.

The exemplary process of determining the candidate prediction mode list at the encoding side is introduced in the above embodiments.

In some embodiments, at the encoding side, first information is encoded into a bitstream, the first information being used for indicating whether the candidate prediction mode list includes prediction modes of neighboring blocks. In this way, at the decoding side, it may be determined whether the candidate prediction mode list of the j-th prediction mode includes the prediction modes of the neighboring blocks based on the first information.

At the encoding side, after the candidate prediction mode list is determined based on the above steps, the following step S203 will be performed.

S203, a first weight derivation mode and K first prediction modes corresponding to the current block are determined based on the N candidate weight derivation modes and the at least one candidate prediction mode.

At the encoding side, the N candidate weight derivation modes are determined according to the step S201, the at least one candidate prediction mode is determined according to the step S202, and then, one candidate weight derivation mode is selected from the N candidate weight derivation modes as the first weight derivation mode, and at least one first prediction mode of K first prediction modes is determined from at least one candidate prediction mode included in the at least one candidate prediction mode. Finally, the current block is predicted using the determined first weight derivation mode and the K first prediction modes to obtain a prediction value of the current block.

The exemplary manner in which the first weight derivation mode and K first prediction modes are determined at the encoding side based on the N candidate weight derivation modes and the at least one candidate prediction mode is not limited in the embodiments of the present application.

In some embodiments, the at least one candidate prediction mode is a candidate prediction mode list corresponding to the K first prediction modes; that is, the K first prediction modes are all selected from the candidate prediction mode list. In this case, at the encoding side, the N candidate weight derivation modes and the candidate prediction modes included in the candidate prediction mode list are combined. For example, each candidate weight derivation mode of the N candidate weight derivation modes is combined with any K candidate prediction modes in the candidate prediction mode list to obtain multiple combinations, each of which includes a candidate weight derivation mode and K candidate prediction modes. Then, the template of the current block is predicted using the candidate weight derivation modes and K candidate prediction modes included in each combination to determine the cost of each combination, and then a combination is determined from multiple combinations based on the costs; for example, a combination with the smallest cost is selected from the multiple combinations, the candidate weight derivation mode included in the combination with the smallest cost is determined as the first weight derivation mode, and the K prediction modes included in the combination with the smallest cost are determined as the K first prediction modes.

In some embodiments, at least one candidate prediction mode is a candidate prediction mode list of a first prediction mode among the K first prediction modes; for example, in a case where K=2, the above candidate prediction mode is a candidate prediction mode list of the first prediction mode. In this case, at the encoding side, the optional prediction mode set corresponding to the second prediction mode is determined. Then, at the encoding side, a candidate prediction mode is selected from the candidate prediction mode list of the first prediction mode as a possibility of the first prediction mode for each of the N candidate weight derivation modes, and a prediction mode is selected from the optional prediction mode set corresponding to the second prediction mode as a possibility of the second prediction mode, so as to obtain a combination of the candidate weight derivation mode, the possibility of the first prediction mode and the possibility of the second prediction mode, so that multiple combinations may be obtained. Each combination includes one candidate weight derivation mode and 2 candidate prediction modes. Then, the template of the current block is predicted using the candidate weight derivation mode and 2 candidate prediction modes included in each combination to determine the cost of each combination, and then, a combination is determined from multiple combinations based on the costs; for example, a combination with the smallest cost is selected from the multiple combinations, the candidate weight derivation mode included in the combination with the smallest cost is determined as the first weight derivation mode, and the K prediction modes included in the combination with the smallest cost are determined as the K first prediction modes.

In some embodiments, the at least one candidate prediction mode includes a candidate prediction mode list corresponding to each of the K first prediction modes; that is, at the encoding side, K candidate prediction modes are determined based on the step S202. For example, assuming that K=2, at the encoding side, a candidate prediction mode list of the first prediction mode and a candidate prediction mode list of the second prediction mode are determined. In this way, at the decoding side, a candidate weight derivation mode is selected from N candidate weight derivation modes, a candidate prediction mode is selected from the candidate prediction mode list of the first prediction mode, and a candidate prediction mode is selected from the candidate prediction mode list of the second prediction mode. In this case, the selected candidate weight derivation mode and the 2 candidate prediction modes constitute a combination. By referring to the above method, multiple combinations may be obtained. Each combination includes one candidate weight derivation mode and 2 candidate prediction modes. Then, the template of the current block is predicted using the candidate weight derivation modes and 2 candidate prediction modes included in each combination to determine the cost of each combination, and then a combination is determined from the multiple combinations based on the costs; for example, a combination with the smallest cost is selected from the multiple combinations, the candidate weight derivation mode included in the combination with the smallest cost is determined as the first weight derivation mode, and the K prediction modes included in the combination with the smallest cost are determined as the K first prediction modes.

Based on the above description, a weight derivation mode and K prediction modes may act together on the current block as a combination. In order to save codewords and reduce encoding costs, in some embodiments, the weight derivation mode and K prediction modes corresponding to the current block are used as a combination, i.e., a first combination. A first index is used to indicate the first combination. Compared with indicating the weight derivation mode and K prediction modes separately, fewer codewords are used in the embodiments of the present application, thereby reducing the encoding cost.

Based on this, the S203 includes the following steps S203-A to S203-C:
S203-A, determining a candidate combination list based on the N candidate weight derivation modes and the at least one candidate prediction mode, the candidate combination list including at least one candidate combination, the candidate combination including one weight derivation mode and K prediction modes; and
S203-B, determining the first combination from the candidate combination list.

Exemplarily, the candidate combination list is shown in Table 12. As shown in Table 12, the candidate combination list includes multiple candidate combinations, and any two candidate combinations of the multiple candidate combinations are not completely the same; that is, for the weight derivation modes and the K prediction modes included in any two candidate combinations, there is a difference in at least one mode. For example, there is a difference in the weight derivation mode in candidate combination 1 and candidate combination 2; alternatively, the weight derivation modes in candidate combination 1 and candidate combination 2 are the same, and there is a difference in at least one of the K prediction modes in candidate combination 1 and candidate combination 2; alternatively, there is a difference in the weight derivation mode in candidate combination 1 and candidate combination 2, and there is a difference in at least one prediction mode of the K prediction modes in candidate combination 1 and candidate combination 2.

Exemplarily, in the above Table 12, the ranking of the candidate combinations in the candidate combination list is used as the index. Optionally, the index of the candidate combinations in the candidate combination list may also be reflected in other ways, which is not limited in the embodiments of the present application.

The exemplary process of determining the candidate combination list based on the N candidate weight derivation modes and the at least one candidate prediction mode in the above S203-A will be introduced below.

The exemplary manner of determining the candidate combination list based on the N candidate weight derivation modes and the at least one candidate prediction mode in the S203-A is not limited in the embodiments of the present application.

In some embodiments, the N candidate weight derivation modes are arbitrarily combined with multiple candidate prediction modes included in the at least one candidate prediction mode, and each combination includes one weight derivation mode and 2 prediction modes. In this way, multiple combinations may be obtained, and the information related to the current block may be used to analyze the probability of different combinations occurring, and a candidate combination list may be constructed according to the probability of each combination occurring. Optionally, the information related to the current block includes pattern information of neighboring blocks of the current block, reconstructed samples of the current block, etc.

In some embodiments, the S203-A includes the following steps S203-A1 and S203-A2:
S203-A1, obtaining T second combinations based on the N candidate weight derivation modes and the at least one candidate prediction mode; and
S203-A2, obtaining the candidate combination list based on the T second combinations.

Here, any second combination of the T second combinations includes one weight derivation mode and K prediction modes, and the weight derivation modes and the K prediction modes included in any two combinations of the T second combinations are not exactly the same, T being a positive integer greater than 1.

In these embodiments, at the encoding side, T second combinations are determined based on the N candidate weight derivation modes and the at least one candidate prediction mode. The value of the T second combinations is not limited in the present application, such as 8, 16, 32. Each second combination of the T second combinations includes one weight derivation mode and K prediction modes, and the weight derivation modes and K prediction modes included in any two second combinations of the T second combinations are not exactly the same.

The exemplary manner of obtaining the T second combinations based on the N candidate weight derivation modes and the at least one candidate prediction mode in the S203-A1 is not limited in the embodiments of the present application.

In some embodiments, the at least one candidate prediction mode is a candidate prediction mode list corresponding to the K first prediction modes; that is, the K first prediction modes are all selected from the candidate prediction mode list. In this case, at the encoding side, the N candidate weight derivation modes are combined with the candidate prediction modes included in the candidate prediction mode list. For example, each of the N candidate weight derivation modes is combined with any K candidate prediction modes in the candidate prediction mode list to obtain T second combinations, each of which includes one candidate weight derivation mode and K candidate prediction modes.

In some embodiments, the at least one candidate prediction mode is a candidate prediction mode list of a certain first prediction mode among K first prediction modes; for example, in a case where K=2, the above candidate prediction mode is selected from a candidate prediction mode list of the first prediction mode. In this case, at the encoding side, the optional prediction mode set corresponding to the second prediction mode is determined. Then, at the encoding side, for each of the N candidate weight derivation modes, a candidate prediction mode is selected from the candidate prediction mode list of the first prediction mode as a possibility of the first prediction mode and a prediction mode is selected from the optional prediction mode set corresponding to the second prediction mode as a possibility of the second prediction mode, so as to obtain a second combination composed of the candidate weight derivation mode, the possibility of the first prediction mode and the possibility of the second prediction mode. In this way, T second combinations may be obtained, and each second combination includes one candidate weight derivation mode and 2 candidate prediction modes.

In some embodiments, the at least one candidate prediction mode includes a candidate prediction mode list corresponding to each of the K first prediction modes; that is, at the encoding side, K candidate prediction modes are determined based on the step S202. For example, assuming that K=2, at the encoding side, a candidate prediction mode list of the first prediction mode and a candidate prediction mode list of the second prediction mode are determined. In this way, at the encoding side, a candidate weight derivation mode is selected from N candidate weight derivation modes, a candidate prediction mode is selected from the candidate prediction mode list of the first prediction mode, and a candidate prediction mode is selected from the candidate prediction mode list of the second prediction mode. In this case, the selected candidate weight derivation mode and 2 candidate prediction modes constitute a second combination. Referring to the above method, T second combinations may be obtained, and each second combination includes one candidate weight derivation mode and 2 candidate prediction modes.

The implementations of obtaining the candidate combination list based on the T second combinations in the S203-A2 include but are not limited to the following implementations.
Implementation 1: the T second combinations are sorted according to a preset rule to obtain the candidate combination list.
Implementation 2, the S203-A2 includes the following steps:
S203-A21, for any second combination of the T second combinations, determining a cost corresponding to the second combination in a case where the template of the current block is predicted using the weight derivation mode and the K prediction modes in the second combination; and
S203-A22, determining the candidate combination list according to the cost corresponding to each second combination in the T second combinations.

In the Implementation 2, for each of the T second combinations, the template of the current block is predicted by using the weight derivation mode and the K prediction modes included in the second combination, so as to obtain a prediction value of the template corresponding to the second combination.

In some implementation, for each of the T second combinations, the template of the current block is predicted using the K prediction modes in the second combination to obtain K prediction values.

Then, the template weight corresponding to the second combination is determined based on the weight derivation mode in the second combination.

The above method is used to determine the weight of the template and the K template prediction values corresponding to a certain second combination, and the K template prediction values are weighted using the weight of the template to obtain the template prediction value under the second combination.

Since the template of the current block is a reconstructed area, a reconstructed value of the template may be obtained at the encoding side. In this way, for each of the T second combinations, the cost corresponding to the second combination may be determined according to the prediction value of the template and the reconstructed value of the template under the second combination. The manner of determining the cost corresponding to the second combination includes but is not limited to SAD, SATD, SEE or the like. Then, at the encoding side, a candidate combination list is constructed according to the cost corresponding to each second combination in the T second combinations.

In the embodiments of the present application, the manner of determining the template prediction value corresponding to the second combination includes at least the following manners.

The first manner is that the template prediction value corresponding to the second combination is a value; that is, at the encoding side, the K prediction modes included in the second combination are used to predict the template to obtain K prediction values, the weight of the template is determined according to the weight derivation mode included in the second combination, the K prediction values are weighted through the weight of the template to obtain the weighted prediction value, and the weighted prediction value is determined as the template prediction value corresponding to the second combination.

The second manner is that in some embodiments, some hierarchical selection ideas may also be used. For example, if a relatively small cost may be obtained in a weight derivation mode, a weight derivation pattern similar thereto is continued to be tried. Conversely, if a relatively small cost cannot be obtained in a weight derivation mode, a weight derivation mode similar thereto is not continued to be tried. For example, if a relatively small cost may be obtained in an intra prediction mode, an intra modes similar thereto is continued to be tried. Conversely, if a relatively small cost cannot be obtained in an intra prediction mode, an intra prediction modes similar thereto is not continued to be tried. Certainly, these selection methods may also be limited to the case where they are used in combination with other two elements. For example, if a relatively small cost cannot be obtained when a certain intra prediction mode is used as the first prediction mode in a certain weight derivation mode, then intra prediction modes similar to the intra prediction mode in the weight derivation mode will no longer be tried as the first prediction mode.

The third manner is that the cost corresponding to each second combination is determined using a fast cost calculation method. It may be seen from the above that the template prediction value corresponding to the second combination includes the template prediction values corresponding to the K prediction modes included in the second combination. In this case, the costs corresponding to the K prediction modes in the second combination may be determined according to the template prediction values and template reconstructed values corresponding to the K prediction modes in the second combination; the cost corresponding to the second combination may be determined according to the costs corresponding to the K prediction modes in the second combination. For example, a sum of the costs corresponding to the K prediction modes in the second combination is determined as the cost corresponding to the second combination.

In the embodiments of the present application, considering K=2 as an example, the weight of the template may be simplified to be only two possibilities, 0 and 1. Then, for each sample position, its sample value only comes from the prediction block of the first prediction mode or the prediction block of the second prediction mode. Therefore, for a prediction mode, the cost of the template in the prediction mode in a case where the prediction mode is used as the first prediction mode of a certain weighted derivation mode may be calculated; that is, in a case where the prediction mode is used as the first prediction mode in the weighted derivation mode, only the cost generated on the template of some samples with a weight of 1 is calculated. In an example, the cost is denoted as cost [pred_mode_idx] [gpm_idx] [0], where pred_mode_idx represents the index of the prediction mode, gpm_idx represents the index of the weight derivation mode, and 0 represents the prediction mode is used as the first prediction mode.

Moreover, in a case where the prediction mode is used as the second prediction mode of a certain weighted derivation mode, the cost of the prediction mode of the template is calculated; that is, in a case where the prediction mode is used as the second prediction mode in the weighted derivation mode, only the cost generated on the template of some samples with a weight of 1 is calculated. In an example, the cost is denoted as cost [pred_mode_idx] [gpm_idx] [1], where pred_mode_idx represents the index of the prediction mode, gpm_idx represents the index of the weight derivation mode, and 1 represents the prediction mode is used as the second prediction mode.

Then, in a case of calculating the cost of a combination, the corresponding two costs mentioned above may be directly added. For example, a cost of prediction modes pred_mode_idx0 and pred_mode_idx1in the weighted derivation mode gpm_idx is required to be calculated, where pred_mode_idx0 is used as the first prediction mode and pred_mode_idx1 is used as the second prediction mode, the cost is denoted as costTemp, then costTemp=cost [pred_mode_idx0] [gpm_idx] [0]+cost [pred_mode_idx1] [gpm_idx] [1]. If a cost of prediction modes pred_mode_idx0 and pred_mode_idx1 in the weighted derived mode gpm_idx is required to be calculated, where pred_mode_idx1 is used as the first prediction mode and pred_mode_idx0 is used as the second prediction mode, the cost is denoted as costTemp, then costTemp=cost [pred_mode_idx1] [gpm_idx] [0]+cost [pred_mode_idx0] [gpm_idx] [1].

In this way, one advantage is that the prediction blocks are first weighted and combined into a prediction block and then the cost is calculated, which is simplified to directly calculating the cost of the two parts, and then adding the costs to get the cost of the combination. Since a prediction mode may be combined with multiple other prediction modes, and for the same weight derivation mode, the costs of the parts of which the prediction mode is used as the first prediction mode and the second prediction mode are fixed, these costs, i.e., cost [pred_mode_idx] [gpm_idx] [0] and cost [pred_mode_idx] [gpm_idx] [1] in the above examples, may be retained and reused to reduce the amount of calculation.

According to the above method, the cost corresponding to each second combination in the T second combinations may be determined, and then a candidate combination list is constructed according to the cost corresponding to each second combination in the T second combinations.

In the embodiments of the present application, the method of determining the candidate combination list according to the cost corresponding to each second combination in the T second combinations in S203-A22 includes but is not limited to the following examples.

Example 1: the T second combinations are sorted according to cost corresponding to each second combination in the T second combinations; and the sorted T second combinations are determined as a candidate combination list.

The candidate combination list generated in the Example 1 includes T first candidate combinations.

Optionally, the T first candidate combinations in the candidate combination list are sorted according to the magnitude of the cost from small to large; that is, the cost corresponding to the T first candidate combinations in the candidate combination list increases in order.

The T second combinations are sorted according to the cost corresponding to each second combination in the T second combinations, which may be that the T second combinations are sorted in an order of the cost from small to large.

Example 2: C second combinations are selected from the T second combinations according to the costs corresponding to the second combinations, and the list composed of the C second combinations is determined as a candidate combination list.

Optionally, the C second combinations are the first C second combinations with the smallest costs of the T second combinations. For example, according to the cost corresponding to each second combination in the T second combinations, C second combinations with the smallest costs are selected from the T second combinations to constitute a candidate combination list. In this case, the candidate combination list includes C candidate combinations.

Optionally, the C candidate combinations in the candidate combination list are sorted according to the magnitude of the cost from small to large, that is, the costs corresponding to the C candidate combinations in the candidate combination list increase in order.

Based on the above steps, at the encoding side, the candidate combination list is determined.

Then, at the encoding side, a first combination is determined from the candidate combination list.

The method of determining the first combination from the candidate combination list is not limited in the embodiments of the present application.

For example, the first combination is any candidate combination in the candidate combination list.

For another example, the first combination is a candidate combination with the smallest cost in the candidate combination list.

In some embodiments, the index of the first combination in the candidate combination list is the first index, and the first index is encoded into the bitstream at the encoding side, so that the first combination is determined based on the first index at the decoding side.

At the encoding side, a first combination corresponding to a first index is selected from the candidate combination list, and the weight derivation mode included in the first combination is determined as the first weight derivation mode, and the K prediction modes included in the first combination are determined as K first prediction modes.

Based on the above steps, at the decoding side, the first weight derivation mode and the K first prediction modes are determined, and then the following step S204 is performed.

S204, the current block is predicted based on the first weight derivation mode and the K first prediction modes to obtain a prediction value of the current block.

In the embodiments of the present application, when the current block is encoded at the encoding side, N candidate weight derivation modes and at least one candidate prediction mode are determined; the at least one candidate prediction mode includes prediction modes determined based on the partition the template of the current block. That is, when a candidate prediction mode is determined in the embodiments of the present application, the prediction modes are derived via the partitioned template, thereby achieving accurate derivation of the prediction modes, thereby improving the accuracy of determining the at least one candidate prediction mode. Then, based on the N candidate weight derivation modes and the accurately determined candidate prediction modes, the first weight derivation mode and K first prediction modes are determined, so as to achieve accuracy in determining the first weight derivation mode and the K first prediction modes. In a case where the current block is predicted based on the accurately determined first weight derivation mode and the K first prediction modes, the prediction accuracy may be improved, thereby improving the encoding performance.

The exemplary process of predicting the current block based on the first weight derivation mode and the K first prediction modes to obtain the prediction value of the current block in the S204 is not limited in the embodiments of the present application.
In Case 1, when the prediction value weight is determined without considering the weight gradient parameter (also referred to as a blending parameter), the prediction value weight of the current block is determined based on the first weight derivation mode, and the current block is predicted based on the K first prediction modes to obtain K prediction values of the current block. The K prediction values of the current block are weighted based on the prediction value weight of the current block to obtain the prediction value of the current block. The process of deriving the prediction value weight of the current block based on the first weight derivation mode may refer to the process of deriving the prediction value weight of the current block in the above embodiments, which will not be repeated here.
In Case 2, when the prediction value weight is determined, the weight gradient parameter is considered. In this case, the S204 includes the following steps:
S204-A1, determining a weight gradient parameter; and
S204-A2, predicting the current block based on the weight gradient parameter, the first weight derivation mode and the K first prediction modes to obtain the prediction value of the current block.

In some embodiments, the S204-A2 includes the following steps:
S204-A21, determining a weight of the prediction value based on the weight gradient parameter and the first weight derivation mode;
S204-A22, predicting the current block based on the K first prediction modes to obtain K prediction values; and
S204-A23, weighting the K prediction values based on the weight of the prediction value to obtain the prediction value of the current block.

There is no order of performance between S204-A22 and S204-A21, that is, S204-A22 may be performed before S204-A21, or after S204-A21, or in parallel with S204-A21.

In the Case 2, at the encoding side, the weight gradient parameter is determined, and the weight of the prediction value is determined based on the weight gradient parameter and the first weight derivation mode. Then, the current block is predicted based on the K first prediction modes to obtain K prediction values of the current block. Then, the K prediction values of the current block are weighted using the weight of the prediction value to obtain the prediction value of the current block.

In some embodiments, at the encoding side, after the weight gradient parameter is determined, the second index corresponding to the weight gradient parameter is encoded into the bitstream. Thus, at the decoding side, the second index is obtained by decoding the bitstream, and then the weight gradient parameter is determined based on the second index.

In some embodiments, the second index is also referred to as a weight gradient index.

In some embodiments, different weight gradient parameters have little effect on the prediction result of the template. If a simplified method, i.e., the weights on the template are only 0 and 1, is used, then the weight gradient parameters cannot affect the prediction of the template, that is, the weight gradient parameters cannot affect the candidate combination list. In this case, the blending gradient index may be placed outside the combination.

In the embodiments of the present application, the exemplary manner of determining the weight gradient parameter according to the second index is not limited.

In some embodiments, at the encoding side, a candidate blending parameter list is determined, and the candidate blending parameter list includes multiple candidate blending parameters; and the candidate blending parameter corresponding to the second index in the candidate blending parameter list is determined as the weight gradient parameter.

The manner of determining the candidate blending parameter list is not limited in the embodiments of the present application.

In an example, the candidate blending parameters in the candidate blending parameter list are preset.

In another example, at the encoding side, at least one blending parameter is selected from multiple preset blending parameters according to the feature information of the current block to constitute a candidate blending parameter list. For example, according to the picture information of the current block, blending parameters that match the picture information of the current block are selected from the multiple preset blending parameters to constitute a candidate blending parameter list.

For example, assuming that the picture information includes a clarity of the picture edge, in response to that the clarity of the image edge of the current block is less than a preset value, at least one first-type weight gradient parameter, such as ¼ or ½, from the preset multiple weight gradient parameters is selected to constitute a candidate weight gradient parameter list; in response to that the clarity of the picture edge of the current block is greater than or equal to the preset value, at least one second-type weight gradient parameter, such as 2 or 4, from the preset multiple weight gradient parameters, is selected to constitute a candidate weight gradient parameter list.

In some embodiments, the weight gradient parameters are determined via the following steps S204-A11 and S204-A12.
S204-A11, determining multiple candidate weight gradient parameters, where G is a positive integer; and
S204-A12, determining the weight gradient parameter from the multiple candidate weight gradient parameters.

In these embodiments, at the encoding side, multiple candidate weight gradient parameters are first determined, and then, a candidate weight gradient parameter is determined from the multiple candidate weight gradient parameters as the weight gradient parameter.

The exemplary manner in which multiple candidate weight gradient parameters are determined at the encoding side is not limited in the embodiments of the present application.

In a possible implementation, the above multiple candidate weight gradient parameters are preset; that is, at the decoding side and the encoding side, it is agreed to determine several preset weight gradient parameters as G candidate weight gradient parameters.

In another possible implementation, the multiple candidate weight gradient parameters may be indicated at the encoding side; for example, at the encoding side, multiple weight gradient parameters of the preset multiple weight gradient parameters are indicated to be used as multiple candidate weight gradient parameters.

In another possible implementation, multiple candidate weight gradient parameters may be determined based on the size of the current block.

In another possible implementation, picture information of the current block is determined; and multiple candidate weight gradient parameters are determined from multiple preset candidate weight gradient parameters according to the picture information of the current block.

At the encoding side, after multiple candidate weight gradient parameters are determined, a weight gradient parameter is determined from the multiple candidate weight gradient parameters.

The exemplary manner of determining the weight gradient parameter from the multiple candidate weight gradient parameters is not limited in the embodiments of the present application.

In some embodiments, any candidate weight gradient parameter among the multiple candidate weight gradient parameters is determined as the weight gradient parameter.

In some embodiments, a cost corresponding to each of multiple candidate weight gradient parameters is determined; and a weight gradient parameter is determined from the multiple candidate weight gradient parameters according to the costs. For example, the weight gradient parameter with the minimum cost is determined as the gradient parameter corresponding to the current block.

In some embodiments, the weight gradient parameter is determined based on the size of the current block.

It may be seen from the above that there is a certain correlation between the weight gradient parameter and the size of the block. Therefore, the weight gradient parameter may also be determined based on the size of the current block in the embodiments of the present application.

In a possible implementation, a fixed weight gradient parameter is determined as the weight gradient parameter based on the size of the current block.

For example, in response to that the size of the current block is less than a first set threshold, the weight gradient parameter is determined to be a first value.

For another example, in response to that the size of the current block is greater than or equal to a first set threshold, the weight gradient parameter is determined to be a second value, the second value being less than a first value.

The values of the first value, the second value and the first set threshold are not limited in the embodiments of the present application

Exemplarily, the first value is 1, and the second value is ½.

Exemplarily, in response to that the size of the current block is indicated by a number of samples (or sampling points) of the current block, the first set threshold may be 256 or the like.

In another possible implementation, the value range of the weight gradient parameter is determined based on the size of the current block, and then the weight gradient parameter is determined to be a value within the value range.

For example, in response to that the size of the current block is less than the first set threshold, the weight gradient parameter is determined to be within a value range of the weight gradient parameter. For example, the weight gradient parameter is any weight gradient parameter such as the minimum weight gradient parameter, the maximum weight gradient parameter, or the intermediate weight gradient parameter within the value range of the weight gradient parameter. For another example, the weight gradient parameter is the weight gradient parameter with the minimum cost within the value range of the weight gradient parameter. The method of determining the cost of the weight gradient parameter may refer to the description of other embodiments of the present application, which will not be repeated here.

For another example, in response to that the size of the current block is greater than or equal to the first set threshold, the weight gradient parameter is determined to be within a second value range of the weight gradient parameter. For example, the weight gradient parameter is any weight gradient parameter such as the minimum weight gradient parameter, the maximum weight gradient parameter, or the intermediate weight gradient parameter within the second value range of the weight gradient parameter. For another example, the weight gradient parameter is the weight gradient parameter with the minimum cost within the second value range of the weight gradient parameter. The minimum value of the second value range of the weight gradient parameter is less than the minimum value of the value range of the weight gradient parameter, and the value range of the weight gradient parameter may or may not overlap with the second value range of the weight gradient parameter, which will not be repeated in the embodiments of the present application.

In this Case 2, after the weight gradient parameters are determined according to the above steps, the above steps S204-A21 are performed to determine the weight of the prediction value according to the weight gradient parameters and the first weight derivation mode.

Then, the current block is predicted based on the K first prediction modes to obtain K prediction values; the K prediction values are weighted according to the weight of the prediction value to obtain the prediction value of the current block.

From the above embodiments, it may be understood that determining the weight of the template and the weight of the prediction value are two independent processes that do not interfere with each other. The weight of the prediction value may be individually determined through the above method.

In some embodiments, when the weight of the template is determined as described above, the weight of the template is determined by determining the weight of a merged area formed by combining the template area and the current block. Since the merged area includes the current block, the weight corresponding to the current block in the weight of the merged area is determined as the weight of the prediction value. It will be noted that when the weight of the merged area is determined, the influence of the weight gradient parameter on the weight is also taken into account, with reference to the description of the above embodiments, which will not be repeated here.

In some embodiments, the above prediction process is performed in units of samples, and the corresponding weights of the above prediction values are also the weights corresponding to the samples. In this case, when the current block is predicted, each prediction mode of the K first prediction modes is used to predict a certain sample A in the current block, and K prediction values of the K first prediction modes with respect to the sample A are obtained. The weight of the prediction value of the sample A is determined according to the first weight derivation mode and the weight gradient parameter. Then, the K prediction values are weighted using the weight of the prediction value of the sample A to obtain the prediction value of the sample A. By performing the above steps on each sample in the current block, a prediction value of each sample in the current block may be obtained, and the prediction value of each sample in the current block is used to obtain the prediction value of the current block. Considering K=2 as an example, the first prediction mode is used to predict a sample A in the current block to obtain the first prediction value of the sample A, the second prediction mode is used to predict the sample A to obtain the second prediction value of the sample A; based on the prediction value weight corresponding to the sample A, the first prediction value and the second prediction value are weighted to obtain the prediction value of the sample A.

In an example, considering K=2 as an example, in response to that the first prediction mode and the second prediction mode are both intra prediction modes, the first intra prediction mode is used for prediction to obtain a first prediction value, and the second intra prediction mode is used for prediction to obtain a second prediction value. The first prediction value and the second prediction value are weighted according to the weight of the prediction value to obtain the prediction value of the current block. For example, the first intra prediction mode is used to predict the sample A to obtain the first prediction value of the sample A, and the second intra prediction mode is used to predict the sample A to obtain the second prediction value of the sample A. According to the weight of the prediction value corresponding to sample A, the first prediction value and the second prediction value are weighted to obtain the prediction value of sample A.

In some embodiments, in response to that K is greater than 2, the weights of the prediction values corresponding to two prediction modes of the K first prediction modes may be determined according to the first weight derivation mode, and the weights of the prediction values corresponding to other prediction modes of the K first prediction modes may be preset values. For example, K=3, the first weight of the prediction values corresponding to the first prediction mode and the second prediction mode is derived according to the weight derivation mode, and the weight of the prediction value corresponding to the third prediction mode is a preset value. In some embodiments, if the weight of the total prediction value corresponding to the K first prediction modes is a fixed value, e.g., 8, the weight of the prediction value corresponding to each of the K first prediction modes may be determined according to a preset weight ratio. Assuming that the weight of the prediction value corresponding to the third prediction mode accounts for ¼ of the weight of the total prediction value, the weight of the prediction value of the third prediction mode may be determined to be 2, and the remaining ¾ of the weight of the total prediction value is allocated to the first prediction mode and the second prediction mode. Exemplarily, if the weight of the prediction value corresponding to the first prediction mode derived according to the first weight derivation mode is 3, then the weight of the prediction value corresponding to the first prediction mode is determined to be (¾)*3, and the weight of the prediction value corresponding to the second prediction mode is determined to be (¾)*5.

According to the above method, the prediction value of the current block is determined, the residual value of the current block is obtained according to the current block and the prediction value of the current block, the residual value of the current block is transformed to obtain the transform coefficient, the transform coefficient is quantized to obtain the quantization coefficient, the quantization coefficient is encoded to obtain the bitstream.

In the video encoding method provided by the embodiments of the present application, at the decoding side, when the current block is decoded, N candidate weight derivation modes are determined, and then at least one candidate prediction mode is determined based on the N candidate weight derivation modes and the attribute information of the current block, and then, a first weight derivation mode and K first prediction modes corresponding to the current block are determined based on the N candidate weight derivation modes and the at least one candidate prediction mode, and then, the current block is predicted based on the first weight derivation mode and the K first prediction modes to obtain a prediction value of the current block. That is, in the embodiments of the present application, at the encoding side, the weight derivation mode and the attribute information of the current block are taken into account when the at least one candidate prediction mode is determined, thereby improving the accuracy of determining the candidate prediction mode list. When the current block is predicted based on the accurately determined candidate prediction mode list, the prediction accuracy of the current block may be improved, thereby improving encoding performance.

It will be understood that FIGS. 19 to 23 are merely examples in the present application, which may not be construed as a limitation on the present application.

The preferred embodiments of the present application are described in detail above in conjunction with the accompanying drawings, however, the present application is not limited in the exemplary details in the above embodiments. Within the technical concept of the present application, a variety of simple modifications can be made to the technical solution of the present application, and these simple modifications all fall within the protection scope of the present application. For example, the various exemplary technical features described in the above exemplary embodiments can be combined in any suitable manner without contradiction. In order to avoid unnecessary repetition, the present application will not further explain various possible combinations. For another example, the various implementations of the present application can be arbitrarily combined, and as long as they do not violate the concept of the present application, they should also be regarded as the content disclosed in the present application.

It should further be understood that, in the various method embodiments of the present application, the magnitude of numbers of the above-mentioned processes does not mean the order of execution. The execution order of each process should be determined by its function and internal logic, and should not constitute any limitation on the implementation process of the embodiments of the present application. In addition, in the embodiments of the present application, the term “and/or” is only an association relationship to describe associated objects, which means that there may be three kinds of relationships. In some implementation, A and/or B may indicate three cases that: A exists alone, both A and B exist, and B exists alone. In addition, a character “/” herein generally means that related objects before and after “/” are in an “or” relationship.

The method embodiments of the present application have been described in detail above with reference to FIGS. 19 to 23. The apparatus embodiments of the present application will be described in detail below with reference to FIGS. 24 to 27.

FIG. 24 is a schematic block diagram of a video decoding apparatus provided by an embodiment of the present application. The video decoding apparatus 10 is applied to the above video decoder.

As shown in FIG. 24, a video decoding apparatus 10 may include:
a weight derivation mode determining unit 11, configured to determine N candidate weight derivation modes, where N is a positive integer;
a prediction list determining unit 12, configured to determine at least one candidate prediction mode based on the N candidate weight derivation modes and attribute information of a current block;
a processing unit 13, configured to determine a first weight derivation mode and K first prediction modes corresponding to the current block based on the N candidate weight derivation modes and the at least one candidate prediction mode, where K is a positive integer greater than 1; and
a prediction unit 14, configured to predict the current block based on the first weight derivation mode and the K first prediction modes to obtain a prediction value of the current block.

In some embodiments, the prediction list determining unit 12 is configured to, for an i-th candidate weight derivation mode of the N candidate weight derivation modes, determine a candidate prediction mode list corresponding to the i-th candidate weight derivation mode based on the i-th candidate weight derivation mode and the attribute information of the current block, where i is a positive integer less than or equal to N.

In some embodiments, the prediction list determining unit 12 is configured to determine a candidate prediction mode list of at least one prediction mode of K prediction modes corresponding to the i-th candidate weight derivation mode based on the i-th candidate weight derivation mode and the attribute information of the current block.

In some embodiments, if the at least one prediction mode corresponds to a candidate prediction mode list, the prediction list determining unit 12 is configured to, for a j-th prediction mode of the at least one prediction mode, determine a candidate prediction mode list of the j-th prediction mode based on the i-th candidate weight derivation mode and the attribute information of the current block, where j is a positive integer; and determine the candidate prediction mode list of the at least one prediction mode based on the candidate prediction mode list of the j-th prediction mode.

In some embodiments, the prediction list determining unit 12 is configured to determine the candidate prediction mode list of the j-th prediction mode as the candidate prediction mode list of the at least one prediction mode.

In some embodiments, the prediction list determining unit 12 is configured to, in response to that the candidate prediction mode list of the j-th prediction mode includes a preset prediction mode, determine the candidate prediction mode list of the j-th prediction mode as the candidate prediction mode list of the at least one prediction mode.

In some embodiments, the prediction list determining unit 12 is configured to, in response to that the candidate prediction mode list of the j-th prediction mode does not include a preset prediction mode, add the preset prediction mode to the candidate prediction mode list of the j-th prediction mode to obtain the candidate prediction mode list of the at least one prediction mode.

In some embodiments, in response to that each prediction mode in the at least one prediction mode corresponds to a candidate prediction mode list, then in some embodiments, the prediction list determining unit 12 is configured to, for a j-th prediction mode among the at least one prediction mode, determine a candidate prediction mode list of the j-th prediction mode based on the i-th candidate weight derivation mode and the attribute information of the current block, where j is a positive integer.

In some embodiments, the prediction list determining unit 12 is configured to: determine a first look-up table, the first look-up table including neighboring blocks corresponding to different prediction modes under different block attribute information and different weight derivation modes; determine neighboring blocks corresponding to the j-th prediction mode in the first look-up table based on the attribute information of the current block and the i-th candidate weight derivation mode; and determine the candidate prediction mode list of the j-th prediction mode based on prediction modes of the neighboring blocks corresponding to the j-th prediction mode.

In some embodiments, the prediction list determining unit 12 is configured to: determine weights of neighboring blocks of the current block with respect to the j-th prediction mode based on the i-th candidate weight derivation mode and the attribute information of the current block; and determine the candidate prediction mode list of the j-th prediction mode based on the weights of the neighboring blocks with respect to the j-th prediction mode.

In some embodiments, the prediction list determining unit 12 is configured to: determine a weight of a first point in the neighboring block based on the i-th candidate weight derivation mode and the attribute information of the current block; and determine the weight of the first point as the weight of the neighboring block with respect to the j-th prediction mode.

In some embodiments, the prediction list determining unit 12 is configured to determine the weight of the first point based on the i-th candidate weight derivation mode, the attribute information of the current block and a template of the current block.

In some embodiments, the prediction list determining unit 12 is configured to: determine a weight of the template based on the i-th candidate weight derivation mode, the attribute information of the current block and the template of the current block; and determine a weight corresponding to the first point in the weight of the template as the weight of the first point.

In some embodiments, the prediction list determining unit 12 is configured to: determine a second point in the current block corresponding to the first point; determine a weight of the second point based on the i-th candidate weight derivation mode and the attribute information of the current block; and determine the weight of the first point based on the weight of the second point.

In some embodiments, the second point is a point in the current block that is neighboring to the first point.

In some embodiments, the first point is any point in the neighboring block.

In some embodiments, the first point is a point in the neighboring block that is neighboring to the current block.

In some embodiments, the prediction list determining unit 12 is configured to: in response to that the weight of the neighboring block with respect to the j-th prediction mode is greater than or equal to a preset threshold, obtain the prediction mode of the neighboring block; and determine the candidate prediction mode list of the j-th prediction mode based on the prediction modes of the neighboring blocks.

Optionally, in response to that a value of the weight is in a range from 0 to n, the preset threshold is n/2, and n is a positive number.

In some embodiments, if the value of the weight is a first value or a second value, the prediction list determining unit 12 is configured to: in response to that the weight of the neighboring block with respect to the j-th prediction mode is equal to the first value, obtain the prediction mode of the neighboring block, the first value being greater than the second value; and determine the candidate prediction mode list of the j-th prediction mode based on the prediction modes of the neighboring blocks.

In some embodiments, the prediction list determining unit 12 is configured to, according to a preset checking order, sequentially obtain prediction modes of neighboring blocks whose weight with respect to the j-th prediction mode is greater than or equal to the preset threshold or equal to the first value of the neighboring blocks of the current block.

In some embodiments, the prediction list determining unit 12 is configured to, according to the checking order, sequentially add the obtained prediction modes of the neighboring blocks to the candidate prediction mode list of the j-th prediction mode.

In some embodiments, if the neighboring blocks of the current block include a left neighboring block, a top neighboring block, a bottom-left neighboring block, a top-right neighboring block and a top-left neighboring block, the preset checking order is the left neighboring block, the top neighboring block, the bottom-left neighboring block, the top-right neighboring block and the top-left neighboring block.

In some embodiments, the prediction list determining unit 12 is configured to, in response to that the candidate prediction mode list of the j-th prediction mode does not include the prediction modes of the neighboring blocks, add the prediction modes of the neighboring blocks to the candidate prediction mode list of the j-th prediction mode.

In some embodiments, the prediction list determining unit 12 is further configured to, in response to that the weight of the neighboring block with respect to the j-th prediction mode is less than the preset threshold, skip obtaining the prediction mode of the neighboring block.

In some embodiments, if M neighboring blocks are included for the current block, the prediction list determining unit 12 is configured to determine the candidate prediction mode list of the j-th prediction mode based on the weights of the M neighboring blocks respectively with respect to the j-th prediction mode and the prediction modes of the M neighboring blocks, where M is a positive integer.

In some embodiments, the prediction list determining unit 12 is configured to add the prediction modes of the M neighboring blocks to the candidate prediction mode list based on the weights of the M neighboring blocks respectively with respect to the j-th prediction mode until a length of the candidate prediction mode list reaches a preset length.

In some embodiments, the M neighboring blocks include at least one of a left neighboring block, a top neighboring block, a bottom-left neighboring block, a top-right neighboring block or a top-left neighboring block.

In some embodiments, before determining the candidate prediction mode list of the j-th prediction mode based on the i-th candidate weight derivation mode and the attribute information of the current block, the prediction list determining unit 12 determines whether the candidate prediction mode list of the j-th prediction mode includes the prediction mode of the neighboring block; in response to that the candidate prediction mode list of the j-th prediction mode includes the prediction mode of the neighboring block is determined, the prediction list determining unit 12 determines the candidate prediction mode list of the j-th prediction mode based on the i-th candidate weight derivation mode and the attribute information of the current block.

In some embodiments, the prediction list determining unit 12 is configured to: decode a bitstream to obtain first information, the first information being used for indicating whether the candidate prediction mode list includes the prediction mode of neighboring block; and determine whether the candidate prediction mode list of the j-th prediction mode includes the prediction mode of the neighboring block based on the first information.

In some embodiments, the prediction list determining unit 12 is configured to:, in response to that the length of the candidate prediction mode list does not reach the preset length after adding, according to a preset order, each prediction mode located before the prediction modes of the neighboring blocks in the preset order to the candidate prediction mode list, determine that the candidate prediction mode list of the j-th prediction mode includes the prediction modes of the neighboring blocks.

In some embodiments, the preset order includes: a prediction mode whose prediction angle is parallel to a partition line of the i-th candidate weight derivation mode, a candidate prediction mode derived based on the template of the current block, a candidate prediction mode derived based on the reconstructed samples neighboring to the current block, a prediction mode of a neighboring block, a prediction mode whose prediction angle is perpendicular to the partition line of the i-th candidate weight derivation mode and a preset mode.

Optionally, the preset mode includes a PLANAR mode.

In some embodiments, the processing unit 13 is specifically configured to: decode a bitstream to obtain a first index, the first index being used to indicate a first combination, the first combination including the first weight derivation mode and the K first prediction modes; determine a candidate combination list based on the N candidate weight derivation modes and the at least one candidate prediction mode, the candidate combination list including at least one candidate combination, the candidate combination including one weight derivation mode and K prediction modes; and determine the first combination from the candidate combination list based on the first index.

In some embodiments, the processing unit 13 is specifically configured to: obtain T second combinations based on the N candidate weight derivation modes and the at least one candidate prediction mode, any second combination of the T second combinations including one weight derivation mode and K prediction modes, and the weight derivation mode and the K prediction modes included in any two combinations of the T second combinations being not completely the same, T being a positive integer greater than 1; and obtain the candidate combination list based on the T second combinations.

In some embodiments, the processing unit 13 is specifically configured to: for any second combination of the T second combinations, determine a cost corresponding to the second combination in a case where the template of the current block is predicted using the weight derivation mode and the K prediction modes in the second combination; and determine the candidate combination list according to the cost corresponding to each second combination in the T second combinations.

In some embodiments, a height of a top part of the template of the current block is 1, and/or a width of a left part of the template of the current block is 1.

In some embodiments, the attribute information of the current block includes size information of the current block.

It should be understood that, the apparatus embodiments and the method embodiments may correspond to each other, and similar descriptions may refer to the video decoding method embodiments, which will not be repeated here for the sake of brevity. In some implementation, the apparatus 10 shown in FIG. 24 may perform the decoding method at the decoding side in the embodiments of the present application, and the aforementioned and other operations and/or functions of various units in the apparatus 10 are respectively for implementing the corresponding processes in the decoding methods of the decoding side, which will not be repeated here for the sake of brevity.

FIG. 25 is a schematic block diagram of a video encoding apparatus provided by an embodiment of the present application. The video encoding apparatus is applied to the above video encoder.

As shown in FIG. 25, the video encoding apparatus 20 may include:
a weight derivation mode determining unit 21, configured to determine N candidate weight derivation modes, where N is a positive integer;
a prediction list determining unit 22, configured to determine at least one candidate prediction mode based on the N candidate weight derivation modes and attribute information of a current block;
a processing unit 23, configured to determine a first weight derivation mode and K first prediction modes corresponding to the current block based on the N candidate weight derivation modes and the at least one candidate prediction mode, where K is a positive integer greater than 1; and
a prediction unit 24, configured to predict the current block based on the first weight derivation mode and the K first prediction modes to obtain a prediction value of the current block.

In some embodiments, the prediction list determining unit 22 is specifically configured to: for an i-th candidate weight derivation mode of the N candidate weight derivation modes, determine a candidate prediction mode list corresponding to the i-th candidate weight derivation mode based on the i-th candidate weight derivation mode and the attribute information of the current block, where i is a positive integer less than or equal to N.

In some embodiments, the prediction list determining unit 22 is configured to determine a candidate prediction mode list of the at least one prediction mode of K prediction modes corresponding to the i-th candidate weight derivation mode based on the i-th candidate weight derivation mode and the attribute information of the current block.

In some embodiments, in a case where the at least one prediction mode corresponds to a candidate prediction mode list, the prediction list determining unit 22 is configured to: for a j-th prediction mode of the at least one prediction mode, determine a candidate prediction mode list of the j-th prediction mode based on the i-th candidate weight derivation mode and the attribute information of the current block, where j is a positive integer; and determine the candidate prediction mode list of the at least one prediction mode based on the candidate prediction mode list of the j-th prediction mode.

In some embodiments, the prediction list determining unit 22 is configured to determine the candidate prediction mode list of the j-th prediction mode as the candidate prediction mode list of the at least one prediction mode.

In some embodiments, the prediction list determining unit 22 is configured to, in response to that the candidate prediction mode list of the j-th prediction mode includes a preset prediction mode, determine the candidate prediction mode list of the j-th prediction mode as the candidate prediction mode list of the at least one prediction mode.

In some embodiments, the prediction list determining unit 22 is configured to, in response to that the candidate prediction mode list of the j-th prediction mode does not include a preset prediction mode, add the preset prediction mode to the candidate prediction mode list of the j-th prediction mode to obtain the candidate prediction mode list of the at least one prediction mode.

In some embodiments, in response to that each prediction mode in the at least one prediction mode corresponds to a candidate prediction mode list, the prediction list determining unit 22 is configured to: for a j-th prediction mode of the at least one prediction mode, determine a candidate prediction mode list of the j-th prediction mode based on the i-th candidate weight derivation mode and the attribute information of the current block, where j is a positive integer.

In some embodiments, the prediction list determining unit 22 is configured to: determine a first look-up table, the first look-up table including neighboring blocks corresponding to different prediction modes under different block attribute information and different weight derivation modes; determine neighboring blocks corresponding to the j-th prediction mode in the first look-up table based on the attribute information of the current block and the i-th candidate weight derivation mode; and determine the candidate prediction mode list of the j-th prediction mode based on prediction modes of the neighboring blocks corresponding to the j-th prediction mode.

In some embodiments, the prediction list determining unit 22 is configured to: determine weight of a neighboring block of the current block with respect to the j-th prediction mode based on the i-th candidate weight derivation mode and the attribute information of the current block; and determine the candidate prediction mode list of the j-th prediction mode based on the weights of the neighboring blocks with respect to the j-th prediction mode.

In some embodiments, the prediction list determining unit 22 is configured to: determine a weight of a first point in the neighboring block based on the i-th candidate weight derivation mode and the attribute information of the current block; and determine the weight of the first point as the weight of the neighboring block with respect to the j-th prediction mode.

In some embodiments, the prediction list determining unit 22 is configured to determine the weight of the first point based on the i-th candidate weight derivation mode, the attribute information of the current block and a template of the current block.

In some embodiments, the prediction list determining unit 22 is configured to: determine a weight of the template based on the i-th candidate weight derivation mode, the attribute information of the current block and the template of the current block; and determine a weight corresponding to the first point in the weight of the template as the weight of the first point.

In some embodiments, the prediction list determining unit 22 is configured to: determine a second point in the current block corresponding to the first point; determine a weight of the second point based on the i-th candidate weight derivation mode and the attribute information of the current block; and determine the weight of the first point based on the weight of the second point.

In some embodiments, the second point is a point in the current block that is neighboring to the first point.

In some embodiments, the first point is any point in the neighboring block.

In some embodiments, the first point is a point in the neighboring block that is neighboring to the current block.

In some embodiments, the prediction list determining unit 22 is configured to: in response to that the weight of the neighboring block with respect to the j-th prediction mode is greater than or equal to a preset threshold, obtain the prediction mode of the neighboring block; and determine the candidate prediction mode list of the j-th prediction mode based on the prediction modes of the neighboring blocks.

Optionally, in response to that a value of the weight is in a range from 0 to n, the preset threshold is n/2, and n is a positive number.

In some embodiments, in response to that the value of the weight is a first value or a second value, the prediction list determining unit 22 is configured to: in response to that the weight of the neighboring block with respect to the j-th prediction mode is equal to the first value, obtain the prediction mode of the neighboring block, the first value being greater than the second value; and determine the candidate prediction mode list of the j-th prediction mode based on the prediction modes of the neighboring blocks.

In some embodiments, the prediction list determining unit 22 is configured to: according to a preset checking order, sequentially obtain prediction modes of neighboring blocks whose weight with respect to the j-th prediction mode are greater than or equal to the preset threshold or equal to the first value in the neighboring blocks of the current block.

In some embodiments, the prediction list determining unit 22 is configured to sequentially add, according to the checking order, the obtained prediction modes of the neighboring blocks to the candidate prediction mode list of the j-th prediction mode.

In some embodiments, in a case where the neighboring blocks of the current block include a left neighboring block, a top neighboring block, a bottom-left neighboring block, a top-right neighboring block and a top-left neighboring block, the preset checking order is the left neighboring block, the top neighboring block, the bottom-left neighboring block, the top-right neighboring block and the top-left neighboring block.

In some embodiments, the prediction list determining unit 22 is specifically configured to: in response to that the candidate prediction mode list of the j-th prediction mode does not include the prediction mode of the neighboring block, add the prediction mode of the neighboring block to the candidate prediction mode list of the j-th prediction mode.

In some embodiments, the prediction list determining unit 22 is further configured to: in response to that the weight of the neighboring block with respect to the j-th prediction mode is less than the preset threshold, skip obtaining the prediction mode of the neighboring block.

In some embodiments, in a case where M neighboring blocks are included for the current block, the prediction list determining unit 22 is specifically configured to determine the candidate prediction mode list of the j-th prediction mode based on the weights of the M neighboring blocks respectively with respect to the j-th prediction mode and the prediction modes of the M neighboring blocks, where M is a positive integer.

In some embodiments, the prediction list determining unit 22 is specifically configured to add the prediction modes of the M neighboring blocks to the candidate prediction mode list based on the weights of the M neighboring blocks respectively with respect to the j-th prediction mode until a length of the candidate prediction mode list reaches a preset length.

In some embodiments, the M neighboring blocks include at least one of a left neighboring block, a top neighboring block, a bottom-left neighboring block, a top-right neighboring block or a top-left neighboring block.

In some embodiments, before determining the candidate prediction mode list of the j-th prediction mode based on the i-th candidate weight derivation mode and the attribute information of the current block, the prediction list determining unit 22 determines whether the candidate prediction mode list of the j-th prediction mode includes the prediction mode of the neighboring block; in response to that the candidate prediction mode list of the j-th prediction mode includes the prediction mode of the neighboring block is determined, the prediction list determining unit 22 determines the candidate prediction mode list of the j-th prediction mode based on the i-th candidate weight derivation mode and the attribute information of the current block.

In some embodiments, the prediction list determining unit 22 is specifically configured to: in response to that the length of the candidate prediction mode list does not reach the preset length after adding, according to a preset order, each prediction mode located before the prediction modes of the neighboring blocks in the preset order to the candidate prediction mode list, determine that the candidate prediction mode list of the j-th prediction mode includes the prediction modes of the neighboring blocks.

In some embodiments, the preset order includes: a prediction mode whose prediction angle is parallel to a partition line of the i-th candidate weight derivation mode, a candidate prediction mode derived based on the template of the current block, a candidate prediction mode derived based on reconstructed samples neighboring to the current block, prediction modes of the neighboring blocks, a prediction mode whose prediction angle is perpendicular to the partition line of the i-th candidate weight derivation mode and a preset mode.

Optionally, the preset mode includes a PLANAR mode.

In some embodiments, the prediction list determining unit 22 is further configured to encode first information into a bitstream, where the first information is used for indicating whether the candidate prediction mode list includes the prediction modes of the neighboring blocks.

In some embodiments, the processing unit 23 is specifically configured to: determine a candidate combination list based on the N candidate weight derivation modes and the at least one candidate prediction mode, the candidate combination list including at least one candidate combination, the candidate combination including one weight derivation mode and K prediction modes; and determine a first combination from the candidate combination list, the first combination including the first weight derivation mode and the K first prediction modes.

In some embodiments, the processing unit 23 is specifically configured to: obtain T second combinations based on the N candidate weight derivation modes and the at least one candidate prediction mode, any second combination of the T second combinations including one weight derivation mode and K prediction modes, and the weight derivation modes and the K prediction modes included in any two combinations of the T second combinations being not exactly the same, T being a positive integer greater than 1; and obtain the candidate combination list based on the T second combinations.

In some embodiments, the processing unit 23 is specifically configured to: for any second combination of the T second combinations, determine a cost corresponding to the second combination in a case where the template of the current block is predicted using the weight derivation mode and the K prediction modes in the second combination; and determine the candidate combination list according to the cost corresponding to each second combination in the T second combinations.

In some embodiments, the processing unit 23 is further configured to encode a first index into the bitstream, the first index being used to indicate the first combination.

In some embodiments, a height of a top part of the template of the current block is 1, and/or a width of a left part of the template of the current block is 1.

In some embodiments, the attribute information of the current block includes size information of the current block.

It should be understood that, the apparatus embodiments and the method embodiments may correspond to each other, and similar descriptions may refer to the method embodiments, which will not be repeated here for the sake of brevity. In some implementation, the apparatus 20 shown in FIG. 25 may correspond to the corresponding subject in the encoding methods at the encoding side that performs the embodiments of the present application, and the aforementioned and other operations and/or functions of various units in the apparatus 20 are respectively for implementing the corresponding processes in the encoding methods at the encoding side, which will not be repeated here for the sake of brevity.

The above describes the apparatus and system of the embodiments of the present application from the perspective of functional units in conjunction with the accompanying drawings. It should be understood that the functional units may be implemented in a hardware form, may be implemented by instructions in a software form, or may be implemented by a combination of hardware and software units. In some implementation, various steps of the method embodiments in the present application may be completed by an integrated logic circuit of hardware in the processor and/or instructions in the software form. The steps of the method disclosed in the embodiments of the present application may be directly embodied as being performed and completed by a hardware decoding processor, or by using a combination of hardware and software units in the decoding processor. Optionally, the software unit may be located in the mature storage medium in the art, such as a random memory, a flash, a read-only memory, a programmable read-only memory, an electrically erasable programmable memory, or a register. The storage medium is located in a memory, and a processor reads information stored in the memory and completes the steps in the above method embodiments in combination with the hardware of the processor.

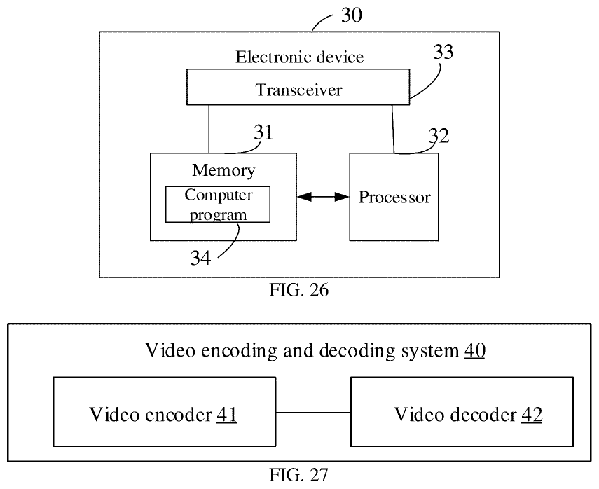

FIG. 26 is a schematic block diagram of an electronic device provided by the embodiments of the present application.

As shown in FIG. 26, the electronic device 30 may be a video encoder or a video decoder as described in the embodiments of the present application, and the electronic device 30 may include:
a memory 31 and a processor 32, the memory 31 being configured to store a computer program 34 and transmit the computer program 34 to the processor 32. In other words, the processor 32 may call the computer program 34 from the memory 31 and run the computer program 34 to implement the methods in the embodiments of the present application.

For example, the processor 32 may be configured to perform the steps in the above methods 200 according to instructions in the computer program 34.

In some embodiments of the present application, the processor 32 may include but is not limited to:
a general-purpose processor, a digital signal processor (DSP), an application specific integrated circuit (ASIC), a field programmable gate array (FPGA) or other programmable logic devices, a discrete gate or transistor logic device, a discrete hardware component.

In some embodiments of the present application, the memory 31 includes but is not limited to:
a volatile (transitory) memory and/or a non-volatile (non-transitory) memory. Herein, the non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash. The volatile memory may be a random access memory (RAM), which is used as an external cache. By way of illustrative rather than limiting illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM).

In some embodiments of the present application, the computer program 34 may be divided into one or more units, the one or more units are stored in the memory 31 and executed by the processor 32 to complete the methods provided by the present application. The one or more units may be a series of computer program instruction segments capable of completing exemplary functions, and the instruction segments are used to describe the execution process of the computer program 34 in the electronic device 30.

As shown in FIG. 26, the electronic device 30 may further include:
a transceiver 33, the transceiver 33 being connected to the processor 32 or the memory 31.

Here, the processor 32 may control the transceiver 33 to communicate with other devices, and exemplarily, may transmit information or data to other devices, or receive information or data transmitted by other devices. The transceiver 33 may include a transmitter and a receiver. The transceiver 33 may further include an antenna(s), and the number of antennas may be one or more.

It should be understood that the various components of the electronic device 30 are connected via a bus system, and the bus system includes not only a data bus, but also a power bus, a control bus and a status signal bus.

FIG. 27 is a schematic block diagram of a video encoding and decoding system provided by the embodiments of the present application.

As shown in FIG. 27, the video encoding and decoding system 40 may include: a video encoder 41 and a video decoder 42; the video encoder 41 is configured to perform the video encoding method involved in the embodiments of the present application, and the video decoder 42 is configured to perform the video decoding method involved in the embodiments of the present application.

The present application provides a computer storage medium, and a computer program is stored on the computer storage medium. The computer program, when executed by a computer, causes the computer to perform the method in the above method embodiments. In other words, a computer program product including instructions is further provided by the embodiments of the present application, and the instructions, when executed by a computer, cause the computer to perform the method in the above method embodiments.

The present application further provides a bitstream, which is generated according to the above encoding method.

When the above embodiments are implemented by using software, they may be implemented in the form of a computer program product in whole or in portion. The computer program product includes one or more computer instructions. When the computer program instruction(s) are loaded and executed on a computer, processes or functions of the embodiments of the present application are generated in whole or in portion. The computer may be a general-purpose computer, a special-purpose computer, a computer network, or other programmable apparatus. The computer instructions may be stored in a non-transitory computer-readable storage medium, or transmitted from a non-transitory computer-readable storage medium to another non-transitory computer-readable storage medium. For example, the computer instructions may be transmitted from a website, computer, server, or data center to another website, computer, server, or data center via wired means (e.g., coaxial cable, fiber optic, digital subscriber line (DSL)) or wireless means (e.g., infrared, radio, microwave). The non-transitory computer-readable storage medium may be any available medium that can be accessed by the computer, or a data storage device, such as including a server or a data center that integrates one or more available mediums. The available medium may be a magnetic medium (e.g., a floppy disk, a hard disk or a magnetic tape), an optical medium (e.g., a digital video disk (DVD)) or a semiconductor medium (e.g., a solid state disk (SSD)), etc.

Those ordinary skilled in the art may realize that units and algorithm steps of the examples described in combination with the embodiments disclosed in this application can be implemented in electronic hardware or in a combination of computer software and electronic hardware. Whether these functions are performed by hardware or software depends on an exemplary application and a design constraint of the technical solution. A skilled person may use different methods for each exemplary application, to implement the described functions, but such implementation should not be considered beyond the scope of the present application.

In the several embodiments provided in the application, it should be understood that, the disclosed systems, apparatus, and method may be implemented in other ways. For example, the apparatus embodiments described above are only schematic, for example, division of the units is only division with logical functions, and there may be other division methods in actual implementations, such as, a plurality of units or components may be combined or integrated into another system, or some features may be ignored or not performed. Furthermore, the coupling or direct coupling or communication connection between each other as shown or discussed may be indirect coupling or communication connection of apparatus or units via some interfaces, which may be electrical, mechanical, or in other forms.

The units described as separate components may be or may not be physically separated, and the components shown as units may be or may not be physical units; that is, they may be located in one place, or may be distributed onto a plurality of network units. All or a portion of the units may be selected according to actual needs to implement the purpose of the schemes of the embodiments. For example, various functional units in the various embodiments of the present application may be integrated into one processing unit, or the various units may exist physically separately, or two or more units may be integrated into one unit.

The above contents are only exemplary implementations of the present application, but the protection scope of the present application is not limited thereto, and changes or substitutions, which may be easily thought by any skilled familiar with this technical field, within the technical scope disclosed in the present application should be all covered within the protection scope of the present application. Therefore, the protection scope of the present application should be subject to the protection scope of the claims.

What is claimed is:

1. A video decoding method, comprising:
determining N candidate weight derivation modes, wherein N is a positive integer;
determining at least one candidate prediction mode based on the N candidate weight derivation modes and attribute information of a current block;
determining a first weight derivation mode and K first prediction modes corresponding to the current block based on the N candidate weight derivation modes and the at least one candidate prediction mode, wherein K is a positive integer greater than 1; and
predicting the current block based on the first weight derivation mode and the K first prediction modes to obtain a prediction value of the current block.

2. The method according to claim 1, wherein determining the at least one candidate prediction mode based on the N candidate weight derivation modes and the attribute information of the current block comprises:
for an i-th candidate weight derivation mode of the N candidate weight derivation modes, determining a candidate prediction mode list corresponding to the i-th candidate weight derivation mode based on the i-th candidate weight derivation mode and the attribute information of the current block, wherein i is a positive integer less than or equal to N.

3. The method according to claim 2, wherein determining the candidate prediction mode list corresponding to the i-th candidate weight derivation mode based on the i-th candidate weight derivation mode and the attribute information of the current block comprises:
determining a candidate prediction mode list of at least one prediction mode of K prediction modes corresponding to the i-th candidate weight derivation mode based on the i-th candidate weight derivation mode and the attribute information of the current block.

4. The method according to claim 3, wherein in response to that the at least one prediction mode corresponds to a candidate prediction mode list, determining the candidate prediction mode list of the at least one prediction mode of the K prediction modes corresponding to the i-th candidate weight derivation mode based on the i-th candidate weight derivation mode and the attribute information of the current block comprises:
for a j-th prediction mode of the at least one prediction mode, determining a candidate prediction mode list of the j-th prediction mode based on the i-th candidate weight derivation mode and the attribute information of the current block, wherein j is a positive integer; and
determining the candidate prediction mode list of the at least one prediction mode based on the candidate prediction mode list of the j-th prediction mode.

5. The method according to claim 3, wherein in response to that each prediction mode of the at least one prediction mode corresponds to a candidate prediction mode list, determining the candidate prediction mode list of the at least one prediction mode of the K prediction modes corresponding to the i-th candidate weight derivation mode based on the i-th candidate weight derivation mode and the attribute information of the current block comprises:
for a j-th prediction mode of the at least one prediction mode, determining a candidate prediction mode list of the j-th prediction mode based on the i-th candidate weight derivation mode and the attribute information of the current block, wherein j is a positive integer.

6. The method according to claim 4, wherein determining the candidate prediction mode list of the j-th prediction mode based on the i-th candidate weight derivation mode and the attribute information of the current block comprises:
determining a first look-up table, wherein the first look-up table includes neighboring blocks corresponding to different prediction modes under different block attribute information and different weight derivation modes;
determining neighboring blocks corresponding to the j-th prediction mode in the first look-up table based on the attribute information of the current block and the i-th candidate weight derivation mode; and
determining the candidate prediction mode list of the j-th prediction mode based on prediction modes of the neighboring blocks corresponding to the j-th prediction mode.

7. The method according to claim 4, wherein determining the candidate prediction mode list of the j-th prediction mode based on the i-th candidate weight derivation mode and the attribute information of the current block comprises:
determining weights of neighboring blocks of the current block with respect to the j-th prediction mode based on the i-th candidate weight derivation mode and the attribute information of the current block; and
determining the candidate prediction mode list of the j-th prediction mode based on the weights of the neighboring blocks with respect to the j-th prediction mode.

8. The method according to claim 7, wherein determining the weights of the neighboring blocks of the current block with respect to the j-th prediction mode based on the i-th candidate weight derivation mode and the attribute information of the current block comprises:
determining a weight of a first point in the neighboring blocks based on the i-th candidate weight derivation mode and the attribute information of the current block; and
determining the weight of the first point as the weights of the neighboring blocks with respect to the j-th prediction mode.

9. The method according to claim 8, wherein determining the weight of the first point in the neighboring blocks based on the i-th candidate weight derivation mode and the attribute information of the current block comprises:
determining the weight of the first point based on the i-th candidate weight derivation mode, the attribute information of the current block and a template of the current block.

10. The method according to claim 9, wherein determining the weight of the first point based on the i-th candidate weight derivation mode, the attribute information of the current block and the template of the current block comprises:
determining a weight of the template based on the i-th candidate weight derivation mode, the attribute information of the current block and the template of the current block; and
determining a weight corresponding to the first point in the weight of the template as the weight of the first point.

11. The method according to claim 8, wherein determining the weight of the first point in the neighboring blocks based on the i-th candidate weight derivation mode and the attribute information of the current block comprises:
determining a second point in the current block corresponding to the first point;
determining a weight of the second point based on the i-th candidate weight derivation mode and the attribute information of the current block; and
determining the weight of the first point based on the weight of the second point.

12. The method according to claim 11, wherein the second point is a point in the current block that is neighboring to the first point.

13. The method according to claim 8, wherein the first point is any point in the neighboring blocks, or the first point is a point in the neighboring blocks that is neighboring to the current block.

14. The method according to claim 7, wherein determining the candidate prediction mode list of the j-th prediction mode based on the weights of the neighboring blocks with respect to the j-th prediction mode comprises:
in response to that the weights of the neighboring blocks with respect to the j-th prediction mode are greater than or equal to a preset threshold, obtaining prediction modes of the neighboring blocks; and
determining the candidate prediction mode list of the j-th prediction mode based on the prediction modes of the neighboring blocks.

15. The method according to claim 14, wherein in response to that a value of the weight is in a range from 0 to n, the preset threshold is n/2, and n is a positive number.

16. The method according to claim 7, wherein in response to that the value of the weight is a first value or a second value, determining the candidate prediction mode list of the j-th prediction mode based on the weights of the neighboring blocks with respect to the j-th prediction mode comprises:
in response to that the weights of the neighboring blocks with respect to the j-th prediction mode are equal to the first value, obtaining the prediction modes of the neighboring blocks, the first value being greater than the second value;
determining the candidate prediction mode list of the j-th prediction mode based on the prediction modes of the neighboring blocks.

17. The method according to claim 14, wherein obtaining the prediction modes of the neighboring blocks comprises:
according to a preset checking order, sequentially obtaining prediction modes of neighboring blocks whose weight with respect to the j-th prediction mode are greater than or equal to the preset threshold or equal to the first value of the neighboring blocks of the current block.

18. The method according to claim 17, wherein determining the candidate prediction mode list of the j-th prediction mode based on the prediction modes of the neighboring blocks comprises:
according to the checking order, sequentially adding the obtained prediction modes of the neighboring blocks to the candidate prediction mode list of the j-th prediction mode.

19. The method according to claim 17, wherein in response to that the neighboring blocks of the current block include a left neighboring block, a top neighboring block, a bottom-left neighboring block, a top-right neighboring block and a top-left neighboring block, the preset checking order is the left neighboring block, the top neighboring block, the bottom-left neighboring block, the top-right neighboring block and the top-left neighboring block.

20. The method according to claim 14, wherein determining the candidate prediction mode list of the j-th prediction mode based on the prediction modes of the neighboring blocks comprises:
in response to that the candidate prediction mode list of the j-th prediction mode does not include the prediction modes of the neighboring blocks, adding the prediction modes of the neighboring blocks to the candidate prediction mode list of the j-th prediction mode.

21. The method according to claim 14, wherein the method further comprises:
in response to that the weights of the neighboring blocks with respect to the j-th prediction mode are less than a preset threshold or equal to a second value, skipping obtaining the prediction modes of the neighboring blocks.

22. The method according to claim 7, wherein in response to that M neighboring blocks are included for the current block, determining the candidate prediction mode list of the j-th prediction mode based on the weights of the neighboring blocks with respect to the j-th prediction mode comprises:
determining the candidate prediction mode list of the j-th prediction mode based on the weights of the M neighboring blocks respectively with respect to the j-th prediction mode and prediction modes of the M neighboring blocks, wherein M is a positive integer.

23. The method according to claim 22, wherein determining the candidate prediction mode list of the j-th prediction mode based on the weights of the M neighboring blocks respectively with respect to the j-th prediction mode and the prediction modes of the M neighboring blocks comprises:
adding the prediction modes of the M neighboring blocks to the candidate prediction mode list based on the weights of the M neighboring blocks respectively with respect to the j-th prediction mode until a length of the candidate prediction mode list reaches a preset length.

24. The method according to claim 23, wherein the M neighboring blocks include at least one of a left neighboring block, a top neighboring block, a bottom-left neighboring block, a top-right neighboring block or a top-left neighboring block.

25. A video encoding method, comprising:
determining N candidate weight derivation modes, wherein N is a positive integer;
determining at least one candidate prediction mode based on the N candidate weight derivation modes and attribute information of a current block;
determining a first weight derivation mode and K first prediction modes corresponding to the current block based on the N candidate weight derivation modes and the at least one candidate prediction mode, wherein K is a positive integer greater than 1; and
predicting the current block based on the first weight derivation mode and the K first prediction modes to obtain a prediction value of the current block.

26. A video decoding apparatus, comprising:
a processor; and
a memory,
wherein the memory is configured to store a computer program, and the processor is configured to call the computer program stored in the memory and run the computer program to perform:
determining N candidate weight derivation modes, wherein N is a positive integer;
determining at least one candidate prediction mode based on the N candidate weight derivation modes and attribute information of a current block, wherein a candidate prediction mode list includes the at least one candidate prediction mode;
determining a first weight derivation mode and K first prediction modes corresponding to the current block based on the N candidate weight derivation modes and the at least one candidate prediction mode, wherein K is a positive integer greater than 1; and
predicting the current block based on the first weight derivation mode and the K first prediction modes to obtain a prediction value of the current block.
